(19) United States
(12) Patent Application Publication
(10) Pub. No.: US 2023/0292757 A1
(43) Pub. Date: Sep. 21, 2023

(54) SYNERGISTIC AGROCHEMICAL COMPOSITION COMPRISING DIAMIDES AND PLANT GROWTH REGULATORS

(71) Applicant: RAJDHANI PETROCHEMICALS PRIVATE LIMITED, Ahmedabad, Gujarat (IN)

(72) Inventors: Dipakkumar PATEL, Ahmedabad, Gujarat (IN); Kenal V. SHAH, Ahmedabad, Gujarat (IN); Bhavesh V. SHAH, Ahmedabad, Gujarat (IN); Kawarlal DABHODIA, Ahmedabad, Gujarat (IN)

(21) Appl. No.: 18/016,701

(22) PCT Filed: Jul. 16, 2021
(86) PCT No.: PCT/IN2021/050690

§ 371 Date: Jan. 18, 2023

(30) Foreign Application Priority Data
Jul. 18, 2020 (IN) 202021030670

(51) Int. Cl. A01N 43/56; A01N 25/14; A01N 25/04; A01N 31/02; A01N 51/00; A01N 45/00; A01N 37/46; A01P 7/00

(52) U.S. Cl. CPC A01N 43/56; A01N 25/14; A01N 25/04; A01N 31/02; A01N 51/00; A01N 45/00; A01N 37/46; A01P 7/00

(57) ABSTRACT

Synergistic agrochemical composition comprising diamide and plant growth regulators. The present invention more particularly relates to the synergistic agrochemical insecticidal composition comprising of bioactive amount of at least one insecticide selected from class of diamide, metadiamides, isoxazolines or mixture thereof; at least one plant growth regulator or mixture thereof; and at least one more insecticide from various groups or mixture thereof. The present invention further relates to process for preparing the said compositions in specific ratio. The present invention further relates to the process for preparing the said composition along with at least one inactive excipient; and formulations thereof. The present invention further relates to the synergistic insecticidal compositions, wherein active ingredient present in fixed ratio shows synergy in an insecticidal activity.

### FIELD OF THE INVENTION

The present invention relates to synergistic insecticidal compositions comprising bioactive amounts of (A) at least one insecticide selected from class of diamide, metadiamides, isoxazolines or mixture thereof; (B) at least one plant growth regulator or mixture thereof; (C) at least one more insecticide from various groups or mixture thereof. The present invention further relates to process of preparing said composition along with at least one inactive excipients and formulation thereof.

### BACKGROUND OF THE INVENTION

Combination of insecticides are used to broaden the spectrum of control of insect, to improve the pest control with synergistic effect, reduce dosage, thereby reducing environmental impact, to broaden the spectrum of control, i.e. chewing and sucking insects at a time, decrease chances of resistance development and management of resistance and to enhance residual control so lesser the number of sprays for crop protections and minimizing the pesticidal load in ecosystem. The combination of insecticides at times demonstrate an additive or synergistic effect that results in an improved control on the pests.

Insecticide or pesticides are used widely and very frequently in commercial agriculture and have enabled an enormous increase in crop yields and product quality which ultimately increased the ease to farmers in term of economic advantage as well as ease of farming activities.

Plant Growth Regulators (PGRs) are typically any substance or mixture of substances intended to accelerate or slow down the rate of growth or ripening, or otherwise change the development of plants, or to produce plants. Some plant growth regulators protect plants from biotic and abiotic stress. They give tolerance to extreme temperatures, both high and low, to drought, to high salt content, which are some examples of abiotic stresses that plants can undergo. PGR allows plants to withstand abiotic stresses by controlling the natural expression of hormones in the plant.

There are many combinations of insecticide along with plant growth regulators known in the art for the control of soil borne pests. For example, WO2016099919 patent relates agricultural compositions and their use as delayed release compositions. The delayed release compositions comprise an agricultural composition comprises a fertilizer, a pesticide, a plant growth regulator, wherein insecticides are from group of diamide, neonicotinoid, carbamates. The patent more specifically relates to a composition comprising Chlorantraniliprole, Clothianidin, Thiamethoxam along with plant growth regulators.

EP1541023 patent relates to a biologically active combination for agricultural applications consisting of at least one biocidal, agriculturally acceptable active substance and a betaine as bioactivator for the active substance. Further the composition comprising diamide group of insecticides along with plant growth regulators.

AU2017204400 patent relates to pesticidal mixtures comprising one biological compound and at least one fungicidal, insecticidal or plant growth regulating compound and respective agricultural uses thereof. Further it relates to chlorantralniliprole as diamide insecticides along with various plant growth regulators.

There is however a need for improvement of these combinations. Single active combinations used over a long period of time has resulted in resistance. With the onset of resistance to certain pests, there is a need in the art for a combination of actives that decreases chances of resistance and improves the spectrum of insect-pest control.

However still there is a need for a composition comprises at least one insecticide from diamide group; at least one plant growth regulator; at least one insecticide selected from compound having various mode of action which overcomes some of the existing problems and can be prepared easily without much complex manufacturing process.

In general use, the pesticide actives are used in the form of a dilute aqueous composition because it can attain a good interaction with the target organism, such as plants, fungi and insects. However, most active pesticide compounds that are used as pesticides are only sparingly or even insoluble in water. The low solubility of such compounds present the challenges and difficulties to formulator in formulating pesticide compounds in stable formulations that can be easily stored for a long time and which still have a high stability and effective activity until end use. This problem especially occurs and may get worsen if more than one active compound is present in the composition.

Therefore, one object of the present invention is to provide improved combinations of insecticides for the control of foliar feeder and soil born pests. Another object of the present invention is to provide a method and a composition for controlling insect pests.

Yet another object of the present invention is to provide improved combinations of insecticides that promote plant health.

Embodiment of the present invention can ameliorate one or more of the above mentioned problems.

Inventors of the present invention have surprisingly found that the novel synergistic composition of at least one insecticide from diamide group; at least one plant growth regulator; at least one insecticide selected from compound having various mode of action as described herein which can provide solution to the above mentioned problems.

### SUMMARY OF THE INVENTION

Therefore an aspect of the present invention provides synergistic insecticidal compositions comprising bioactive amounts of (A) at least one insecticide selected from class of diamide, metadiamides, isoxazolines or mixture thereof; (B) at least one plant growth regulator or mixture thereof; (C) at least one more insecticide from various groups or mixture thereof.

Therefore an aspect of the present invention provides synergistic insecticidal compositions comprising (A) at least one insecticide from class of diamide selected from chlorantraniliprole, cyantraniliprole, cyclaniliprole, cyhalodiamide, cyproflanilide, flubendiamide, tetrachlorantraniliprole, tyclopyrazoflor, tetraniliprole; from class of metadiamides is broflanilide; or from class of Isoxazoline selected from Fluxametamide, Isocycloseram; or mixture thereof; (B) at least one plant growth regulator selected from the class of Anti-auxins, Auxin, Cytokinins, Defoliants, Ethylene modulators, Ethylene releasers, Gibberellins, Growth Inhibitors, Morphactins, Growth retardants, Growth stimulants, Unclassified plant growth regulators; (C) at least one insecticidal compound selected from the group of an Acetylcholine esterase inhibitors from the class of carbamates, Acetylcholine esterase inhibitors from the class of organophosphates, GABA-gated chloride channel antagonists from cyclodiene organochlorine compounds and Phenylpyrazole (fiproles), Sodium channel modulators from the class of pyrethroids, Nicotinic acteylcholine receptor agonists from the class of neonicotinoids, Sulfoximines, Butenolides, Mesoionics, allosteric nicotinic acteylcholine receptor activators from the class of spinosyns, chloride channel activators from the class of mectins, Juvenile hormone mimics, Non-specific multi-site inhibitors, Chordotonal organs TRPV channel modulators, Mite growth inhibitors affecting CHS1, Microbial disruptors of insect midgut membrane, Inhibitors of mitochondrial ATP synthase, Uncouplers of oxidative phosphorylation, Inhibitors of the chitin biosynthesis affecting CHS1, Inhibitors of the chitin biosynthesis type 1, Moulting disruptors, Ecdyson receptor agonists, Octopamin receptor agonists, Mitochondrial complex III electron transport inhibitors, Mitochondrial complex I electron transport inhibitors, Voltage-dependent sodium channel blockers from class of oxadiazines and semicarbazones, Inhibitors of the lipid synthesis, Inhibitors of acetyl CoA carboxylase, Mitochondrial complex II electron transport inhibitors, Baculoviruses, Compounds of unknown or uncertain mode of action; and one or more customary formulation adjuvants.

Accordingly, in a further aspect, the present invention provides a method of protecting a plant propagation material, a plant, parts of a plant and/or plant organs that grow at a later point in time against pathogenic damage or pest damage by applying to the plant propagation material a composition comprising an insecticidal composition defined in the first aspect.

As per one embodiment formulation for the an insecticidal composition is selected from Capsule suspension (CS), Dispersible concentrate (DC), Powder for dry seed treatment (DS), Emulsifiable concentrate (EC), Emulsion, water in oil (EO), Emulsion for seed treatment (ES), Emulsion, oil in water (EW), Flowable suspension/concentrate for seed treatment (FS), Granule/soil applied (GR), Controlled (Slow or Fast) release granules (CR), Solution for seed treatment (LS), Micro-emulsion (ME), Oil dispersion (OD), Oil miscible flowable concentrate (oil miscible suspension (OF), Oil miscible liquid (OL), Suspension concentrate (flowable concentrate) (SC), Suspo-emulsion (SE), Water soluble granule (SG), Soluble concentrate (SL), Water soluble powder (SP), Water dispersible granule (WG or WDG), Wettable powder (WP), Water dispersible powder for slurry treatment (WS), A mixed formulation of CS and SC (ZC), A mixed formulation of CS and SE (ZE), A mixed formulation of CS and EW (ZW); and one or more customary formulation adjuvants such as a) dispersant b) wetting agent c) anti-foaming agent d) biocides e) anti-freezing agent f) suspending agent g) thickener h) coating agent and i) buffering agent.

The remainder of the aqueous formulation is preferably wholly water but may comprise other materials, such as inorganic salts. The formulation is preferably, completely free from organic solvents.

Accordingly, in a first aspect, the present invention provides an insecticidal composition comprising (A) at least one insecticide from class of diamide selected from chlorantraniliprole, cyantraniliprole, cyclaniliprole, cyhalodiamide, cyproflanilide, flubendiamide, tetrachlorantraniliprole, tyclopyrazoflor, tetraniliprole; from class of metadiamides is broflanilide; or from class of Isoxazoline selected from Fluxametamide, Isocycloseram; or mixture thereof; (B) at least one plant growth regulator selected from the class of Anti-auxins, Auxin, Cytokinins, Defoliants, Ethylene modulators, Ethylene releasers, Gibberellins, Growth Inhibitors, Morphactins, Growth retardants, Growth stimulants, Unclassified plant growth regulators; (C) at least one insecticidal compound selected from the group of an Acetylcholine esterase inhibitors from the class of carbamates, Acetylcholine esterase inhibitors from the class of organophosphates, GABA-gated chloride channel antagonists from cyclodiene organochlorine compounds and Phenylpyrazole (fiproles), Sodium channel modulators from the class of pyrethroids, Nicotinic acteylcholine receptor agonists from the class of neonicotinoids, Sulfoximines, Butenolides, Mesoionics, allosteric nicotinic acteylcholine receptor activators from the class of spinosyns, chloride channel activators from the class of mectins, Juvenile hormone mimics, Non-specific multi-site inhibitors, Chordotonal organs TRPV channel modulators, Mite growth inhibitors affecting CHS1, Microbial disruptors of insect midgut membrane, Inhibitors of mitochondrial ATP synthase, Uncouplers of oxidative phosphorylation, Inhibitors of the chitin biosynthesis affecting CHS1, Inhibitors of the chitin biosynthesis type 1, Moulting disruptors, Ecdyson receptor agonists, Octopamin receptor agonists, Mitochondrial complex III electron transport inhibitors, Mitochondrial complex I electron transport inhibitors, Voltage-dependent sodium channel blockers from class of oxadiazines and semicarbazones, Inhibitors of the lipid synthesis, Inhibitors of acetyl CoA carboxylase, Mitochondrial complex II electron transport inhibitors, Baculoviruses, Compounds of unknown or uncertain mode of action; and one or more customary formulation adjuvants; shows synergistic activity.

### DETAILED DESCRIPTION OF THE INVENTION

The term “synergistic”, as used herein, refers the combined action of two or more active agents blended together and administered conjointly that is greater than the sum of their individual effects. “Bioactive amounts” as mentioned herein means that amount which, when applied treatment of crops, is sufficient to effect such treatment.

Therefore an aspect of the present invention provides synergistic insecticidal compositions comprising bioactive amounts of (A) at least one insecticide selected from class of diamide, metadiamides, isoxazolines or mixture thereof; (B) at least one plant growth regulator or mixture thereof; (C) at least one more insecticide from various groups or mixture thereof.

More particularly a further aspect of the present invention provides synergistic insecticidal compositions comprising (A) at least one insecticide from class of diamide selected from chlorantraniliprole, cyantraniliprole, cyclaniliprole, cyhalodiamide, cyproflanilide, flubendiamide, tetrachlorantraniliprole, tyclopyrazoflor, tetraniliprole; from class of metadiamides is broflanilide; or from class of Isoxazoline selected from Fluxametamide, Isocycloseram; or mixture thereof; (B) at least one plant growth regulator selected from the class of Anti-auxins, Auxin, Cytokinins, Defoliants, Ethylene modulators, Ethylene releasers, Gibberellins, Growth Inhibitors, Morphactins, Growth retardants, Growth stimulants, Unclassified plant growth regulators; (C) at least one insecticidal compound selected from the group of an Acetylcholine esterase inhibitors from the class of carbamates, Acetylcholine esterase inhibitors from the class of organophosphates, GABA-gated chloride channel antagonists from cyclodiene organochlorine compounds and Phenylpyrazole (fiproles), Sodium channel modulators from the class of pyrethroids, Nicotinic acteylcholine receptor agonists from the class of neonicotinoids, Sulfoximines, Butenolides, Mesoionics, allosteric nicotinic acteylcholine receptor activators from the class of spinosyns, chloride channel activators from the class of mectins, Juvenile hormone mimics, Non-specific multi-site inhibitors, Chordotonal organs TRPV channel modulators, Mite growth inhibitors affecting CHS1, Microbial disruptors of insect midgut membrane, Inhibitors of mitochondrial ATP synthase, Uncouplers of oxidative phosphorylation, Inhibitors of the chitin biosynthesis affecting CHS1, Inhibitors of the chitin biosynthesis type 1, Moulting disruptors, Ecdyson receptor agonists, Octopamin receptor agonists, Mitochondrial complex III electron transport inhibitors, Mitochondrial complex I electron transport inhibitors, Voltage-dependent sodium channel blockers from class of oxadiazines and semicarbazones, Inhibitors of the lipid synthesis, Inhibitors of acetyl CoA carboxylase, Mitochondrial complex II electron transport inhibitors, Baculoviruses, Compounds of unknown or uncertain mode of action; and one or more customary formulation adjuvants.

In an embodiment of the present invention the insecticede from class of a diamide insecticide may be selected from chlorantraniliprole, cyantraniliprole, cyclaniliprole, cyhalodiamide, cyproflanilide, flubendiamide, tetrachlorantraniliprole, tetraniliprole.

In an embodiment of the present invention the insecticede from class of a metadiamide is broflanilide.

In an embodiment of the present invention the insecticede from class of Isoxazolines is selected from Fluxametamide and Isocycloseram.

In an embodiment of the present invention the insecticede from acetylcholine esterase inhibitors from the class of carbamates may be selected from aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, and triazamate.

In an embodiment of the present invention the insecticede acetylcholine esterase inhibitors from the class of organophosphates may be selected from acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion;

In a further embodiment of the present invention the insecticide GABA-gated chloride channel antagonists from cyclodiene organochlorine class of compound is endosulfan.

In a further embodiment of the present invention the insecticide GABA-gated chloride channel antagonists from Phenylpyrazole (fiproles) class of compound may be selected from ethiprole, fipronil, nicofluprole, flufiprole, pyrafluprole, or pyriprole.

In a further embodiment of the present invention the insecticede from sodium channel modulators from the class of pyrethroids may be selected from acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, meperfluthrin, metofluthrin, momfluorothrin, permethrin, phenothrin, prallethrin, profluthrin, pyrethrin (pyrethrum), resmethrin, silafluofen, tefluthrin, tetramethylfluthrin, tetramethrin, tralomethrin, transfluthrin.

In a further embodiment of the present invention the insecticede from nicotinic acteylcholine receptor agonists from the class of neonicotinoids may be selected from acetamiprid, dichloromezotiaz, chlothianidin, dinotefuran, imidacloprid, nitenpyram, thiacloprid, thiamethoxam, sulfoxaflor, flupyradifurone, flupyrimin or triflumezopyrim.

In a yet another embodiment of the present invention the insecticede from allosteric nicotinic acteylcholine receptor activators from the class of spinosyns may be selected from spinosad, spinetoram.

In a yet another embodiment of the present invention the insecticede from chloride channel activators from the class of mectins may be selected from abamectin, emamectin benzoate, ivermectin, lepimectin or milbemectin.

In a yet another embodiment of the present invention the insecticede from juvenile hormone mimics may be selected from hydroprene, kinoprene, methoprene, fenoxycarb, pyriproxyfen.

In a yet another embodiment of the present invention the insecticede from non specific multi-site inhibitors may be selected from methyl bromide and other alkyl halides, chloropicrin, sulfuryl fluoride, borax or tartar emetic, dazomet, metam;

In a yet another embodiment of the present invention the insecticede from chordotonal organ TRPV channel modulators with selective homopteran feeding blockers from the pymetrozine, pyrifluquinazon, afidopyropen, flonicamid.

In a yet another embodiment of the present invention the insecticede from selective homopteran feeding blockers from the class of pyropenes is afidopyropen.

In a yet another embodiment of the present invention the insecticede from mite growth inhibitors may be selected from clofentezine, hexythiazox, diflovidazin or etoxazole.

In a yet another embodiment of the present invention the insecticede from microbial disruptors of insect midgut membrane may be selected from Bacillus thuringiensis and insecticidal proteins they produce.

In a yet another embodiment of the present invention the insecticede from class of inhibitors of mitochondrial ATP synthase may be selected from diafenthiuron, azocyclotin, cyhexatin, fenbutatin oxide, propargite, or tetradifon.

In a yet another embodiment of the present invention the insecticede from class of uncouplers of oxidative phosphorylation may be selected from chlorfenapyr, DNOC, or sulfluramid.

In a yet another embodiment of the present invention the insecticede from class of inhibitors of the chitin biosynthesis affecting CHS1 may be selected from Benzoylureas-bistrifluron, chlorfluazuron, diflubenzuron, flucycloxuron, flufenoxuron, hexaflumuron, lufenuron, novaluron, noviflumuron, teflubenzuron, triflumuron.

In a yet another embodiment of the present invention the insecticede from class of inhibitors of the chitin biosynthesis type 1 is buprofezin.

In a yet another embodiment of the present invention the insecticede from class of moulting disruptors is cyromazine.

In a yet another embodiment of the present invention the insecticede from class of Ecdyson receptor agonists may be selected from diacylhydrazines-methoxyfenozide, tebufenozide, halofenozide, fufenozide or chromafenozide.

In a yet another embodiment of the present invention the insecticede from class of Octopamin receptor agonists is amitraz.

In a yet another embodiment of the present invention the insecticede from class of Mitochondrial complex III electron transport inhibitors may be selected from hydramethylnon, acequinocyl, flometoquin, fluacrypyrim, pyriminostrobin or bifenazate.

In a yet another embodiment of the present invention the insecticede from class of Mitochondrial complex I electron transport inhibitors may be selected from fenazaquin, fenpyroximate, pyrimidifen, pyridaben, tebufenpyrad, tolfenpyrad, flufenerim, or rotenone.

In a yet another embodiment of the present invention the insecticede from class of voltage-dependent sodium channel blockers may be selected from indoxacarb, metaflumizone.

In a yet another embodiment of the present invention the insecticede from class of Inhibitors of the lipid synthesis, inhibitors of acetyl CoA carboxylase may be selected from spirodiclofen, spiromesifen, spirotetramat or spiropidion.

In a yet another embodiment of the present invention the insecticede from class of Mitochondrial complex II electron transport inhibitors may be selected from cyenopyrafen, cyflumetofen or pyflubumide.

In a yet another embodiment of the present invention the insecticede from class of chlorodontal organ modulators is flonicamid.

In a yet another embodiment of the present invention the insecticidal compounds of unknown or uncertain mode of action may be selected from azadirechtin, benzoximate, benzpyrimoxan, pyridalyl, oxazosulfyl, dimpropyridaz, tyclopyrazoflor, fluhexafon, Cyetpyrafen, flupentiofenox, acynonapyr, Cyclobutrifluram, fluazaindolizine or tioxazafen

In another embodiment of the present invention Plant Growth Regulators from the class of Antiauxins may be selected from clofibric acid, 2,3,5-tri-iodobenzoic acid.

In an embodiment of the present invention, the plant growth regulator from the class of Auxin may be selected from 4-CPA, 2,4-D, 2,4-DB, 2,4-DEP, dichlorprop, fenoprop, IAA, IBA, naphthaleneacetamide, a-naphthaleneacetic acid, 1-naphthol, naphthoxyacetic acid, potassium naphthenate, sodium naphthenate, 2,4,5-T.

In an embodiment of the present invention plant growth regulator from the class of Cytokinins may be selected from adenine, adenine hemisulfate di-hydrate, 2iP, 6-benzylaminopurine, N-Oxide-2,6-lutidine, 2,6-dimethylpyridine, kinetin, zeatin.

In yet another embodiment of the present invention, plant growth regulator from the class of Defoliants may be selected from calcium cyanamide, dimethipin, endothal, merphos, metoxuron, pentachlorophenol, thidiazuron, tribufos, tributyl phosphorotrithioate.

In a further embodiment of the present invention plant growth regulator from the class of Ethylene modulators may be selected from aviglycine, 1-MCP, prohexadione, prohexadione calcium, trinexapac, trinexapac-ethyl, aminoethoxyvinylglycine (AVG).

In another embodiment of the present invention plant growth regulator from the class of Ethylene releasers may be selected from ACC, etacelasil, ethephon, glyoxime.

In an embodiment of the present invention plant growth regulator from the class of Gibberellins may be selected from gibberelline, gibberellic acid, GA3.

In a further embodiment of the present invention, plant growth regulator from the class of Growth Inhibitors may be selected from abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, mepiquat chloride, mepiquat pentaborate, piproctanyl, prohydrojasmon, propham, 2,3,5-tri-iodobenzoic acid.

In yet another embodiment of the present invention, plant growth regulator from the class of Morphactins may be selected from chlorfluren, chlorflurenol, dichlorflurenol, flurenol.

In another embodiment of the present invention plant growth regulator from the class of Growth retardants may be selected from chlormequat, chlormequat chloride, daminozide, flurprimidol, mefluidide, paclobutrazol, tetcyclacis, uniconazole, metconazole.

Moreover in another embodiment of the present invention, plant growth regulator from the class of Growth stimulants may be selected from forchlorfenuron, hymexazol.

In yet another embodiment of the present invention, plant growth regulator from the class of Unclassified plant growth regulators may be selected from amidochlor, benzofluor, buminafos, carvone, choline chloride, ciobutide, clofencet, cloxyfonac, cyanamide, cyclanilide, cycloheximide, cyprosulfamide, epocholeone, ethychlozate, ethylene, fenridazon, fluprimidol, fluthiacet, heptopargil, holosulf, inabenfide, karetazan, lead arsenate, methasulfocarb, pydanon, sintofen, triapenthenol, Nitrophenolate (sodium para-nitrophenolate, ortho-nitrophenoate, sodium-5-nitroguaiacolate), triacontanol, alpha naphthyl acetic acid, 6-benzyladenine.

The present invention provides formulation for the aforesaid composition and method of preparation thereof.

### Diamide Group of Insecticides:

Anthranilic diamides are an important commercial synthetic class of insecticides (IRAC Group 28) that bind to the ryanodine receptor with selective potency against insect versus mammalian forms of the receptor. Chlorantraniliprole is first of the anthranilic diamide insecticides. It is a ryanodine receptor activator and is used to protect a wide variety of crops, including corn, cotton, grapes, rice and potatoes. It has a role as a ryanodine receptor agonist. It is an organobromine compound, a member of pyridines, a member of pyrazoles, a pyrazole insecticide, a member of monochlorobenzenes and a secondary carboxamide.

Chlorantraniliprole is a novel anthranilic diamide insecticide that functions via activation of the insect ryanodine receptors within the sarcoplasmic reticulum causing impaired regulation of muscle contraction. Ryanodine receptor channels regulate the release of internal calcium stores and are important in muscle contraction. Sustained release of calcium levels within the cytosol leads to muscle contraction, paralysis and eventual death of the organism. While insects possess a single form of the ryanodine receptor distributed in muscle and neuronal tissue, mammals possess three forms which are widely distributed in muscle and non-muscle tissues. The present inventors believe that the combination of the present invention surprisingly results in a synergistic action. The combinations of the present invention allow for a broad spectrum of pest control and has surprisingly improved plant vigour and yield. The broad spectrum of the present combination also provides a solution for preventing the development of resistance.

The synergistic composition has very advantageous curative, preventive and systemic fungicidal properties for protecting cultivated plants. As has been mentioned, said active ingredient composition can be used to inhibit or destroy the pathogens that occur on plants or parts of plants (fruit, blossoms, leaves, stems, tubers, roots) of different crops or useful plants, while at the same time those parts of plants which grow later are also protected from attack by such pathogens. Active ingredient composition has the special advantage of being highly active against diseases in the soil that mostly occur in the early stages of plant development.

### Plant Growth Regulators

Plant Growth Regulators are defined as small, simple chemicals produced naturally by plants to regulate their growth and development.

Plant Growth Regulators can be of a diverse chemical composition such as gases (ethylene), terpenes (gibberellic acid) or carotenoid derivatives (abscisic acid). They are also referred to as plant growth substances, phytohormones or plant hormones.

Plant growth hormones are organic compounds which are either produced naturally within the plants or are synthesized in laboratories. They profoundly control and modify the physiological processes like the growth, development, and movement of plants.

Gibberellic acid is a simple gibberellin, a pentacyclic diterpene acid promoting growth and elongation of cells. It affects decomposition of plants and helps plants grow if used in small amounts, but eventually plants develop tolerance to it. Gibberellic acid is a very potent hormone whose natural occurrence in plants controls their development. Since GA regulates growth, applications of very low concentrations can have a profound effect while too much will have the opposite effect. Gibberellins have a number of effects on plant development. They can stimulate rapid stem and root growth, induce mitotic division in the leaves of some plants, and increase seed germination rates.

Moreover oral toxicity of Gibberellic acid (GA3) has been evaluated in S. littoralis and L. migratoria insect species. Researchers observed that GA3 caused significant reduction in food consumption in both insect species which led to larval weight loss. GA3 toxicity was also demonstrated by larval mortality due to exuviation difficulties.

Paclobutrazol (PBZ) is a plant growth retardant and triazole fungicide. It is a known antagonist of the plant hormone gibberellin. It acts by inhibiting gibberellin biosynthesis, reducing internodal growth to give stouter stems, increasing root growth, causing early fruitset and increasing seedset in plants such as tomato and pepper. PBZ has also been shown to reduce frost sensitivity in plants. Moreover, paclobutrazol can be used as a chemical approach for reducing the risk of lodging in cereal crops. PBZ is used by arborists to reduce shoot growth and has been shown to have additional positive effects on trees and shrubs. Among those are improved resistance to drought stress, darker green leaves, higher resistance against fungi and bacteria, and enhanced development of roots. Cambial growth, as well as shoot growth, has been shown to be reduced in some tree species.

Triacontanol is a fatty alcohol of the general formula C₃₀H₆₂O, also known as melissyl alcohol or myricyl alcohol. It is found in plant cuticle waxes and in beeswax. Triacontanol has been reported to increase the growth of plants by enhancing the rates of photosynthesis, protein biosynthesis, the transport of nutrients in a plant and enzyme activity, reducing complex carbohydrates among many other purposes. The fatty alcohol appears to increase the physiological efficiency of plant cells and boost the potential of the cells responsible for the growth and maturity of a plant.

The synergistic composition of pesticide are used to protect the crops and plants from insect and pests. The lists of the major crops includes but are not limited to GMO (Genetically Modified Organism) and Non GMO varieties of Cotton (Gossypium spp.), Paddy (Oryza sativa), Wheat (Triticum aestavum), Barley (Hordeum vulgare), Maize (Zea mays), Sorghum (Sorghum bicolor), Oat (Avena sativa), Pearl millet (Pennisetum glaucum), Sugarcane (Saccharum officinarum), Sugarbeet (Beta vulgaris), Soybean (Glycin max), Peanut (Arachis hypogaea), Sunflower (Helianthus annuus), Mustard (Brassica juncea), Rape seed (Brassica napus), Linseed (Linum usitatissimum), Sesame (Sesamum indicum), Green gram (Vigna radiata), Black gram (Vigna mungo), Chickpea (Cicer aritinum), Cowpea (Vigna unguiculata), Redgram (Cajanus cajan), Frenchbean (Phaseolus vulgaris), Indian bean (Lablab purpureus), Horse gram (Macrotyloma uniflorum), Field pea (Pisum sativum), Cluster bean (Cyamopsis tetragonoloba), Lentils (Lens culinaris), Brinjal (Solanum melongena), Cabbage (Brassica oleracea var. capitata), Cauliflower (Brassica oleracea var. botrytis), Okra (Abelmoschus esculentus), Onion (Allium cepa L.), Tomato (Solanum lycopersicun), Potato (Solanum tuberosum), Sweet potato (Ipomoea batatas), Chilly (Capsicum annum), Garlic (Allium sativum), Cucumber (Cucumis sativus), Muskmelons (Cucumis melo), Watermelon (Citrullus lanatus), Bottle gourd (Lagenaria siceraria), Bitter gourd (Momordica charantia), Radish (Raphanus sativus), Carrot (Dacus carota subsp. sativus), Turnip (Brassica rapa subsp rapa), Apple (Melus domestica), Banana (Musa spp.), Citrus groups (Citrus spp.), Grape (Vitis vinifera), Guava (Psidium guajava), Litchi (Litchi chinensis), Mango (Mangifera indica), Papaya (Carica papaya), Pineapple (Ananas comosus), Pomegranate (Punica granatum), Sapota (Manilkara zapota), Tea (Camellia sinensis), Coffea (Coffea Arabica), Turmeric (Curcuma longa), Ginger (Zingiber officinale), Cumin (Cuminum cyminum), Fenugreek (Trigonella foenum-graecum), Fennel (Foeniculum vulgare), Coriander (Coriandrum sativum), Ajwain (Trachyspermum ammi), Psyllium (Plantago ovate), Black Pepper (Piper nigrum), Stevia (Stevia rebaudiana), Safed musli (Chlorophytum tuberosum), Drum stick (Moringa oleifera), Coconut (Coco nucifera), Mentha (Mentha spp.), Rose (Rosa spp.), Jasmine (Jasminum spp.), Marigold (Tagetes spp.), Common daisy (Bellis perennis), Dahlia (Dahlia hortnesis), Gerbera (Gerbera jamesonii), Carnation (Dianthus caryophyllus), vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

The synergistic combination of the present invention used to control the insects-pests and plant parasitic nematode. The major insects pests are belongs to the order Hemiptera, for example, rice leafhopper Nephotettix nigropictus, rice brown plant hopper Nilaparvata lugen, rice white backed plant hopper, Apple Mealy bug Phenococcus aceris, bean aphid Aphis fabae, black citrus aphid Toxoptera aurantii, citrus black scale Saissetia oleae, cabbage aphid Brevicoryne brassicae, Lipaphis erysimi, citrus red scale Aonidiella aurantii, yellow scale Aonidiella citrine, citrus mealybug Planococcus citri, corn leaf aphid Rhopalosiphum maidis, cotton aphid Aphis gossypii, cotton jassid Amrasca biguttula biguttla, cotton mealy bug Planococcus spp. And Pseudococcus spp., cotton stainer Dysdercus suturellus, cotton whitefly Bemisia tabaci, cowpea aphid Aphis crassivora, grain aphid Sitobion avenae, golden glow aphid Uroleucon spp., grape mealybug Pseudococcus maritimus, green peach aphid Myzus persicae, greenhouse whitefly Trialeurodes vaporariorum, papaya mealy bug Pracoccus marginatus, pea aphid Acyrthosiphon pisum, sugarcane mealybug Saccharicoccus sacchari, potato aphid Myzus persicae, potato leaf hopper Empoasca fabae, cotton whitefly Bemisia tabaci, tarnished plant bug Lygus lineolaris, wooly apple aphid Eriosoma lanigerum, mango hopper Amritodus atkinsoni, Idioscopus spp.; order Lepidoptera, army worm Mythimna unipuncta, asiatic rice borer Chilo suppressalis, bean pod borer Maruca vitrata, beet armyworm Spodoptera exigua, black cutworm Agrotis ipsilon, bollworm Helicoverpa armigera, cabbage looper Trichoplusia ni, codling moth Cydia pomonella, croton caterpillar Achea janata, diamond backmoth Plutella xylostella, cabbage worm Pieris rapae, pink bollworm Pectinophora gossypiella, sugarcane borer Diatraea saccharalis, tobacco budworm Heliothis virescens, tomato fruitworm Helicoverpa zea, velvet bean caterpillar Anticarsia gemmatalis, yellow stem borer Scirpophaga incertulas, spotted bollworm Earias vittella, rice leaffolder Cnaphalocrocis medinalis, pink stem borer Sesamia spp., tobacco leafeating caterpillar Spodoptera litura; brinjal fruit and shoot borer Leucinodes orbonalis, bean pod borer Maruca vitrata, Maruca testulalis, armyworm Mythimna separata, cotton pinkbollworm Pectinophora gossypiella, citrus leafminer Phyllocnistis citrella, cabbage butterfly Pieris bras-sicae, diamond backmoth Plutella xylostella, paddy stem borer Scirpophaga excerptallis, Scirpophaga incertulas, Scirpophaga innotata, wheat stem borer Sesamia inferens, Sitotroga cerealella, Spilosoma obliqua, Spodoptera frugiperda, Spodoptera littoralis, Spodoptera litura, Trichoplusia ni, Tryporyza novella, Tuta absoluta. from the order Coleoptera, for example, apple twig borer Amphicerus spp., corn root worm Diabrotica virgifera, cucumber beetle diabrotica balteata, boll weevil Anthonomus grandis, grape flea beetle Altica chalybea, grape root worm Fidia viticola, grape trunk borer Clytoleptus albofasciatus, radish flea beetle Phyllotreta armoraciae, maize weevil Sitophilus zeamais, northern corn rootworm Diabrotica barberi, rice water weevil Lissorhoptrus oryzophilus, Anthonomus grandis, Bruchus lentis, Diabrotica semipunctata, Diabrotica virgifera, Dicladispa armigera, Epila-chna varivestis, various species of white grubs are Holotrichia bicolor, Holotrichia consanguinea, Holotrichia serrata, Leptinotarsa decemlineata, Phyllotreta chrysocephala, Popillia japonica etc; from the order Orthoptera, for example, Gryllotalpa spp., Locusta spp., and Schistocerca is spp.; from the order Thysanoptera, for example, Frankliniella spp., Thrips palmi, Thrips tabaci and Scirtothrips dorsalis; termites (Isoptera), e.g. Calotermes flavicollis, Coptotermes formosanus, Heterotermes aureus, Leucotermes flavipes, Microtermes obesi, Odontotermes obesus, Reticulitermes flavipes, Termes natalensis; from the order Heteroptera, for example, Dysdercus spp., Leptocorisa spp., from the order Hymenoptera, for example, Solenopsis spp.; from the order Diptera, for example, Antherigona soccata, Dacus spp., Liriomyza spp., Melanagromyza spp., from the order Acarina, for example, Aceria mangiferae, Brevipalpus spp., Eriophyes spp., Oligonychus mangiferus, Oligonychus punicae, Panonychus citri, Panonychus ulmi, Polyphagotarsonemus latus, Tarsonemus spp., Tetranychus urticae, Tetranychus cinnabarinus;

plant parasitic nematodes such as root-knot nematodes, Meloidogyne incognita, Meloidogyne javanica and other Meloidogyne species; cyst nematodes, Globodera rostochiensis, Globodera pallida, Globodera tabacum and other Globodera species, Heterodera avenae, Heterodera glycines, Heterodera schachtii, Heterodera trifolii, and other Heterodera species.

The composition according to the invention can be applied to any and all developmental stages of pests, such as egg, larva, pupa, and adult. The pests may be controlled by contacting the target pest, its food supply, habitat, breeding ground or its locus with a pesticidally effective amount of the inventive mixtures or of compositions comprising the mixtures.

The term “health of a plant” or “plant health” is defined as a condition of the plant and/or its products. As a result of the improved health, yield, plant vigor, quality and tolerance to abiotic or biotic stress are increased. Noteworthy, the health of a plant when applying the method according to the invention, is increased independently of the pesticidal properties of the active ingredients used because the increase in health is not based upon the reduced pest pressure but instead on complex physiological and metabolic reactions which result for example in an activation of the plant's own natural defense system. As a result, the health of a plant is increased even in the absence of pest pressure. Accordingly, in an especially preferred embodiment of the method according to the invention, the health of a plant is increased both in the presence and absence of biotic or abiotic stress factors. The above identified indicators for the health condition of a plant may be interdependent or they may result from each other. An increase in plant vigor may for example result in an increased yield and/or tolerance to abiotic or biotic stress. One indicator for the condition of the plant is the yield. “Yield” is to be understood as any plant product of economic value that is produced by the plant such as grains, fruits in the proper sense, vegetables, nuts, grains, seeds, wood (e.g. in the case of silviculture plants) or even flowers (e.g. in the case of gardening plants, ornamentals). The plant products may in addition be further utilized and/or processed after harvesting.

In an especially preferred embodiment of the invention, the yield of the treated plant is increased.

In another preferred embodiment of the invention, the yield of the plants treated according to the method of the invention, is increased synergistically.

According to the present invention, “increased yield” of a plant, in particular of an agricultural, silvicultural and/or horticultural plant means that the yield of a product of the respective plant is increased by a measurable amount over the yield of the same product of the plant produced under the same conditions, but without the application of the mixture according to the invention.

Increased yield can be characterized, among others, by the following improved proper-ties of the plant: increased plant, weight, increased plant height, increased biomass such as higher overall fresh weight (FW), increased number of flowers per plant, higher grain yield, more tillers or side shoots (branches), larger leaves, increased shoot growth, increased protein content, increased oil content, increased starch content, increased pigment content, increased leaf are index.

According to the present invention, the yield is increased by at least 4%, preferable by 5 to 10%, more preferable by 10 to 20%, or even 20 to 30% compared to the untreated control plants or plants treated with pesticides in a way different from the method according to the present invention. In general, the yield increase may even be higher.

A further indicator for the condition of the plant is the plant vigor. The plant vigor becomes manifest in several aspects such as the general visual appearance. In another especially preferred embodiment of the invention, the plant vigor of the treated plant is increased. In another preferred embodiment of the invention, the plant vigor of the plants treated according to the method of the invention, is increased synergistically. Improved plant vigor can be characterized, among others, by the following improved properties of the plant: improved vitality of the plant, improved plant growth, improved plant development, improved visual appearance, improved plant stand (less plant verse/lodging), improved emergence, enhanced root growth and/or more developed root system, enhanced nodulation, in particular rhizobial nodulation, bigger leaf blade, bigger size, increased plant weight, increased plant height, increased tiller number, increased number of side shoots, increased number of flowers per plant, increased shoot growth, increased root growth (extensive root system), increased yield when grown on poor soils or unfavorable climate, enhanced photosynthetic activity (e.g. based on increased stomatal conductance and/or increased C02 assimilation rate), increased stomatal conductance, increased C02 assimilation rate, enhanced pigment content (e.g. chlorophyll content), earlier flowering, earlier fruiting, earlier and improved germination, earlier grain maturity, improved self-defense mechanisms, improved stress tolerance and resistance of the plants against biotic and abiotic stress factors such as fungi, bacteria, viruses, insects, heat stress, cold stress, drought stress, UV stress and/or salt stress, less non-productive tillers, less dead basal leaves, less input needed (such as fertilizers or water), greener leaves, complete maturation under shortened vegetation periods, less fertilizers needed, less seeds needed, easier harvesting, faster and more uniform ripening, longer shelf-life, longer panicles, delay of senescence, stronger and/or more productive tillers, better extractability of ingredients, improved quality of seeds (for being seeded in the following seasons for seed production), better nitrogen uptake, improved reproduction, reduced production of ethylene and/or the inhibition of its reception by the plant.

The improvement of the plant vigor according to the present invention particularly means that the improvement of any one or several or all of the above mentioned plant characteristics are improved independently of the pesticidal action of the mixture or active ingredients (components).

Another indicator for the condition of the plant is the “quality” of a plant and/or its products.

In an especially preferred embodiment of the invention, the quality of the treated plant is increased.

In another preferred embodiment of the invention, the quality of the plants treated according to the method of the invention, is increased synergistically.

According to the present invention, enhanced quality means that certain plant characteristics such as the content or composition of certain ingredients are increased or improved by a measurable or noticeable amount over the same factor of the plant produced under the same conditions, but without the application of the mixtures of the present invention. Enhanced quality can be characterized, among others, by following improved properties of the plant or its product: increased nutrient content, increased protein content, increased content of fatty acids, increased metabolite content, increased carotenoid content, increased sugar content, increased amount of essential amino acids, improved nutrient composition, improved protein composition, improved composition of fatty acids, improved metabolite composition, improved carotenoid composition, improved sugar composition, improved amino acids composition, improved or optimal fruit color, improved leaf color, higher storage capacity, higher processability of the harvested products.

Another indicator for the condition of the plant is the plant's tolerance or resistance to biotic and/or abiotic stress factors. Biotic and abiotic stress, especially over longer terms, can have harmful effects on plants. Biotic stress is caused by living organisms while abiotic stress is caused for example by environmental extremes. According to the present invention, “enhanced tolerance or resistance to biotic and/or abiotic stress factors” means (1.) that certain negative factors caused by biotic and/or abiotic stress are diminished in a measurable or noticeable amount as compared to plants exposed to the same conditions, but without being treated with a mixture according to the invention and (2.) that the negative effects are not diminished by a direct action of the mixture according to the invention on the stress factors, e.g. by its fungicidal or insecticidal action which directly destroys the microorganisms or pests, but rather by a stimulation of the plants' own defensive reactions against said stress factors.

Formulation of the present invention can be in any of the formulations selected from Capsule suspension (CS), Dispersible concentrate (DC), Powder for dry seed treatment (DS), Emulsifiable concentrate (EC), Emulsion, water in oil (EO), Emulsion for seed treatment (ES), Emulsion, oil in water (EW), Flowable suspension/concentrate for seed treatment (FS), Granule/soil applied (GR), Controlled (Slow or Fast) release granules (CR), Solution for seed treatment (LS), Micro-emulsion (ME), Oil dispersion (OD), Oil miscible flowable concentrate (oil miscible suspension (OF), Oil miscible liquid (OL), Suspension concentrate (=flowable concentrate) (SC), Suspo-emulsion (SE), Water soluble granule (SG), Soluble concentrate (SL), Water soluble powder (SP), Water dispersible granule (WG or WDG), Wettable powder (WP), Water dispersible powder for slurry treatment (WS), A mixed formulation of CS and SC (ZC), A mixed formulation of CS and SE (ZE), A mixed formulation of CS and EW (ZW).

One or more of the active ingredients is encapsulated for various purposes, such as to increase the residual biological activity, or to reduce the acute toxicity, or to obtain a physical or chemically stable water-based formulation. The purpose determines whether the “free” active ingredient and the “release rate” are relevant properties of a specific product.

Further composition comprising (A) at least one insecticide from class of diamide selected from chlorantraniliprole, cyantraniliprole, cyclaniliprole, cyhalodiamide, cyproflanilide, flubendiamide, tetrachlorantraniliprole, tyclopyrazoflor, tetraniliprole; from class of metadiamides is broflanilide; or from class of Isoxazoline selected from Fluxametamide, Isocycloseram; or mixture thereof; (B) at least one plant growth regulator selected from the class of Anti-auxins, Auxin, Cytokinins, Defoliants, Ethylene modulators, Ethylene releasers, Gibberellins, Growth Inhibitors, Morphactins, Growth retardants, Growth stimulants, Unclassified plant growth regulators; (C) at least one more insecticidal compound selected from the group with different mode of action are present in the said composition in specific fixed ratio.

In further aspect the present invention relates to the synergistic insecticidal composition comprising bioactive amounts of (A) is 0.1 to 40% w/w of the composition; (B) is 0.001 to 20% w/w of the composition; and (C) is 0.01 to 40% w/w of the composition.

Active Ingredients

| | Compound A | Compound B | Compound C |
|---|---|---|---|
| Examples | Insecticide | Plant Growth | One more |
| | from the class | Regulator | Insecticide(s) |
| | of diamides, | | |
| | metadiamides, | | |
| | Isoxazolines. | | |
| % of Active | 0.1 to 40% | 0.001 to 20% | 0.01 to 40% |
| Ingredient | | | |

The composition of the present invention in addition to bioactive amounts of active ingredients further comprises inactive excipients including but not limited to dispersant, anti-freezing agent, anti-foam agent, wetting agent, suspension aid, antimicrobial agent, thickener, quick coating agent or sticking agents, filler, binders, anticaking agents, absorbents and buffering agent.

A dispersant is a substance which adsorbs onto the surface of particles and helps to preserve the state of dispersion of the particles and prevents them from re-aggregating. Dispersants are added to agrochemical formulations to facilitate dispersion and suspension during manufacture, and to ensure the particles re-disperse into water in a spray tank. They are widely used in wettable powders, suspension concentrates and water-dispersible granules. Surfactants that are used as dispersants have the ability to adsorb strongly onto a particle surface and provide a charged or steric barrier to reaggregation of particles. The most commonly used surfactants are anionic, non-ionic, or mixtures of the two types. For wettable powder formulations, the most common dispersants are sodium lingo sulphonates. For suspension concentrates, very good adsorption and stabilization are obtained using polyelectrolytes, such as sodium naphthalene sulphonate formaldehyde condensates. Tristyrylphenolethoxylate phosphate esters are also used. Nonionics such as alkyl aryl ethylene oxide condensates and EO-PO block copolymers are sometimes combined with anionics as dispersants for suspension concentrates. In recent years, new types of very high molecular weight polymeric surfactants have been developed as dispersants. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces. Examples of dispersants or dispersing agent used herein include but not limited to alkylated naphthalene sulfonate, sodium salt, Sodium salt of naphthalene sulfonate condensate, Sodium Ligno sulfonate, Sodium ploycarboxylate, EO/PO based copolymer, Phenol sulfonate, Sodium Methyl Oleoyl Taurate, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide, Copolymer of propylene oxide (PO) and ethylene oxide (EO) and/or an ethoxylated tristyrene phenol, copolymer of PO and EO is alpha-butyl-omega-hydroxypoly(oxypropylene) block polymer with poly(oxyethylene), ethoxylated tristyrene phenol is alpha-[2,4,6-tris[1-(phenyl)ethyl] phenyl]-omega-hydroxy poly(oxyethylene, poly(oxy-1,2-ethanediyl)-alpha-C10-15alkyl-omega-hydroxy phosphate or sulphate and/or a C10-13alkylbenzenesulfonic acid, tristyrylphenols, nonylphenols, dinonylphenol and octylphenols, styrylphenol polyethoxyester phosphate, alkoxylated C14-20fatty amines, Naphthalenesulfonic acid, sodium salt condensated with formaldehyde, polyalcoxylated alkylphenol, naphthalenesulfonic acid formaldehyde condensate, methylnaphtaline-formaldehyde-condensate sodium salt, napthalene condensates, lignosulfonates, polyacrylates and phosphate esters, calcium lignosulfonate, lignin sulfonate sodium salt or mixture thereof.

Anti-freezing agent as used herein can be selected from the group consisting of polyethylene glycols, methoxy polyethylene glycols, polypropylene glycols, polybutylene glycols, glycerin and ethylene glycol. Water-based formulations often cause foam during mixing operations in production. In order to reduce the tendency to foam, anti-foam agents are often added either during the production stage or before filling into bottles. Generally, there are two types of antifoam agents, namely silicones and non-silicones. Silicones are usually aqueous emulsions of dimethyl poly siloxane while the non-silicone anti-foam agents are water-insoluble oils, such as octanol and nonanol, or silica. In both cases, the function of the anti-foam agent is to displace the surfactant from the air-water interface.

A wetting agent is a substance that when added to a liquid increases the spreading or penetration power of the liquid by reducing the interfacial tension between the liquid and the surface on which it is spreading. Wetting agents are used for two main functions in agrochemical formulations: during processing and manufacture to increase the rate of wetting of powders in water to make concentrates for soluble liquids or suspension concentrates; and during mixing of a product with water in a spray tank or other vessel to reduce the wetting time of wettable powders and to improve the penetration of water into water-dispersible granules. Examples of wetting agents used in wettable powder, suspension concentrate, and water-dispersible granule formulations include but not limited to Mono C2-6alkyl ether of a polyC2-4alkylene oxide block copolymer, condensation product of castor oil and polyC2-4alkylene oxide, alkoxylated castor oil is available under the trade name Agnique CSO-36, a mono- or di-ester of a C12-24fatty acid and polyC2-4alkylene oxide, carboxylates, sulphates, sulphonates, alcohol ethoxylates, alkyl phenol ethoxylates, fatty acid ethoxylates, sorbitan esters, ethoxylated fats or oils, amine ethoxylates, phosphate esters, ethylene oxide-propylene oxide copolymers, fluorocarbons, alkyd-polyethylene glycol resin, polyalkylene glycol ether, apolyalkoxylated nonyl phenyl, alkoxylated primary alcohol, ethoxylated distyrylphenol, ethoxylated distyrylphenol sulphate, ethoxylated tristyrylphenol phosphate, tristyrylphenol phosphate ester, hydroxylated stearic acid polyalkylene glycol polymer, and their corresponding salts, alkyd-polyethylene glycol resin, polyalkylene glycol ether, ethoxylated distyrylphenol, ethoxylated distyrylphenol sulphate, ethoxylated tristyrylphenol phosphate, tristyrylphenol phosphate ester, tristyrylphenol phosphate potassium salt, dodecysulfate sodium salt or mixture thereof.

Suspension aid in the present description denotes a natural or synthetic, organic or inorganic material with which the active substance is combined in order to facilitate its application to the plant, to the seeds or to the soil. This carrier is hence generally inert, and it must be agriculturally acceptable, in particular to the plant being treated. The carrier may be solid (clays, natural or synthetic silicates, silica, resins, waxes, solid fertilizers, and the like or mixtures thereof) or liquid (water, alcohols, ketones, petroleum fractions, aromatic or paraffinic hydrocarbons, chlorinated hydrocarbons, liquefied gases, and the like or mixtures thereof). Further specifically suspending agents for the present formulation is selected from Aluminum Magnesium Silicate, Bentonite clay, Silica, Attapulgite clay.

Biocides/Microorganisms cause spoilage of formulated products. Therefore antimicrobial agents are used to eliminate or reduce their effect. Examples of such agents include, but are not limited to: propionic acid and its sodium salt; sorbic acid and its sodium or potassium salts; benzoic acid and its sodium salt; p-hydroxy benzoic acid sodium salt; methyl p-hydroxy benzoate; and biocide such as sodium benzoate, 1,2-benzisothiazoline-3-one, 2-methyl-4-isothiazolin-3-one, 5-chloro-2-methyl-4-isothiazolin-3-one, potassium sorbate, para hydroxy benzoates or mixtures thereof.

Thickeners or gelling agents are used mainly in the formulation of suspension concentrates, emulsions and suspoemulsions to modify the rheology or flow properties of the liquid and to prevent separation and settling of the dispersed particles or droplets. Thickening, gelling, and anti-settling agents generally fall into two categories, namely water-insoluble particulates and water-soluble polymers. It is possible to produce suspension concentrate formulations using clays and silicas. Examples of these types of materials, include, but are limited to, montmorillonite, e.g. bentonite; magnesium aluminum silicate; and attapulgite. Water-soluble polysaccharides have been used as thickening-gelling agents for many years. The types of polysaccharides most commonly used are natural extracts of seeds and seaweeds are synthetic derivatives of cellulose or mixtures thereof. Examples of these types of materials include, but are not limited to, guar gum; locust bean gum; carrageenam; xanthan gum; alginates; methyl cellulose; sodium carboxymethyl cellulose (SCMC); hydroxyethyl cellulose (HEC) or mixtures thereof. Other types of anti-settling agents are based on modified starches, polyacrylates, polyvinyl alcohol and polyethylene oxide or mixtures.

The quick coating agent can be a conventionally available sticker, for example polyesters, polyamides, poly-carbonates, polyurea and polyurethanes, acrylate polymers and copolymers, styrene copolymers, butadiene copolymers, polysaccharides such as starch and cellulose derivatives, vinyl alcohol, vinyl acetate and vinyl pyrrolidone polymers and copolymers, polyethers, epoxy, phenolic and melamine resins, polyolefins and define copolymers and mixtures thereof. Examples of preferred polymers are acrylate polymers such as poly(methacrylate), poly(ethyl methacrylate), poly(methyl methacrylate), acrylate copoylmers and styrene-acrylic copolymers as defined herein below, poly(styrene-co maleic anhydride), cellulosic polymers such as ethyl cellulose, cellulose acetate, cellulose acetatebutyrate, acetylated mono, di, and triglycerides, poly(vinyl pyrrolidone), vinyl acetate polymers and copolymers, poly(alkylene glycol), styrene butadiene copolymers, poly(ortho esters), alkyd resins, and mixtures of two or more of these.

Polymers that are biodegradable are also useful in the present invention. As used herein, a polymer is biodegradable if is not water soluble, but is degraded over a period of several weeks when placed in an application environment. Examples of biodegradable polymers that are useful in the present invention include biodegradable polyesters, starch, polylactic acid starch blends, polylactic acid, poly(lactic acid-glycolic acid) copolymers, polydioxanone, cellulose esters, ethyl cellulose, cellulose acetate butyrate, starch esters, starch ester aliphatic polyester blends, modified corn starch, poly capro lactone, poly(namylmethacrylate), wood rosin, poly anhydrides, poly vinyl alcohol, poly hydroxyl butyrate valerate, biodegradable aliphatic polyesters, and poly hydroxyl butyrate or mixtures thereof.

Buffering agent as used herein is selected from group consisting of calcium hydroxyapatite, Potassium Dihydrogen Phosphate, Sodium Hydroxide, carbonated apatite, calcium carbonate, sodium bicarbonate, tricalcium phosphate, calcium phosphates, carbonated calcium phosphates, amine monomers, lactate dehydrogenase and magnesium hydroxide.

Antifoaming agent for the present formulation is selected from silicone oil, silicone compound, C10˜C20 saturated fat acid compounds or C8˜C10 aliphatic alcohols compound, Silicone antifoam emulsion, Dimethylsiloxane, Polydimethyl siloxane, Vegetable oil based antifoam, tallow based fatty acids, polyalkyleneoxide modified polydimethylsiloxane.

Diintegrating agent for the present formulation is selected from citric acid, succinic acid or the sodium bicarbonate.

Carrier for the present formulation is selected from diatomaceous earth, attapulgite or zeolites, dolomite, limestone, silica, fly ash, hydrated lime, wheat flour, wood flour, ground wheat straw, cellulose and soy flour, bentonite, kaolin, attapulgite, diatomaceous earth, calcium carbonate, talc, muscovite mica, fused sodium potassium, aluminum silicate, perlite, talc and muscovite mica, urea, sulfur-coated urea, isobutylidene diurea, ammonium nitrate, ammonium sulfate, ammonium phosphate, triple super phosphate, phosphoric acid, potassium sulfate, potassium nitrate, potassium metaphosphate, potassium chloride, dipotassium carbonate, potassium oxide and a combination of these, Calcium, magnesium, sulfur, iron, manganese, copper, zinc; oxides, humic acid, Wood floor, Calcium silicate, Cellulose granules, Magnesium stearate, China Clay, Silica, Lactose anhydrous, Ammonium sulfate, Sodium sulfate anhydrous, Corn starch, Urea, EDTA.

Colorants for the present formulation is selected from Crystal violet, Thalocyano dye chlorinated, Aerosol green FFB dye, Rodamine, Azo compound.

Preservative for the present formulation is selected from 1,2-benzisothiazolin-3(2H)-one, sodium salt, Sodium benzoate, 2-bromo-2-nitropropane-1,3-diol, Formaldehyde, Sodium o-phenylphenate, 5-chloro-2-methyl-4-isothiazolin-3-one & 2-methyl-4-isothiazolin-3-one.

The solvent for the formulation of the present invention may include water, water soluble alcohols and dihydroxy alcohol ethers. The water-soluble alcohol which can be used in the present invention may be lower alcohols or water-soluble macromolecular alcohols. The term “lower alcohol”, as used herein, represents an alcohol having 1-4 carbon atoms, such as methanol, ethanol, n-propanol, isopropanol, n-butanol, tertbutanol, etc. Macromolecular alcohol is not limited, as long as it may be dissolved in water in a suitable amount range, e.g., polyethylene glycol, sorbitol, glucitol, etc. The examples of suitable dihydroxy alcohol ethers used in the present invention may be dihydroxy alcohol alkyl ethers or dihydroxy alcohol aryl ethers. The examples of dihydroxy alcohol alkyl ether include ethylene glycol methyl ether, diethylene glycol methyl ether, propylene glycol methyl ether, dipropylene glycol methyl ether, ethylene glycol ethyl ether, diethylene glycol ethyl ether, propylene glycol ethyl ether, dipropylene glycol ethyl ether, etc. The examples of dihydroxy alcohol aryl ethers include ethylene glycol phenyl ether, diethylene glycol phenyl ether, propylene glycol phenyl ether, dipropylene glycol phenyl ether, and the like. Any of the above mentioned solvent can be used either alone or in combination thereof.

The process for preparing the present novel synergistic composition can be modified accordingly by any person skilled in the art based on the knowledge of the manufacturing the formulation. However all such variation and modification is still covered by the scope of present invention.

The present invention highlights the synergistic effect of the combination of the at least one insecticide selected from class of diamide, metadiamides, isoxazolines or mixture thereof; at least one plant growth regulator or mixture thereof; and at least one more insecticide from various groups or mixture thereof. Following the right use of the invented technology and the synergistic insecticidal composition of the invention with a formulations having a multi-pesticide components i.e. pesticide mixture, formulation prepared with an extra care of physical compatibility by purposefully specially selected solvents, dispersing agents, carriers and the surfactants, thickeners, stabilisers etc. exhibits better insect and pest management and boost plant health.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. The invention shall now be described with reference to the following specific examples. It should be noted that the example(s) appended below illustrate rather than limit the invention, and that those skilled in the art will be able to design many alternative embodiments without departing from the scope of the present invention.

These and other aspects of the invention may become more apparent from the examples set forth herein below. These examples are provided merely as illustrations of the invention and are not intended to be construed as a limitation thereof.

Granules formulation can be prepares by the method of preparation by Granules (GR) and Controlled Released Granules.

### Manufacturing Process of Granules (GR)

| | |
|---|---|
| Step 1 | Charged required quantity of carrier into the booth mixture |
| | with help of bucket elevator, then add other raw material (as |
| | technical, solvent, Surfactant, stabilizer, and binder) into |
| | the booth mixture and at this point add filler and allow |
| | mixing for another 20 minutes for homogenization. |
| Step 2 | After completion of raw material addition and proper mixing, |
| | stop booth mixture for sampling. |
| Step 3 | Sample is sent for QC approval and approved material is |
| | unloaded in 25 Kg HDPE woven bags. |

### Manufacturing Process of Controlled Release Granule

| | |
|---|---|
| Step 1 | Charge required quantity of filler in booth mixer |
| Step 2 | Charge required quantity of technical material and homogenies. |
| Step 3 | Now spray solution of binding agents and slowly in atomized |
| | form |
| Step 4 | Homogenize and dry the material to form irregular granules of |
| | spherical shape |
| Step 5 | Now add required quantity of hydrophobic filler and spray |
| | remaining binding agent. |
| Step 6 | Homogenize and send sample to lab for final analysis. |

Water dispersible granules can be formed by a) agglomeration, b) spray drying, or c) extrusion techniques.
In an embodiment of the present invention generalised procedure for the preparation of Water Dispersible Granules (WG) can be given as below:

### Manufacturing Process of Water Dispersible Granules (WG) by Extrusion Method

| | |
|---|---|
| Step 1 | Charge the required quantity of filler, wetting agent, dispersing |
| | agent, and suspending agent, & technical in premixing blender |
| | for homogenization for 30 minutes. |
| Step 2 | Pre-blended material is then grinded through Jet mill/air |
| | classifier mills. Finely grinded material is blended in post |
| | blender till it becomes homogeneous. (For approx. 1.5 hr.) |
| Step 3 | Finely grinded powder is mixed with required quantity of water |
| | to form extrudable dough. |
| Step 4 | Dough is passed through extruder to get granules of required |
| | size. |
| Step 5 | Wet granules are passed through Fluidized bed drier and further |
| | graded using vibrating screens. |
| Step 6 | Final product is sent for QC approval. |
| Step 7 | After approval material is packed in required pack sizes. |

### Manufacturing Process of Water Dispersible Granules (WG) by Spray Dried Method

| | |
|---|---|
| Step 1 | Charge required quantity of DM water need to be taken in |
| | designated vessel for production. |
| Step 2 | Add required quantity of Wetting agent, dispersing agent, |
| | antifoam & suspending agents and homogenize the contents |
| | for 45-60 minutes using high shear homogenizer. |
| Step 3 | Add required quantity technical and homogenized to get |
| | uniform slurry ready for grinding. |
| Step 4 | Now material is subjected to grinding in Bead mill till |
| | desired particle size is achieved. |
| Step 5 | After grinding process completes the material is sprayed |
| | at required temperature. |
| Step 6 | After completion of spray drying process material is |
| | collected and sent for QC department approval. |
| Step 7 | After approval material is packed in required pack sizes. |

### Example 1

Granule (GR) formulation of Chlorantraniliprole 0.3%+Paclobutrazol 0.3%+Thiamethoxam 1.0%.

| Chemical composition | % (w/w) |
|---|---|
| Chlorantraniliprole a.i. | 0.30 |
| Paclobutrazol a.i. | 0.30 |
| Thiamethoxam a.i. | 1.00 |
| Wetting agent | 3.00 |
| Dispersing agent II | 1.00 |
| Dispersing agent II | 2.00 |
| Colourant | 0.50 |
| Solvent | 4.00 |
| Carrier | 87.90 |
| Total | 100.00 |

### Procedure: Manufacturing Process of Granules (GR)

| | |
|---|---|
| Step 1 | Charged required quantity of carrier into the booth mixture with |
| | help of bucket elevator, then add other raw material (as |
| | technical, solvent, Surfactant, stabilizer, and binder) into the |
| | booth mixture and at this point add filler and allow mixing for |
| | another 20 minutes for homogenization. |
| Step 2 | After completion of raw material addition and proper mixing, |
| | stop booth mixture for sampling. |
| Step 3 | Sample is sent for QC approval and approved material is |
| | unloaded in 25 Kg HDPE woven bags. |

### Storage Stability:

Storage stability of Granule (GR) formulation of Chlorantraniliprole
0.3% + Paclobutrazol 0.3% + Thiamethoxam 1.0%
Laboratory storage stability for 14 days

| | | | | Cold |
|---|---|---|---|---|
| | | | Heat | storage |
| | Specification | | stability at | stability at |
| Parameters | (in house) | Initial | 54 ± 2° C. | 0 ± 2° C. |
| Chlorantraniliprole | 0.27 to 0.33 | 0.32 | 0.31 | 0.32 |
| content percent by | | | | |
| mass | | | | |
| Paclobutrazol content | 0.27 to 0.33 | 0.31 | 0.30 | 0.31 |
| percent by mass | | | | |
| Thiamethoxam content | 0.90 to 1.10 | 1.05 | 1.03 | 1.05 |
| percent by mass | | | | |
| pH range (1% aq. | 4.0 to 7.0 | 5.50 | 5.50 | 5.50 |
| Suspension) | | | | |
| Dustiness | <20 mg | 10 | 10 | 10 |
| Dry sieve (300 micron) | >90% | 99.5 | 99.2 | 99.3 |
| percent by mass min. | | | | |
| Attrition Resistance | <5% | 2.1 | 2.1 | 2.1 |
| (<100 micron) | | | | |
| Bulk density (g/ml) | 1.25 to 1.50 | 1.3 | 1.3 | 1.3 |
| Moisture content | max. 2% | 1 | 1 | 1 |
| percent by mass max. | | | | |

Room temperature storage stability up to 12 months

| | specification | | | |
|---|---|---|---|---|
| Parameters | (in house) | 1 month | 6 month | 12 month |
| Chlorantraniliprole | 0.27 to 0.33 | 0.32 | 0.31 | 0.30 |
| content percent by | | | | |
| mass | | | | |
| Paclobutrazol content | 0.27 to 0.33 | 0.31 | 0.31 | 0.30 |
| percent by mass | | | | |
| Thiamethoxam content | 0.90 to 1.10 | 1.05 | 1.04 | 1.03 |
| percent by mass | | | | |
| pH range (1% aq. | 4.0 to 7.0 | 5.50 | 5.50 | 5.50 |
| Suspension) | | | | |
| Dustiness | <20 mg | 10 | 10 | 10 |
| Dry sieve (300 micron) | >90% | 99.5 | 96.35 | 96.25 |
| percent by mass min. | | | | |
| Attrition Resistance | <5% | 2.1 | 2.1 | 2.1 |
| (<100 micron) | | | | |
| Bulk density (g/ml) | 1.25 to 1.50 | 1.3 | 1.3 | 1.3 |
| Moisture content | max. 2% | 1 | 1 | 1 |
| percent by mass max. | | | | |

### Example 2

Water Dispersible Granule (WG) Formulation of Chlorantraniliprole 7.5% Gibberellic Acid 0.005%+Pymetrozine 37.5%

| Chemical composition | % (w/w) |
|---|---|
| Chlorantraniliprole a.i. | 7.50 |
| Gibberellic acid a.i. | 0.005 |
| Pymetrozine a.i. | 37.50 |
| Wetting agent | 3.00 |
| Dispersing agent I | 8.00 |
| Dispersing agent II | 2.00 |
| Disintegrating agent | 0.50 |
| Antifoaming agent | 1.00 |
| Carrier | 40.49 |
| Total | 100.00 |

### Procedure: Manufacturing Process of Water Dispersible Granules (WG) by Spray Dried Method

| | |
|---|---|
| Step 1 | Charge required quantity of DM water need to be taken in |
| | designated vessel for production. |
| Step 2 | Add required quantity of Wetting agent, dispersing agent, |
| | antifoam & suspending agents and homogenize the contents |
| | for 45-60 minutes using high shear homogenizer. |
| Step 3 | Add required quantity technical and homogenized to get |
| | uniform slurry ready for grinding. |
| Step 4 | Now material is subjected to grinding in Bead mill till desired |
| | particle size is achieved. |
| Step 5 | After grinding process completes the material is sprayed at |
| | required temperature. |
| Step 6 | After completion of spray drying process material is collected |
| | and sent for QC department approval. |
| Step 7 | After approval material is packed in required pack sizes. |

### Storage Stability:

Storage stability of Water Dispersible Granules
(WG) of Chlorantraniliprole 7.5% + Gibberellic
acid 0.005% + Pymetrozine 37.5%
Laboratory storage stability for 14 days

| | | | | Cold |
|---|---|---|---|---|
| | | | Heat | storage |
| | Specification | | stability at | stability at |
| Parameters | (in house) | Initial | 54 ± 2° C. | 0 ± 2° C. |
| Chlorantraniliprole | 7.125 to 8.25 | 7.55 | 7.53 | 7.55 |
| content percent by | | | | |
| mass | | | | |
| Gibberellic acid | 0.00475 to | 0.0052 | 0.0052 | 0.0052 |
| content percent by | 0.0055 | | | |
| mass | | | | |
| Pymetrozine content | 35.625 to | 37.80 | 37.60 | 37.80 |
| percent by mass | 39.375 | | | |
| Chlorantraniliprole | 70 | 96.02 | 95.62 | 95.51 |
| suspensibility | | | | |
| percent min. | | | | |
| Gibberellic acid | 70 | 97.15 | 96.90 | 96.35 |
| suspensibility | | | | |
| percent min. | | | | |
| Pymetrozine | 70 | 97.05 | 96.95 | 96.14 |
| suspensibility | | | | |
| percent min. | | | | |
| pH range (1% aq. | 6.0 to 9.0 | 7.50 | 7.60 | 7.50 |
| Suspension) | | | | |
| Wettability sec. max. | 60 | 9 | 10 | 10 |
| Wet sieve (45 micron) | 98.5 | 99.5 | 99.2 | 99.3 |
| percent by mass min. | | | | |
| Bulk density (g/ml) | 0.45 to 0.65 | 0.48 | 0.48 | 0.48 |
| Moisture content | max. 2% | 2 | 2 | 2 |
| percent by mass max. | | | | |

Room temperature storage stability up to 12 months

| | specification | 1 | 6 | 12 |
|---|---|---|---|---|
| Parameters | (in house) | month | month | month |
| Chlorantraniliprole | 7.125 to | 7.55 | 7.55 | 7.54 |
| content percent by | 8.25 | | | |
| mass | | | | |
| Gibberellic acid | 0.00475 to | 0.0052 | 0.0052 | 0.0051 |
| content percent by | 0.0055 | | | |
| mass | | | | |
| Pymetrozine content | 35.625 to | 37.80 | 37.80 | 37.79 |
| percent by mass | 39.375 | | | |
| Chlorantraniliprole | 70 | 96.02 | 96.35 | 96.25 |
| suspensibility | | | | |
| percent min. | | | | |
| Gibberellic acid | 70 | 97.15 | 97.45 | 97.15 |
| suspensibility | | | | |
| percent min. | | | | |
| Pymetrozine | 70 | 97.05 | 96.95 | 96.14 |
| suspensibility | | | | |
| percent min. | | | | |
| pH range (1% aq. | 6.0 to 9.0 | 7.50 | 7.50 | 7.50 |
| Suspension) | | | | |
| Wettability sec. max. | 60 | 9 | 10 | 9 |
| Wet sieve (45 micron) | 98.5 | 99.5 | 99.5 | 99.5 |
| percent by mass min. | | | | |
| Bulk density (g/ml) | 0.45 to 0.65 | 0.48 | 0.48 | 0.48 |
| Moisture content | max. 2% | 2 | 2 | 2 |
| percent by mass max. | | | | |

### Example 3

Granule (GR) Formulation of Tetraniliprole 0.3%+Triacontanol 0.125%+Thiamethoxam 1.0%

| Chemical composition | % (w/w) |
|---|---|
| Tetraniliprole a.i. | 0.30 |
| Triacontanol a.i. | 0.125 |
| Thiamethoxam a.i. | 1.00 |
| Wetting agent | 3.00 |
| Dispersing agent I | 1.00 |
| Dispersing agent II | 2.00 |
| Colourant | 0.50 |
| Solvent | 4.00 |
| Carrier | 87.90 |
| Total | 99.83 |

### Procedure: As Per Example 1

### Storage Stability:

Storage stability of Granule (GR) formulation of Tetraniliprole
0.3% + Triacontanol 0.125% + Thiamethoxam 1.0%
Laboratoy storage stability for 14 days

| | | | | Cold |
|---|---|---|---|---|
| | | | Heat | storage |
| | Specification | | stability at | stability at |
| Parameters | (in house) | Initial | 54 ± 2° C. | 0 ± 2° C. |
| Tetraniliprole content | 0.285 to 0.33 | 0.32 | 0.31 | 0.32 |
| percent by mass | | | | |
| Triacontanol content | 0.1188 to | 0.126 | 0.125 | 0.126 |
| percent by mass | 0.1375 | | | |
| Thiamethoxam content | 0.95 to 1.10 | 1.05 | 1.03 | 1.05 |
| percent by mass | | | | |
| pH range (1% aq. | 4.0 to 7.0 | 5.50 | 5.50 | 5.50 |
| Suspension) | | | | |
| Dustiness | <20 mg | 10 | 10 | 10 |
| Dry sieve (300 micron) | >90% | 99.5 | 99.2 | 99.3 |
| percent by mass min. | | | | |
| Attrition Resistance | <5% | 2.1 | 2.1 | 2.1 |
| (<100 micron) | | | | |
| Bulk density (g/ml) | 1.25 to 1.50 | 1.3 | 1.3 | 1.3 |
| Moisture content | max. 2% | 1 | 1 | 1 |
| percent by mass max. | | | | |

Room temperature storage stability up to 12 months

| | specification | | | |
|---|---|---|---|---|
| Parameters | (in house) | 1 month | 6 month | 12 month |
| Tetraniliprole content | 0.285 to 0.33 | 0.32 | 0.31 | 0.31 |
| percent by mass | | | | |
| Triacontanol content | 0.1188 to | 0.126 | 0.126 | 0.125 |
| percent by mass | 0.1375 | | | |
| Thiamethoxam content | 0.95 to 1.10 | 1.05 | 1.05 | 1.04 |
| percent by mass | | | | |
| pH range (1% aq. | 4.0 to 7.0 | 5.50 | 5.50 | 5.50 |
| Suspension) | | | | |
| Dustiness | <20 mg | 10 | 10 | 10 |
| Dry sieve (300 micron) | >90% | 99.5 | 96.35 | 96.25 |
| percent by mass min. | | | | |
| Attrition Resistance | <5% | 2.1 | 2.1 | 2.1 |
| (<100 micron) | | | | |
| Bulk density (g/ml) | 1.25 to 1.50 | 1.3 | 1.3 | 1.3 |
| Moisture content | max. 2% | 1 | 1 | 1 |
| percent by mass max. | | | | |

### Example 4

Granule (GR) Formulation of Chlorantraniliprole 0.3%+Triacontanol 0.125%+Clothianidin 1.0%

| Chemical composition | % (w/w) |
|---|---|
| Chlorantraniliprole a.i. | 0.30 |
| Triacontanol a.i. | 0.125 |
| Clothianidin a.i. | 1.00 |
| Wetting agent | 3.00 |
| Dispersing agent I | 1.00 |
| Dispersing agent II | 2.00 |
| Colourant | 0.50 |
| Solvent | 4.00 |
| Carrier | 88.07 |
| Total | 100.00 |

### Procedure: As Per Example 1

### Storage Stability:

Storage stability of Granule (GR) formulation of Chlorantraniliprole
0.3% + Triacontanol 0.125% + Clothianidin 1.0%
Laboratory storage stability for 14 days

| | | | | Cold |
|---|---|---|---|---|
| | | | Heat | storage |
| | Specification | | stability at | stability at |
| Parameters | (in house) | Initial | 54 ± 2° C. | 0 ± 2° C. |
| Chlorantraniliprole | 0.285 to 0.33 | 0.32 | 0.31 | 0.32 |
| content percent by | | | | |
| mass | | | | |
| Triacontanol content | 0.1188 to | 0.126 | 0.125 | 0.126 |
| percent by mass | 0.1375 | | | |
| Clothianidin content | 0.95 to 1.1 | 1.05 | 1.03 | 1.05 |
| percent by mass | | | | |
| pH range (1% aq. | 4.0 to 7.0 | 5.50 | 5.50 | 5.50 |
| Suspension) | | | | |
| Dustiness | <20 mg | 10 | 10 | 10 |
| Dry sieve (300 micron) | >90% | 99.5 | 99.2 | 99.3 |
| percent by mass min. | | | | |
| Attrition Resistance | <5% | 2.1 | 2.1 | 2.1 |
| (<100 micron) | | | | |
| Bulk density (g/ml) | 1.25 to 1.50 | 1.3 | 1.3 | 1.3 |
| Moisture content | max. 2% | 1 | 1 | 1 |
| percent by mass max. | | | | |

Room temperature storage stability up to 12 months

| | specification | | | |
|---|---|---|---|---|
| Parameters | (in house) | 1 month | 6 month | 12 month |
| Chlorantraniliprole | 0.285 to | 0.32 | 0.32 | 0.31 |
| content percent by | 0.330 | | | |
| mass | | | | |
| Triacontanol content | 0.1188 to | 0.126 | 0.126 | 0.125 |
| percent by mass | 0.1375 | | | |
| Clothianidin content | 0.95 to 1.10 | 1.05 | 1.04 | 1.03 |
| percent by mass | | | | |
| pH range (1% aq. | 4.0 to 7.0 | 5.50 | 5.50 | 5.50 |
| Suspension) | | | | |
| Dustiness | <20 mg | 10 | 10 | 10 |
| Dry sieve (300 micron) | >90% | 99.5 | 96.35 | 96.25 |
| percent by mass min. | | | | |
| Attrition Resistance | <5% | 2.1 | 2.1 | 2.1 |
| (<100 micron) | | | | |
| Bulk density (g/ml) | 1.25 to 1.50 | 1.3 | 1.3 | 1.3 |
| Moisture content | max. 2% | 1 | 1 | 1 |
| percent by mass max. | | | | |

### Example 5

Suspension Concentrate (SC) Formulation of Cyantraniliprole 5%+Gibberellic Acid 0.002%+Diafenthiuron 25%

| Chemical composition | % (w/w) |
|---|---|
| Cyantraniliprole a.i. | 5.00 |
| Gibberellic acid a.i. | 0.002 |
| Diafenthiuron a.i. | 25.00 |
| Wetting agent | 3.50 |
| Dispersing agent 1 | 4.50 |
| Dispersing agent 2 | 1.00 |
| Suspending agent | 2.00 |
| Antifoaming agent | 0.30 |
| Preservative | 0.20 |
| Antifreezing agent | 5.00 |
| Thickner | 0.15 |
| Diluent Water | 53.35 |
| Total | 100.00 |

### Procedure: Manufacturing Process of Suspension Concentrate (SC)

| | |
|---|---|
| Step 1 | Gum Solution should be made 12-18 hour prior to use. Take |
| | required quantity of water, biocide, and defoamer and |
| | homogenize, then slowly add gum powder to it and stir till |
| | complete dissolution. |
| Step 2 | Charge required quantity of DM water need to be taken in |
| | designated vessel for Suspension concentrate production. |
| Step 3 | Add required quantity of Wetting agent, antifreeze, dispersing |
| | agent & suspending agents and homogenize the contents for |
| | 45-60 minutes using high shear homogenizer. |
| Step 4 | Then add technical and other remaining adjuvants excluding |
| | ‘thickener’ are added to it and homogenized to get uniform |
| | slurry ready for grinding. |
| Step 5 | Before grinding half the quantity of antifoam was added and |
| | then material was subjected to grinding in Dyno mill till desired |
| | particle size is achieved. |
| Step 6 | Half quantity of the antifoam was added after grinding process |
| | completes and before sampling for in process analysis. |
| Step 7 | Finally add gum solution to this formulation and send to QC for |
| | quality check. |

### Storage Stability:

Storage stability of suspension concentrate (SC) of Cyantraniliprole
5% + Gibberellic acid 0.002% + Diafenthiuron 25%
Laboratory storage stability

| | | | | Heat | Cold |
|---|---|---|---|---|---|
| | | | | stability | storage |
| | Specification | | | study at | stability at |
| Parameters | (in house) | | Initial | 54 ± 2 ° C. | 0 ± 2° C. |
| Cyantraniliprole | 4.75 to 5.50 | | 5.10 | 5.08 | 5.10 |
| content percent | | | | | |
| by mass | | | | | |
| Gibberellic acid | 0.0018 to | | 0.0022 | 0.0021 | 0.0022 |
| content percent | 0.0022 | | | | |
| by mass | | | | | |
| Diafenthiuron | 23.75 to 26.25 | | 25.20 | 25.16 | 25.20 |
| content percent | | | | | |
| by mass | | | | | |
| Cyantraniliprole | 80 | | 96.14 | 95.15 | 96.03 |
| suspensibility | | | | | |
| percent min. | | | | | |
| Gibberellic acid | 80 | | 97.16 | 97.10 | 96.80 |
| suspensibility | | | | | |
| percent min. | | | | | |
| Diafenthiuron | 80 | | 97.15 | 97.12 | 96.80 |
| suspesnibility | | | | | |
| precent min. | | | | | |
| pH range (1% aq. | 4.5 to 6.5 | | 5.20 | 5.10 | 5.20 |
| Suspension) | | | | | |
| Pourability | 95% | min. | 97.40 | 97.20 | 97.50 |
| Specific gravity | 1.02-1.08 | | 1.03 | 1.03 | 1.03 |
| Viscosity at | 350-800 | cps | 650 | 660 | 675 |

| | | | | |
|---|---|---|---|---|
| spindle no. 62, | | | | |
| 20 rpm | | | | |
| Particle size | D50 < 3, | 2.2, 8.6 | 2.4, 8.8 | 2.5, 8.9 |
| (micron) | D90 < 10 | | | |
| Persistent foam | 60 | nil | 3 | nil |
| ml (after 1 | | | | |
| minute) max. | | | | |

Room temperature storage stability up to 12 months

| | Specification | | | | |
|---|---|---|---|---|---|
| Parameters | (in house) | | 1 month | 6 month | 12 month |
| Cyantraniliprole | 4.75 to 5.50 | | 5.10 | 5.09 | 5.08 |
| content percent | | | | | |
| by mass | | | | | |
| Gibberellic acid | 0.0018 to | | 0.0022 | 0.0022 | 0.0021 |
| content percent | 0.0022 | | | | |
| by mass | | | | | |
| Diafenthiuron | 23.75 to 26.25 | | 25.20 | 25.20 | 25.19 |
| content percent | | | | | |
| by mass | | | | | |
| Cyantraniliprole | 80 | | 96.14 | 95.15 | 96.03 |
| suspensibility | | | | | |
| percent min. | | | | | |
| Gibberellic acid | 80 | | 97.16 | 97.10 | 96.80 |
| suspensibility | | | | | |
| percent min. | | | | | |
| Diafenthiuron | 80 | | 97.15 | 97.12 | 96.80 |
| suspesnibility | | | | | |
| precent min. | | | | | |
| pH range (1% aq. | 4.5 to 6.5 | | 5.20 | 5.10 | 5.20 |
| Suspension) | | | | | |
| Pourability | 95% | min. | 97.40 | 97.20 | 97.50 |
| Specific gravity | 1.02-1.08 | | 1.03 | 1.03 | 1.03 |
| Viscosity at | 350-800 | cps | 650 | 660 | 675 |

| | | | | |
|---|---|---|---|---|
| spindle no. 62, | | | | |
| 20 rpm | | | | |
| Particle size | D50 < 3, | 2.2, 8.6 | 2.4, 8.8 | 2.5, 8.9 |
| (micron) | D90 < 10 | | | |
| Persistent foam | 60 | nil | 3 | nil |
| ml (after 1 | | | | |
| minute) max. | | | | |

### Example 6

Suspension Concentrate (SC) Formulation of Cyantraniliprole 10%+Gibberellic Acid 0.008%+Emamectin Benzoate 3%

| Chemical composition | % (w/w) |
|---|---|
| Cyantraniliprole a.i. | 10.00 |
| Gibberellic acid a.i. | 0.008 |
| Emamectin Benzoate | 3.00 |
| Wetting agent | 3.50 |
| Dispersing agent 1 | 4.50 |
| Dispersing agent 2 | 1.50 |
| Suspending agent | 1.50 |
| Antifoaming agent | 0.20 |
| Preservative | 0.20 |
| Antifreezing agent | 5.00 |
| Thickner | 0.15 |
| Diluent Water | q.s. |
| Total | 100.00 |

### Procedure: As Per Example 5

### Storage Stability:

Storage stability of suspension concentrate (SC) of Cyantraniliprole
10% + Gibberellic acid 0.008% + Emamectin Benzoate 3%
Laboratory storage stability for 14 days

| | | | | Heat | Cold |
|---|---|---|---|---|---|
| | | | | stability | storage |
| | Specification | | | study at | stability at |
| Parameters | (in house) | | Initial | 54 ± 2° C. | 0 ± 2° C. |
| Cyantraniliprole | 9.50 to 10.50 | | 10.15 | 10.13 | 10.15 |
| content percent by | | | | | |
| mass | | | | | |
| Gibberellic acid | 0.0076 to | | 0.008 | 0.0078 | 0.008 |
| content percent by | 0.0088 | | | | |
| mass | | | | | |
| Emamectin | 2.85 to 3.30 | | 3.10 | 3.09 | 3.10 |
| Benzoate content | | | | | |
| percent by mass | | | | | |
| Cyantraniliprole | 80 | | 96.14 | 95.15 | 96.03 |
| suspensibility | | | | | |
| percent min. | | | | | |
| Gibberellic acid | 80 | | 97.16 | 97.10 | 96.80 |
| suspensibility | | | | | |
| percent min. | | | | | |
| Emamectin | 80 | | 97.15 | 97.12 | 96.80 |
| Benzoate | | | | | |
| suspesnibility | | | | | |
| precent min. | | | | | |
| pH range (1% aq. | 5.0 to 7.5 | | 6.2 | 6.3 | 6.2 |
| Suspension) | | | | | |
| Pourability | 95% | min. | 97.4 | 97.2 | 97.5 |
| Specific gravity | 1.03-1.08 | | 1.05 | 1.05 | 1.05 |
| Viscosity at spindle | 350-800 1 | cps | 510 | 518 | 520 |

| | | | | |
|---|---|---|---|---|
| no. 62, 20 rpm | | | | |
| Particle size | D50 < 3, | 2.2, 8.6 | 2.4, 8.8 | 2.5, 8.9 |
| (micron) | D90 < 10 | | | |
| Persistent foam | 60 | Nil | 3 | Nil |
| ml (after 1 | | | | |
| minute) max. | | | | |

Room temperature storage stability up to 12 months

| | Specification | | | | |
|---|---|---|---|---|---|
| Parameters | (in house) | | 1 month | 6 month | 12 month |
| Cyantraniliprole | 9.50 to 10.50 | | 10.15 | 10.15 | 10.14 |
| content percent by | | | | | |
| mass | | | | | |
| Gibberellic acid | 0.0076 to | | 0.008 | 0.008 | 0.0078 |
| content percent by | 0.0088 | | | | |
| mass | | | | | |
| Emamectin | 2.85 to 3.30 | | 3.10 | 3.10 | 3.08 |
| Benzoate content | | | | | |
| percent by mass | | | | | |
| Cyantraniliprole | 80 | | 96.14 | 95.13 | 95.32 |
| suspensibility | | | | | |
| percent min. | | | | | |
| Gibberellic acid | 80 | | 97.16 | 96.10 | 96.20 |
| suspensibility | | | | | |
| percent min. | | | | | |
| Emamectin | 80 | | 97.15 | 96.14 | 96.20 |
| Benzoate | | | | | |
| suspesnibility | | | | | |
| precent min. | | | | | |
| pH range (1% aq. | 5.0 to 7.5 | | 6.2 | 6.21 | 6.22 |
| Suspension) | | | | | |
| Pourability | 95% | min. | 97.4 | 97.4 | 97.3 |
| Specific gravity | 1.03-1.08 | | 1.05 15 | 1.05 15 | 1.05 |
| Viscosity at spindle | 350-800 | cps | 510 | 520 | 523 |

| | | | | |
|---|---|---|---|---|
| no. 62, 20 rpm | | | | |
| Particle size | D50 < 3, | 2.2, 8.6 | 2.2, 8.6 | 2.2, 8.7 |
| (micron) | D90 < 10 | | | |
| Persistent foam | 60 | nil | nil | 2 |
| ml (after 1 | | | | |
| minute) max. | | | | |

### Example 7

Suspension Concentrate (SC) Formulation of Broflanilide 5%+Gibberellic Acid 0.004%+Methoxyfenozide 20%

| Chemical composition | % (w/w) |
|---|---|
| Broflanilide a.i. | 5.00 |
| Gibberellic acid a.i. | 0.004 |
| Methoxyfenozide | 20.00 |
| Wetting agent | 3.50 |
| Dispersing agent I | 4.00 |
| Dispersing agent II | 1.50 |
| Suspending agent | 0.50 |
| Antifoaming agent | 0.20 |
| Preservative | 0.20 |
| Antifreezing agent | 5.00 |
| Thickner | 0.15 |
| Diluent Water | q.s. |
| Total | 100.00 |

### Procedure: As Per Example 5

### Storage Stability:

Storage stability of suspension concentrate (SC) of Broflanilide
5% + Gibberellic acid 0.004% + Methoxyfenozide 20%
Laboratory storage stability for 14 days

| | | | Heat | Cold |
|---|---|---|---|---|
| | | | stability | storage |
| | Specification | | study at | stability at |
| Parameters | (in house) | Initial | 54 ± 2° C. | 0 ± 2° C. |
| Broflanilide | 4.75 to 5.50 | 5.10 | 5.09 | 5.10 |
| content percent | | | | |
| by mass | | | | |
| Gibberellic acid | 0.0038 to 0.0044 | 0.004 | 0.004 | 0.004 |
| content percent | | | | |
| by mass | | | | |
| Methoxyfenozide | 19.00 to 21.00 | 20.20 | 20.18 | 20.20 |
| content percent | | | | |
| by mass | | | | |
| Broflanilide | 80 | 96.14 | 95.15 | 96.03 |
| suspensibility | | | | |
| percent min. | | | | |
| Gibberellic acid | 80 | 97.16 | 97.10 | 96.80 |
| suspensibility | | | | |
| percent min. | | | | |
| Methoxyfenozide | 80 | 97.15 | 97.12 | 96.80 |
| suspesnibility | | | | |
| precent min. | | | | |
| pH range (1% aq. | 4.0 to 6.5 | 5.5 | 5.6 | 5.5 |
| Suspension) | | | | |
| Pourability | 95% min. | 97.4 | 97.2 | 97.5 |
| Specific gravity | 1.05-1.10 | 1.08 | 1.08 | 1.08 |
| Viscosity at spindle | 350-800 cps | 510 | 518 | 520 |
| no. 62, 20 rpm | | | | |
| Particle size | D50 < 3, | 2.2, 8.6 | 2.4, 8.8 | 2.5, 8.9 |
| (micron) | D90 < 10 | | | |
| Persistent foam ml | 60 | Nil | 3 | nil |
| (after 1 minute) | | | | |
| max. | | | | |

Room temperature storage stability up to 12 months

| | Specification | | | |
|---|---|---|---|---|
| Parameters | (in house) | 1 month | 6 month | 12 month |
| Broflanilide | 4.75 to 5.50 | 5.10 | 5.10 | 5.08 |
| content percent | | | | |
| by mass | | | | |
| Gibberellic acid | 0.0038 to 0.0044 | 0.004 | 0.004 | 0.004 |
| content percent | | | | |
| by mass | | | | |
| Methoxyfenozide | 19.00 to 21.00 | 20.20 | 20.20 | 20.19 |
| content percent | | | | |
| by mass | | | | |
| Broflanilide | 80 | 96.14 | 95.13 | 95.32 |
| suspensibility | | | | |
| percent min. | | | | |
| Gibberellic acid | 80 | 97.16 | 96.10 | 96.20 |
| suspensibility | | | | |
| percent min. | | | | |
| Methoxyfenozide | 80 | 97.15 | 96.14 | 96.20 |
| suspesnibility | | | | |
| precent min. | | | | |
| pH range (1% aq. | 4.0 to 6.5 | 5.5 | 5.5 | 5.5 |
| Suspension) | | | | |
| Pourability | 95% min. | 97.4 | 97.4 | 97.3 |
| Specific gravity | 1.05-1.10 | 1.08 | 1.08 | 1.08 |
| Viscosity at spindle | 350-800 cps | 510 | 520 | 523 |
| no. 62, 20 rpm | | | | |
| Particle size | D50 < 3, | 2.2, 8.6 | 2.2, 8.6 | 2.2, 8.7 |
| (micron) | D90 < 10 | | | |
| Persistent foam ml | 60 | Nil | nil | 2 |
| (after 1 minute) | | | | |
| max. | | | | |

### Example 8

Suspension Concentrate (SC) Formulation of Chlorantraniliprole 5%+Gibberellic Acid 0.004%+Methoxyfenozide 20%

| Chemical composition | % (w/w) |
|---|---|
| Chlorantraniliprole a.i. | 5.00 |
| Gibberellic acid a.i. | 0.004 |
| Methoxyfenozide | 20.00 |
| Wetting agent | 3.50 |
| Dispersing agent I | 4.00 |
| Dispersing agent II | 1.50 |
| Suspending agent | 0.50 |
| Antifoaming agent | 0.20 |
| Preservative | 0.20 |
| Antifreezing agent | 5.00 |
| Thickner | 0.15 |
| Diluent Water | q.s. |
| Total | 100.00 |

### Procedure: As Per Example 5

### Storage Stability:

Storage stability of suspension concentrate (SC) of Chlorantraniliprole
5% + Gibberellic 0.004% + Methoxyfenozide 20%
Laboratory storage stability for 14 days

| | | | Heat | Cold |
|---|---|---|---|---|
| | | | stability | storage |
| | Specification | | study at | stability at |
| Parameters | (in house) | Initial | 54 ± 2° C. | 0 ± 2° C. |
| Chlorantraniliprole | 4.75 to 5.50 | 5.10 | 5.09 | 5.1 |
| content percent | | | | |
| by mass | | | | |
| Gibberellic acid | 0.0038 to 0.0044 | 0.004 | 0.004 | 0.004 |
| content percent | | | | |
| by mass | | | | |
| Methoxyfenozide | 19.00 to 21.00 | 20.20 | 20.18 | 20.20 |
| content percent | | | | |
| by mass | | | | |
| Chlorantraniliprole | 80 | 96.14 | 95.15 | 96.03 |
| suspensibility | | | | |
| percent min. | | | | |
| Gibberellic acid | 80 | 97.16 | 97.10 | 96.80 |
| suspensibility | | | | |
| percent min. | | | | |
| Methoxyfenozide | 80 | 97.15 | 97.12 | 96.80 |
| suspesnibility | | | | |
| precent min. | | | | |
| pH range (1% aq. | 4.0 to 6.5 | 5.5 | 5.6 | 5.5 |
| Suspension) | | | | |
| Pourability | 95% min. | 97.4 | 97.2 | 97.5 |
| Specific gravity | 1.05-1.10 | 1.08 | 1.08 | 1.08 |
| Viscosity at spindle | 350-800 cps | 510 | 518 | 520 |
| no. 62, 20 rpm | | | | |
| Particle size | D50 < 3, | 2.2, 8.6 | 2.4, 8.8 | 2.5, 8.9 |
| (micron) | D90 < 10 | | | |
| Persistent foam ml | 60 | nil | 3 | Nil |
| (after 1 minute) | | | | |
| max. | | | | |

Room temperature storage stability up to 12 months

| | Specification | | | |
|---|---|---|---|---|
| Parameters | (in house) | 1 month | 6 month | 12 month |
| Chlorantraniliprole | 4.75 to 5.50 | 5.10 | 5.10 | 5.08 |
| content percent | | | | |
| by mass | | | | |
| Gibberellic acid | 0.0038 to 0.0044 | 0.004 | 0.004 | 0.004 |
| content percent | | | | |
| by mass | | | | |
| Methoxyfenozide | 19.00 to 21.00 | 20.20 | 20.20 | 20.19 |
| content percent | | | | |
| by mass | | | | |
| Chlorantraniliprole | 80 | 96.14 | 95.13 | 95.32 |
| suspensibility | | | | |
| percent min. | | | | |
| Gibberellic acid | 80 | 97.16 | 96.10 | 96.20 |
| suspensibility | | | | |
| percent min. | | | | |
| Methoxyfenozide | 80 | 97.15 | 96.14 | 96.20 |
| suspesnibility | | | | |
| precent min. | | | | |
| pH range (1% aq. | 4.0 to 6.5 | 5.5 | 5.5 | 5.5 |
| Suspension) | | | | |
| Pourability | 95% min. | 97.4 | 97.4 | 97.3 |
| Specific gravity | 1.05-1.10 | 1.08 | 1.08 | 1.08 |
| Viscosity at spindle | 350-800 cps | 510 | 520 | 523 |
| no. 62, 20 rpm | | | | |
| Particle size | D50 < 3, | 2.2, 8.6 | 2.2, 8.6 | 2.2, 8.7 |
| (micron) | D90 < 10 | | | |
| Persistent foam ml | 60 | Nil | nil | 2 |
| (after 1 minute) | | | | |
| max. | | | | |

### Example 9

Most Preferred compositions and formulations thereof for the present invention.

| | | | | | | Formu- | |
|---|---|---|---|---|---|---|---|
| | | | active ingredients(%) | | | lation | Formu- |
| | | | Com- | Com- | Com- | Strength | lation |
| Compound A | Compound B | Compound C | pound A | pound B | pound C | (%) | Type |
| Chlorantraniliprole | Triacontanol | Clothianidin | 0.3 | 0.125 | 1 | 1.43 | Granule |
| Chlorantraniliprole | Triacontanol | Thiamethoxam | 0.3 | 0.125 | 1 | 1.43 | Granule |
| Chlorantraniliprole | Triacontanol | Triflumezopyrim | 0.3 | 0.125 | 0.25 | 0.68 | Granule |
| Chlorantraniliprole | Triacontanol | Flupyrimin | 0.3 | 0.125 | 1 | 1.43 | Granule |
| Cyantraniliprole | Triacontanol | Clothianidin | 0.6 | 0.125 | 1 | 1.73 | Granule |
| Cyantraniliprole | Triacontanol | Thiamethoxam | 0.6 | 0.125 | 1 | 1.73 | Granule |
| Cyantraniliprole | Triacontanol | Triflumezopyrim | 0.6 | 0.125 | 0.25 | 0.98 | Granule |
| Cyantraniliprole | Triacontanol | Flupyrimin | 0.6 | 0.125 | 1 | 1.73 | Granule |
| Tetraniliprole | Triacontanol | Clothianidin | 0.3 | 0.125 | 1 | 1.43 | Granule |
| Tetraniliprole | Triacontanol | Thiamethoxam | 0.3 | 0.125 | 1 | 1.43 | Granule |
| Tetraniliprole | Triacontanol | Triflumezopyrim | 0.3 | 0.125 | 0.25 | 0.68 | Granule |
| Tetraniliprole | Triacontanol | Flupyrimin | 0.3 | 0.125 | 1 | 1.43 | Granule |
| Cyclaniliprole | Triacontanol | Fipronil | 0.6 | 0.125 | 0.6 | 1.33 | Granule |
| Cyclaniliprole | Triacontanol | Clothianidin | 0.6 | 0.125 | 0.75 | 1.48 | Granule |
| Cyclaniliprole | Triacontanol | Triflumezopyrim | 0.6 | 0.125 | 0.2 | 0.93 | Granule |
| Cyclaniliprole | Triacontanol | Flupyrimin | 0.6 | 0.125 | 1 | 1.73 | Granule |
| Cyclaniliprole | Triacontanol | Pymetrozine | 0.6 | 0.125 | 2 | 2.73 | Granule |
| Broflanilide | Triacontanol | Methoxyfenozide | 1.8 | 0.025 | 20 | 21.83 | SC |
| Broflanilide | Triacontanol | Emamectin benzoate | 3.6 | 0.05 | 3.6 | 7.25 | SC |
| Broflanilide | Triacontanol | Diafenthiuron | 1.8 | 0.025 | 40 | 41.83 | SC |
| Broflanilide | Triacontanol | Pyriproxyfen | 0.9 | 0.0125 | 6 | 6.91 | SC |
| Broflanilide | Triacontanol | Tolfenpyrad | 1.8 | 0.025 | 15 | 16.83 | SC |
| Broflanilide | Triacontanol | Flonicamid | 3.6 | 0.05 | 20 | 23.65 | WG |
| Broflanilide | Triacontanol | Spinetoram | 3.6 | 0.05 | 20 | 23.65 | SC |
| Isocycloseram | Triacontanol | Methoxyfenozide | 5 | 0.05 | 20 | 25.05 | SC |
| Isocycloseram | Triacontanol | Emamectin benzoate | 5 | 0.05 | 2 | 7.05 | SC |
| Isocycloseram | Triacontanol | Spinetoram | 5 | 0.05 | 10 | 15.05 | SC |
| Isocycloseram | Triacontanol | Novaluron | 5 | 0.05 | 10 | 15.05 | SC |
| Isocycloseram | Triacontanol | Dichloromezotiaz | 5 | 0.05 | 5 | 10.05 | SC |
| Chlorantraniliprole | Triacontanol | Fipronil | 0.25 | 0.125 | 0.5 | 0.88 | Granule |
| Cyantraniliprole | Triacontanol | Fipronil | 0.25 | 0.125 | 0.5 | 0.88 | Granule |
| Tetraniliprole | Triacontanol | Fipronil | 0.25 | 0.125 | 0.5 | 0.88 | Granule |
| Cyclaniliprole | Triacontanol | Thiamethoxam | 0.25 | 0.125 | 1 | 1.38 | Granule |
| Cyclaniliprole | Triacontanol | Flupyrimin | 0.25 | 0.125 | 0.25 | 0.63 | Granule |
| Broflanilide | Triacontanol | Thiamethoxam | 0.25 | 0.125 | 1 | 1.38 | Granule |
| Broflanilide | Triacontanol | Flupyrimin | 0.25 | 0.125 | 0.25 | 0.63 | Granule |
| Fluxametamide | Triacontanol | Thiamethoxam | 0.25 | 0.125 | 1 | 1.38 | Granule |
| Fluxametamide | Triacontanol | Flupyrimin | 0.25 | 0.125 | 0.25 | 0.63 | Granule |
| Chlorantraniliprole | Triacontanol | Methoxyfenozide | 5 | 0.2 | 20 | 25.2 | SC |
| Cyantraniliprole | Triacontanol | Methoxyfenozide | 5 | 0.2 | 20 | 25.2 | SC |
| Cyclaniliprole | Triacontanol | Methoxyfenozide | 5 | 0.2 | 20 | 25.2 | SC |
| Tetraniliprole | Triacontanol | Methoxyfenozide | 5 | 0.2 | 20 | 25.2 | SC |
| Flubendiamide | Triacontanol | Methoxyfenozide | 5 | 0.2 | 20 | 25.2 | SC |
| Broflanilide | Triacontanol | Methoxyfenozide | 5 | 0.2 | 20 | 25.2 | SC |
| Cyahalodiamide | Triacontanol | Methoxyfenozide | 5 | 0.2 | 20 | 25.2 | SC |
| Chlorantraniliprole | Triacontanol | Emamectin benzoate | 10 | 0.04 | 3 | 13.04 | SC |
| Cyantraniliprole | Triacontanol | Emamectin benzoate | 10 | 0.04 | 3 | 13.04 | SC |
| Cyclaniliprole | Triacontanol | Emamectin benzoate | 10 | 0.04 | 3 | 13.04 | SC |
| Tetraniliprole | Triacontanol | Emamectin benzoate | 10 | 0.04 | 3 | 13.04 | SC |
| Flubendiamide | Triacontanol | Emamectin benzoate | 10 | 0.04 | 3 | 13.04 | SC |
| Broflanilide | Triacontanol | Emamectin benzoate | 10 | 0.04 | 3 | 13.04 | SC |
| Cyahalodiamide | Triacontanol | Emamectin benzoate | 10 | 0.04 | 3 | 13.04 | SC |
| Chlorantraniliprole | Triacontanol | Spinetoram | 10 | 0.04 | 15 | 25.04 | SC |
| Cyantraniliprole | Triacontanol | Spinetoram | 10 | 0.04 | 15 | 25.04 | SC |
| Cyclaniliprole | Triacontanol | Spinetoram | 10 | 0.04 | 15 | 25.04 | SC |
| Tetraniliprole | Triacontanol | Spinetoram | 10 | 0.04 | 15 | 25.04 | SC |
| Flubendiamide | Triacontanol | Spinetoram | 10 | 0.04 | 15 | 25.04 | SC |
| Cyahalodiamide | Triacontanol | Spinetoram | 10 | 0.04 | 15 | 25.04 | SC |
| Cyantraniliprole | Gibberellic acid | Diafenthiuron | 5 | 0.002 | 25 | 30.00 | SC |
| Cyantraniliprole | Gibberellic acid | Pyriproxyfen | 5 | 0.002 | 5 | 10.0020 | SE |
| Cyantraniliprole | Gibberellic acid | Flonicamid | 10 | 0.004 | 10 | 20.00 | OD |
| Cyantraniliprole | Gibberellic acid | Tolfenpyrad | 5 | 0.002 | 10 | 15.00 | SC |
| Cyantraniliprole | Gibberellic acid | Flupyradifuron | 5 | 0.002 | 15 | 20.00 | SC |
| Cyantraniliprole | Gibberellic acid | Spiromesifen | 6.67 | 0.0025 | 12 | 18.67 | OD |
| Cyantraniliprole | Gibberellic acid | Spiropidion | 10 | 0.004 | 10 | 20.00 | SC |
| Cyantraniliprole | Gibberellic acid | Pyrifluqinazon | 10 | 0.004 | 5 | 15.00 | SC |
| Cyantraniliprole | Gibberellic acid | Dimpropyridaz | 10 | 0.004 | 5 | 15.00 | OD |
| Cyantraniliprole | Gibberellic acid | Pymetrozine | 10 | 0.004 | 10 | 20.00 | WG |
| Chlorantraniliprole | Gibberellic acid | Pymetrozine | 7.5 | 0.005 | 37.5 | 45.01 | WG |
| Cyclaniliprole | Gibberellic acid | Pymetrozine | 7.5 | 0.005 | 37.5 | 45.01 | WG |
| Tetraniliprole | Gibberellic acid | Pymetrozine | 7.5 | 0.005 | 37.5 | 45.01 | WG |
| Tetrachlorantraniliprole | Gibberellic acid | Pymetrozine | 7.5 | 0.005 | 37.5 | 45.01 | WG |
| Flubendiamide | Gibberellic acid | Pymetrozine | 7.5 | 0.005 | 37.5 | 45.01 | WG |
| Cyproflanilide | Gibberellic acid | Pymetrozine | 7.5 | 0.005 | 37.5 | 45.01 | WG |
| Broflanilide | Gibberellic acid | Pymetrozine | 7.5 | 0.005 | 37.5 | 45.01 | WG |
| Cyahalodiamide | Gibberellic acid | Pymetrozine | 7.5 | 0.005 | 37.5 | 45.01 | WG |
| Fluxametamide | Gibberellic acid | Pymetrozine | 7.5 | 0.005 | 37.5 | 45.01 | WG |
| Isocycloseram | Gibberellic acid | Pymetrozine | 7.5 | 0.005 | 37.5 | 45.01 | WG |
| Chlorantraniliprole | Gibberellic acid | Lambda cyhalothrin | 4 | 0.0025 | 6.67 | 10.67 | ZC |
| Cyantraniliprole | Gibberellic acid | Lambda cyhalothrin | 4 | 0.0025 | 6.67 | 10.67 | ZC |
| Cyclaniliprole | Gibberellic acid | Lambda cyhalothrin | 4 | 0.0025 | 6.67 | 10.67 | ZC |
| Tetraniliprole | Gibberellic acid | Lambda cyhalothrin | 4 | 0.0025 | 6.67 | 10.67 | ZC |
| Tetrachlorantraniliprole | Gibberellic acid | Lambda cyhalothrin | 4 | 0.0025 | 6.67 | 10.67 | ZC |
| Flubendiamide | Gibberellic acid | Lambda cyhalothrin | 4 | 0.0025 | 6.67 | 10.67 | ZC |
| Cyproflanilide | Gibberellic acid | Lambda cyhalothrin | 4 | 0.0025 | 6.67 | 10.67 | ZC |
| Broflanilide | Gibberellic acid | Lambda cyhalothrin | 4 | 0.0025 | 6.67 | 10.67 | ZC |
| Cyahalodiamide | Gibberellic acid | Lambda cyhalothrin | 4 | 0.0025 | 6.67 | 10.67 | ZC |
| Fluxametamide | Gibberellic acid | Lambda cyhalothrin | 4 | 0.0025 | 6.67 | 10.67 | ZC |
| Isocycloseram | Gibberellic acid | Lambda cyhalothrin | 4 | 0.0025 | 6.67 | 10.67 | ZC |
| Chlorantraniliprole | Gibberellic acid | Methoxyfenozide | 5 | 0.004 | 20 | 25.004 | SC |
| Cyantraniliprole | Gibberellic acid | Methoxyfenozide | 5 | 0.004 | 20 | 25.004 | SC |
| Cyclaniliprole | Gibberellic acid | Methoxyfenozide | 5 | 0.004 | 20 | 25.004 | SC |
| Tetraniliprole | Gibberellic acid | Methoxyfenozide | 5 | 0.004 | 20 | 25.004 | SC |
| Tetrachlorantraniliprole | Gibberellic acid | Methoxyfenozide | 5 | 0.004 | 20 | 25.004 | SC |
| Flubendiamide | Gibberellic acid | Methoxyfenozide | 5 | 0.004 | 20 | 25.004 | SC |
| Cyproflanilide | Gibberellic acid | Methoxyfenozide | 5 | 0.004 | 20 | 25.004 | SC |
| Broflanilide | Gibberellic acid | Methoxyfenozide | 5 | 0.004 | 20 | 25.004 | SC |
| Cyahalodiamide | Gibberellic acid | Methoxyfenozide | 5 | 0.004 | 20 | 25.004 | SC |
| Fluxametamide | Gibberellic acid | Methoxyfenozide | 5 | 0.004 | 20 | 25.004 | SC |
| Isocycloseram | Gibberellic acid | Methoxyfenozide | 5 | 0.004 | 20 | 25.004 | SC |
| Chlorantraniliprole | Gibberellic acid | Emamectin benzoate | 10 | 0.008 | 3 | 13.008 | SC |
| Cyantraniliprole | Gibberellic acid | Emamectin benzoate | 10 | 0.008 | 3 | 13.008 | SC |
| Cyclaniliprole | Gibberellic acid | Emamectin benzoate | 10 | 0.008 | 3 | 13.008 | SC |
| Tetraniliprole | Gibberellic acid | Emamectin benzoate | 10 | 0.008 | 3 | 13.008 | SC |
| Tetrachlorantraniliprole | Gibberellic acid | Emamectin benzoate | 10 | 0.008 | 3 | 13.008 | SC |
| Flubendiamide | Gibberellic acid | Emamectin benzoate | 10 | 0.008 | 3 | 13.008 | SC |
| Cyproflanilide | Gibberellic acid | Emamectin benzoate | 10 | 0.008 | 3 | 13.008 | SC |
| Broflanilide | Gibberellic acid | Emamectin benzoate | 10 | 0.008 | 3 | 13.008 | SC |
| Cyahalodiamide | Gibberellic acid | Emamectin benzoate | 10 | 0.008 | 3 | 13.008 | SC |
| Fluxametamide | Gibberellic acid | Emamectin benzoate | 10 | 0.008 | 3 | 13.008 | SC |
| Isocycloseram | Gibberellic acid | Emamectin benzoate | 10 | 0.008 | 3 | 13.008 | SC |
| Cyclaniliprole | Gibberellic acid | Novaluron | 5 | 0.004 | 10 | 15.004 | SC |
| Cyclaniliprole | Gibberellic acid | Dichloromezotiaz | 5 | 0.004 | 5 | 10.004 | SC |
| Cyclaniliprole | Gibberellic acid | Indoxacarb | 5 | 0.004 | 10 | 15.004 | OD |
| Cyclaniliprole | Gibberellic acid | Oxazosulfyl | 5 | 0.004 | 7.5 | 12.504 | SC |
| Broflanilide | Gibberellic acid | Novaluron | 4 | 0.008 | 20 | 24.008 | SC |
| Broflanilide | Gibberellic acid | Dichloromezotiaz | 4 | 0.008 | 8 | 12.008 | SC |
| Broflanilide | Gibberellic acid | Indoxacarb | 2 | 0.004 | 10 | 12.004 | OD |
| Broflanilide | Gibberellic acid | Oxazosulfyl | 4 | 0.008 | 20 | 24.008 | SC |
| Chlorantraniliprole | Gibberellic acid | Novaluron | 5 | 0.004 | 10 | 15.004 | SC |
| Chlorantraniliprole | Gibberellic acid | Dichloromezotiaz | 5 | 0.004 | 5 | 10.004 | SC |
| Chlorantraniliprole | Gibberellic acid | Indoxacarb | 5 | 0.004 | 10 | 15.004 | OD |
| Chlorantraniliprole | Gibberellic acid | Oxazosulfyl | 5 | 0.004 | 7.5 | 12.504 | SC |
| Chlorantraniliprole | Gibberellic acid | Spinetoram | 10 | 0.006 | 15 | 25.006 | SC |
| Cyantraniliprole | Gibberellic acid | Spinetoram | 10 | 0.006 | 15 | 25.006 | SC |
| Cyclaniliprole | Gibberellic acid | Spinetoram | 10 | 0.006 | 15 | 25.006 | SC |
| Tetraniliprole | Gibberellic acid | Spinetoram | 10 | 0.006 | 15 | 25.006 | SC |
| Flubendiamide | Gibberellic acid | Spinetoram | 10 | 0.006 | 15 | 25.006 | SC |
| Broflanilide | Gibberellic acid | Spinetoram | 10 | 0.006 | 15 | 25.006 | SC |
| Cyahalodiamide | Gibberellic acid | Spinetoram | 10 | 0.006 | 15 | 25.006 | SC |
| Chlorantraniliprole | Paclobutrazol | Clothianidin | 0.3 | 0.3 | 1 | 1.6 | Granule |
| Chlorantraniliprole | Paclobutrazol | Thiamethoxam | 0.3 | 0.3 | 1 | 1.6 | Granule |
| Chlorantraniliprole | Paclobutrazol | Imidacloprid | 0.3 | 0.3 | 1 | 1.6 | Granule |
| Chlorantraniliprole | Paclobutrazol | Dinotefuran | 3 | 3 | 10 | 16 | SC |
| Chlorantraniliprole | Paclobutrazol | Fipronil | 0.3 | 0.3 | 1 | 1.6 | Granule |
| Chlorantraniliprole | Paclobutrazol | Triflumezopyrim | 6 | 6 | 5 | 17 | SC |
| Chlorantraniliprole | Paclobutrazol | Flupyrimin | 6 | 6 | 5 | 17 | SC |
| Cyantraniliprole | Paclobutrazol | Clothianidin | 0.6 | 0.3 | 1 | 1.9 | Granule |
| Cyantraniliprole | Paclobutrazol | Thiamethoxam | 0.6 | 0.3 | 1 | 1.9 | Granule |
| Cyantraniliprole | Paclobutrazol | Triflumezopyrim | 10 | 6 | 4 | 20 | SC |
| Cyantraniliprole | Paclobutrazol | Flupyrimin | 10 | 6 | 10 | 26 | SC |
| Cyantraniliprole | Paclobutrazol | Fipronil | 0.6 | 0.3 | 0.5 | 1.4 | Granule |
| Tetraniliprole | Paclobutrazol | Clothianidin | 0.6 | 0.3 | 1 | 1.9 | Granule |
| Tetraniliprole | Paclobutrazol | Thiamethoxam | 0.6 | 0.3 | 1 | 1.9 | Granule |
| Tetraniliprole | Paclobutrazol | Imidacloprid | 0.6 | 0.3 | 1 | 1.9 | Granule |
| Tetraniliprole | Paclobutrazol | Fipronil | 0.6 | 0.3 | 1 | 1.9 | Granule |
| Tetraniliprole | Paclobutrazol | Triflumezopyrim | 6 | 6 | 5 | 17 | SC |
| Tetraniliprole | Paclobutrazol | Flupyrimin | 6 | 6 | 5 | 17 | SC |
| Cyantraniliprole | Mepiquat chloride | Methoxyfenozide | 5 | 5 | 12 | 22 | SC |
| Cyantraniliprole | Mepiquat chloride | Emamectin benzoate | 8 | 8 | 1.5 | 17.5 | SC |
| Cyantraniliprole | Mepiquat chloride | Novaluron | 8 | 8 | 8 | 24 | SC |
| Cyantraniliprole | Mepiquat chloride | Indoxacarb | 6.4 | 6.4 | 6 | 18.8 | OD |
| Cyantraniliprole | Mepiquat chloride | Bifenthrin | 8 | 8 | 8 | 24 | SC |
| Cyantraniliprole | Mepiquat chloride | Lambda cyhalothrin | 5 | 5 | 2.5 | 12.5 | ZC |
| Tetraniliprole | Mepiquat chloride | Methoxyfenozide | 5 | 5 | 12 | 22 | SC |
| Tetraniliprole | Mepiquat chloride | Emamectin benzoate | 8 | 8 | 1.5 | 17.5 | SC |
| Tetraniliprole | Mepiquat chloride | Novaluron | 8 | 8 | 8 | 24 | SC |
| Tetraniliprole | Mepiquat chloride | Indoxacarb | 6 | 6.4 | 6 | 18.4 | OD |
| Tetraniliprole | Mepiquat chloride | Bifenthrin | 8 | 8 | 8 | 24 | SC |
| Tetraniliprole | Mepiquat chloride | Lambda cyhalothrin | 5 | 5 | 2.5 | 12.5 | ZC |

### Biological Examples

A synergistic effect exists wherever the action of a combination of active ingredient is greater than the sum of the action of each of the components alone. Therefore a synergistically effective amount or an effective amount of a synergistic composition or combination is an amount that exhibits greater pesticidal activity than the sum of the pesticidal activities of the individual components.

In the field of agriculture, it is often understood that the term “synergy” is as defined by Colby S.R. in an article entitled “Calculation of the synergistic and antagonistic responses of herbicide combinations” published in the journal Weeds, 1967, 15, p. 20-22, incorporated herein by reference in its entirety. The action expected for a given combination of two or three active components can be calculated as follows:

Colby's Formula for Calculating Synergism Between Three Active Ingredients

$$E = ( X + Y + Z ) - \frac{( XY + XZ + YZ )}{100} + \frac{( X Y Z )}{10000}$$

Where, E=Expected % control by mixture/combination of Compound A, Compound B and Compound C in a defined dose
   X=Observed % control by Compound A
   Y=Observed % control by Compound B
   Z=Observed % control by Compound C

$$Ratio = \frac{Observed Value ( \% control )}{Expected Value ( \% control )}$$

If ratio of O/E>1, means synergism observed

Colby's Formula for Calculating Synergism Between Two Active Ingredients

$$E = X + Y - \frac{XY}{100}$$

Where, E=Expected % control by mixture/combination of Compound A and Compound B in a defined dose
   X=Observed % control by Compound A
   Y=Observed % control by Compound B

$$Ratio = \frac{Observed va lue ( \% control )}{Expected value ( \% control )}$$

Ratio of O/E>I, means synergism observed

The synergistic insecticidal action of the inventive mixtures can be demonstrated by the experiments below.

Field Bio-Efficacy Studies:

### Example 10

Experiment 1: Control of Paddy/Rice Brown Plant Hopper (BPH), Nilaparvata lugens
Crop & Variety: Paddy, BPT-5204
Location: Kurud, Dhamtari, Chattishgarh
Plot size: 20 sq. mt. (5 m×4 m)
Number of Treatments: Forty
Replication: Two
Application Time: 25 DATP (Days after transplanting)
Method of Application: Manual broadcasting of granules
Agronomic Practices: Fertilizer, irrigation, inter culturing, earthing up and weeding done as per the crop requirement.

Observation Methods:

% BPH Control:

Count the number of hoppers (BPH) per hill, observe 10 hills per plot. Record the observations at 50, 60 and 75 days after transplanting. Calculate the % Hoppers (BPH) control (observed value) as below formula.

$$\% Hoppers ( BPH ) control = 100 - \frac{Number of live BPH in treated plot}{Number of live BPH in untreated plot}$$

The calculated value of % Hoppers (BPH) control was worked out by using Colby's formula given above.

Tiller Counts:

The observations on productive tillers count was recorded by counting number of productive tillers per 1 sq.m. area and such 10 spots per plot were observed at 90 DATP (days after transplanting). The productive tillers directly contributing to the rice grain yield.

TABLE 1
Treatment Details for bioefficacy against Paddy/rice brown plant hopper (BPH), Nilaparvata lugens

| Treatment | | Application |
|---|---|---|
| number | Treatment Composition | Rate (gai/h) |
| 1 | Chlorantraniliprole 0.3% + Triacontanol 0.125% + Clothianidin 1% Gr | 30 + 12.5 + 100 |
| 2 | Chlorantraniliprole 0.3% + Triacontanol 0.125% + Thiamethoxam 1% Gr | 30 + 12.5 + 100 |
| 3 | Chlorantraniliprole 0.3% + Triacontanol 0.125% + Triflumezopyrim 0.25% Gr | 30 + 12.5 + 25 |
| 4 | Chlorantraniliprole 0.3% + Triacontanol 0.125% + Flupyrimin 1% Gr | 30 + 12.5 + 100 |
| 5 | Cyantraniliprole 0.6% + Triacontanol 0.125% + Clothianidin 1% Gr | 60 + 12.5 + 100 |
| 6 | Cyantraniliprole 0.6% + Triacontanol 0.125% + Thiamethoxam 1% Gr | 60 + 12.5 + 100 |
| 7 | Cyantraniliprole 0.6% + Triacontanol 0.125% + Triflumezopyrim 0.25% Gr | 60 + 12.5 + 25 |
| 8 | Cyantraniliprole 0.6% + Triacontanol 0.125% + Flupyrimin 1% Gr | 60 + 12.5 + 100 |
| 9 | Tetraniliprole 0.3% + Triacontanol 0.125% + Clothianidin 1% Gr | 30 + 12.5 + 100 |
| 10 | Tetraniliprole 0.3% + Triacontanol 0.125% + Thiamethoxam 1% Gr | 30 + 12.5 + 100 |
| 11 | Tetraniliprole 0.3% + Triacontanol 0.125% + Triflumezopyrim 0.25% Gr | 30 + 12.5 + 25 |
| 12 | Tetraniliprole 0.3% + Triacontanol 0.125% + Flupyrimin 1% Gr | 30 + 12.5 + 100 |
| 13 | Chlorantraniliprole 0.3% + Triacontanol 0.125% Gr | 30 + 12.5 |
| 14 | Cyantraniliprole 0.6% + Triacontanol 0.125% Gr | 60 + 12.5 |
| 15 | Tetraniliprole 0.3% + Triacontanol 0.125% Gr | 30 + 12.5 |
| 16 | Chlorantraniliprole 0.3% + Clothianidin 1% Gr | 30 + 100 |
| 17 | Chlorantraniliprole 0.3% + Thiamethoxam 1% Gr | 30 + 100 |
| 18 | Chlorantraniliprole 0.3% + Triflumezopyrim 0.25% Gr | 30 + 25 |
| 19 | Chlorantraniliprole 0.3% + Flupyrimin 1% Gr | 30 + 100 |
| 20 | Cyantraniliprole 0.6% + Clothianidin 1% Gr | 60 + 100 |
| 21 | Cyantraniliprole 0.6% + Thiamethoxam 1% Gr | 60 + 100 |
| 22 | Cyantraniliprole 0.6% + Triflumezopyrim 0.25% Gr | 60 + 25 |
| 23 | Cyantraniliprole 0.6% + Flupyrimin 1% Gr | 60 + 100 |
| 24 | Tetraniliprole 0.3% + Clothianidin 1% Gr | 30 + 100 |
| 25 | Tetraniliprole 0.3% + Thiamethoxam 1% Gr | 30 + 100 |
| 26 | Tetraniliprole 0.3% + Triflumezopyrim 0.25% Gr | 30 + 25 |
| 27 | Tetraniliprole 0.3% + Flupyrimin 1% Gr | 30 + 100 |
| 28 | Triacontanol 0.125% + Clothianidin 1% Gr | 12.5 + 100 |
| 29 | Triacontanol 0.125% + Thiamethoxam 1% Gr | 12.5 + 100 |
| 30 | Triacontanol 0.125% + Triflumezopyrim 0.25% Gr | 12.5 + 25 |
| 31 | Triacontanol 0.125% + Flupyrimin 1% Gr | 12.5 + 100 |
| 32 | Chlorantraniliprole 0.3% Gr | 30 |
| 33 | Cyantraniliprole 0.6% Gr | 60 |
| 34 | Tetraniliprole 0.3% Gr | 30 |
| 35 | Triacontanol 0.125% Gr | 12.5 |
| 36 | Clothianidin 1% Gr | 100 |
| 37 | Thiamethoxam 1% Gr | 100 |
| 38 | Triflumezopyrim 0.25% Gr | 25 |
| 39 | Flupyrimin 1% Gr | 100 |
| 40 | UTC (Untreated Check) | 0 |

Treatment numbers from 13 to 31 are prior art.
Gr—Granule, gai/h—gram active ingredients per hectare

TABLE 2
Synergistic bio efficacy against Paddy/rice brown
plant hopper (BPH), Nilaparvata lugens

| Treatment | % Brown Plant Hopper Control at 60 DATP | | | Synergism |
|---|---|---|---|---|
| number | Observed Value | Calculated Value | Ratio O/E | (Y/N) |
| 1 | 87.4 | 78.12 | 1.12 | Y |
| 2 | 84.6 | 75.44 | 1.12 | Y |
| 3 | 90.4 | 80.10 | 1.13 | Y |
| 4 | 86.8 | 78.12 | 1.11 | Y |
| 5 | 90.4 | 79.34 | 1.14 | Y |
| 6 | 85.8 | 76.81 | 1.12 | Y |
| 7 | 92.4 | 81.20 | 1.14 | Y |
| 8 | 89.8 | 79.34 | 1.13 | Y |
| 9 | 90.2 | 79.47 | 1.14 | Y |
| 10 | 85.2 | 76.96 | 1.11 | Y |
| 11 | 91.8 | 81.33 | 1.13 | Y |
| 12 | 89.6 | 79.47 | 1.13 | Y |
| 13 | 38.6 | 41.81 | 0.92 | N |
| 14 | 40.8 | 45.04 | 0.91 | N |
| 15 | 42.4 | 45.40 | 0.93 | N |
| 16 | 74.6 | 75.64 | 0.99 | N |
| 17 | 70.2 | 72.65 | 0.97 | N |
| 18 | 77.2 | 77.84 | 0.99 | N |
| 19 | 75.2 | 75.64 | 0.99 | N |
| 20 | 75.8 | 76.99 | 0.98 | N |
| 21 | 73.4 | 74.17 | 0.99 | N |
| 22 | 77.8 | 79.07 | 0.98 | N |
| 23 | 75.6 | 76.99 | 0.98 | N |
| 24 | 76.4 | 77.14 | 0.99 | N |
| 25 | 73.4 | 74.34 | 0.99 | N |
| 26 | 78.6 | 79.21 | 0.99 | N |
| 27 | 76.2 | 77.14 | 0.99 | N |
| 28 | 65.8 | 66.24 | 0.99 | N |
| 29 | 59.4 | 62.10 | 0.96 | N |
| 30 | 68.6 | 69.29 | 0.99 | N |
| 31 | 65.2 | 66.24 | 0.98 | N |
| 32 | 35.2 | | | |
| 33 | 38.8 | | | |
| 34 | 39.2 | | | |
| 35 | 10.2 | | | |
| 36 | 62.4 | | | |
| 37 | 57.8 | | | |
| 38 | 65.8 | | | |
| 39 | 62.4 | | | |
| 40 | 0 | | | |

The field trials results of granular formulations of innovative combinations (treatment number 1 to 12) shows synergistic control of rice brown plant hopper compared to all prior art treatments (treatment number 13 to 31).

TABLE 3
Residual control (duration of control) of paddy/rice
brown plant hopper (BPH) and tiller counts.

| Treatment | % Brown Plant Hopper Control at | | | Number of productive |
|---|---|---|---|---|
| number | 50 DATP | 60 DATP | 75 DATP | tillers/m² at 90 DATP |
| 1 | 86.2 | 87.4 | 81.20 | 320.2 |
| 2 | 81.2 | 84.6 | 78.80 | 314.8 |
| 3 | 86.8 | 90.4 | 83.60 | 301.6 |
| 4 | 85.2 | 86.8 | 80.20 | 310.2 |
| 5 | 87.2 | 90.4 | 82.20 | 302.6 |
| 6 | 82.6 | 85.8 | 78.80 | 311.6 |
| 7 | 90.8 | 92.4 | 85.80 | 322.6 |
| 8 | 85.8 | 89.8 | 82.40 | 316.2 |
| 9 | 86.4 | 90.2 | 83.40 | 325.4 |
| 10 | 82.4 | 85.2 | 79.80 | 315.8 |
| 11 | 88.6 | 91.8 | 85.20 | 310.2 |
| 12 | 85.2 | 89.6 | 84.60 | 306.8 |
| 13 | 30.2 | 38.6 | 30.20 | 268.4 |
| 14 | 34.6 | 40.8 | 31.60 | 258.8 |
| 15 | 34.8 | 42.4 | 30.00 | 252.4 |
| 16 | 69.8 | 74.6 | 62.40 | 280.2 |
| 17 | 64.2 | 70.2 | 60.60 | 271.6 |
| 18 | 63.8 | 77.2 | 64.80 | 284.6 |
| 19 | 70.2 | 75.2 | 66.20 | 260.4 |
| 20 | 69.8 | 75.8 | 66.40 | 282.4 |
| 21 | 65.8 | 73.4 | 64.20 | 277.4 |
| 22 | 64.6 | 77.8 | 65.80 | 268.8 |
| 23 | 70.4 | 75.6 | 67.40 | 270.2 |
| 24 | 68.6 | 76.4 | 63.80 | 278.2 |
| 25 | 65.2 | 73.4 | 61.80 | 269.2 |
| 26 | 64.2 | 78.6 | 64.00 | 280.4 |
| 27 | 71.0 | 76.2 | 65.20 | 273.4 |
| 28 | 59.8 | 65.8 | 50.20 | 260.2 |
| 29 | 52.2 | 59.4 | 46.20 | 245.8 |
| 30 | 50.8 | 68.6 | 50.80 | 240.4 |
| 31 | 60.2 | 65.2 | 52.20 | 242.8 |
| 32 | 30.4 | 35.2 | 30.60 | 196.8 |
| 33 | 32.2 | 38.8 | 33.40 | 192.4 |
| 34 | 31.6 | 39.2 | 28.80 | 192.8 |
| 35 | 5.2 | 10.2 | 2.20 | 186.8 |
| 36 | 57.8 | 62.4 | 50.20 | 196.8 |
| 37 | 50.2 | 57.8 | 46.80 | 184.8 |
| 38 | 48.6 | 65.8 | 50.20 | 180.2 |
| 39 | 58.2 | 62.4 | 51.80 | 182.4 |
| 40 | 0 | 0 | 0 | 160.2 |

All innovative synergistic mixtures (treatment number 1 to 12) provides excellent residual control (duration of control) i.e. 78.8 to 85.80% control at 75 DATP, where as all prior art treatments (treatment number 13 to 31) provides 30.20 to 67.4% control at 75 DATP. The number of productive tillers at 90 DATP, is varies from 301.6 to 325.4 per sq.m in innovative synergistic mixtures treatment (treatment number 1 to 12) compared to 240.4 to 284.6 per sq.m in all prior art treatments (treatment number 13 to 31).

Conclusion:
1. Synergism was observed in innovative mixtures/combinations (treatment number 1 to 12)
2. The innovative synergistic combinations (treatment number 1 to 12) provides better control of BPH (higher % control) and longer duration which ultimately helps the fanners in reducing the number of sprays and thereby reducing the loading of active ingredients in the crop ecosystem.
3. The innovative synergistic combinations (treatment number 1 to 12) produces higher number of productive tillers, which directly contributes to the higher grain yields.

### Example 11

Experiment 2: Control of Paddy/Rice Stem Borer, Scirpophaga incertulas and Brown Plant Hopper, Nilaparvata Lugen
Crop & Variety: Paddy, BPT-5204
Location: Kurud, Dhamtari, Chattishgarh
Plot size: 20 sq. mt. (5 m×4 m)
Number of Treatments: Twenty four
Replication: Two
Application Time: 25 DATP (Days after transplanting)
Method of Application: Manual broadcasting of granules.
Agronomic Practices: Fertilizer, irrigation, inter culturing, earthing up and weeding done as per the crop requirement.

Observation Methods:

Stem Borer Control:

The infestation by stem borer was observed as white ear (WE) during reproductive stages from 10 hills per plot. The observation on white ear was recorded at 100 days after transplanting of the crop.

The percentage of WE in each individual plot was calculated by using formulae described below:

$$White ear ( WE \% ) = \frac{Number of white ear per 10 hills}{Total number bearing panicle per 10 hills} \times 100$$

$$\% Stem borer control ( White ear symptoms ) = 100 - \frac{White ear ( \% ) in treatment}{White ear ( \% ) in untreated} \times 100$$

% BPH Control:

Count the number of hoppers (BPH) per hill, observe 10 hills per plot. Record the observations when moderate infestation noticed in untreated plot. Calculate the % Hoppers (BPH) control (observed value) as below formula.

$$\% Hoppers ( BPH ) control = 100 - \frac{Number of live BPH in treated plot}{Number of live BPH in untreated plot}$$

The calculated value of % control was used to worked out the Colby's formula to judge the synergism.

Tiller count: Count the number of productive tillers per hill. Record observations from 10 hills per plot before harvesting.

TABLE 4
Treatment Details for bioefficacy against Paddy/rice stem borer,
Scirpophaga incertulas and BPH, Nilaparvata lugen

| Treatment | |
|---|---|
| number | Treatment details with application Rate (ml or g per hectare) |
| 1 | Cyclaniliprole 0.6% + Triacontanol 0.125% + Fipronil 0.6% GR-10 kg/h |
| 2 | Cyclaniliprole 0.6% + Triacontanol 0.125% + Clothianidin 0.75% GR-10 kg/h |
| 3 | Cyclaniliprole 0.6% + Triacontanol 0.125% + Triflumezopyrim 0.2% GR-10 kg/h |
| 4 | Cyclaniliprole 0.6% + Triacontanol 0.125% + Flupyrimin 1% GR-10 kg/h |
| 5 | Cyclaniliprole 0.6% + Triacontanol 0.125% + Pymetrozine 2% GR-10 kg/h |
| 6 | Cyclaniliprol 5% SL-1200 ml/h + Triacontanol 0.5% GR-2.5 kg/h |
| 7 | Cyclaniliprol 5% SL-1200 ml/h + Fipronil 0.3% GR-20 kg/h |
| 8 | Cyclaniliprol 5% SL-1200 ml/h + Clothianidin 2% GR-3.750 kg/h |
| 9 | Cyclaniliprol 5% SL-1200 ml/h + Triflumezopyrim 10% SC-200 ml/h |
| 10 | Cyclaniliprol 5% SL-1200 ml/h + Flupyrimin 2% GR-5 kg/h |
| 11 | Cyclaniliprol 5% SL-1200 ml/h + Pymetrozine 50% WG-400 g/h |
| 12 | Triacontanol 0.5% GR-2.5 kg/h + Fipronil 0.3% GR-20 kg/h |
| 13 | Triacontanol 0.5% GR-2.5 kg/h + Clothianidin 2% GR-3.750 kg/h |
| 14 | Triacontanol 0.5% GR-2.5 kg/h + Triflumezopyrim 10% SC-200 ml/h |
| 15 | Triacontanol 0.5% GR-2.5 kg/h + Flupyrimin 2% GR-5 kg/h |
| 16 | Triacontanol 0.5% GR-2.5 kg/h + Pymetrozine 50% WG-400 g/h |
| 17 | Cyclaniliprol 5% SL-1200 ml/h |
| 18 | Triacontanol 0.5% GR-2.5 kg/h |
| 19 | Fipronil 0.3% GR-20 kg/h |
| 20 | Clothianidin 2% GR-3.750 kg/h |
| 21 | Triflumezopyrim 10% SC-200 ml/h |
| 22 | Flupyrimin 2% GR-5 kg/h |
| 23 | Pymetrozine 50% WG-400 g/h |
| 24 | UTC (Untreated Check) |

Treatment number 1 to 5 are innovative ready mix slow release Granule (GR-Slow release) formulations. Treatment number 6 to 16 are prior arts (tank mixes).

TABLE 5
Synergistic bioefficacy against Paddy/rice stem borer,
Scirpophaga incertulas and BPH, Nilaparvata lugen

| | % Stem borer Control | | | % BPH Control | | | | Average |
|---|---|---|---|---|---|---|---|---|
| | | | Colby/s | | | Colby/s | | number of |
| Treatment | Obs. | Cal. | Ratio | Obs. | Cal. | Ratio | Synergism | productive |
| number | Value | Value | O/E | Value | Value | O/E | (Y/N) | tillers/hill |
| 1 | 98.4 | 85.96 | 1.14 | 76.4 | 60.06 | 1.27 | Y | 44.2 |
| 2 | 92.6 | 82.25 | 1.13 | 88.2 | 70.95 | 1.24 | Y | 45.8 |
| 3 | 82.2 | 74.26 | 1.11 | 90.6 | 72.21 | 1.25 | Y | 43.4 |
| 4 | 99.2 | 86.48 | 1.15 | 86.6 | 69.69 | 1.24 | Y | 46.2 |
| 5 | 80.4 | 72.31 | 1.11 | 92.4 | 75.00 | 1.23 | Y | 44.6 |
| 6 | 67.2 | 67.50 | 1.00 | 28.4 | 30.17 | 0.94 | N | 38.6 |
| 7 | 82.6 | 84.97 | 0.97 | 56.2 | 59.16 | 0.95 | N | 34.8 |
| 8 | 78.8 | 81.00 | 0.97 | 68.4 | 70.30 | 0.97 | N | 35.4 |
| 9 | 70.6 | 72.44 | 0.97 | 69.2 | 71.58 | 0.97 | N | 34.6 |
| 10 | 84.6 | 85.52 | 0.99 | 65.2 | 69.01 | 0.94 | N | 37.2 |
| 11 | 67.4 | 70.35 | 0.96 | 70.4 | 74.44 | 0.95 | N | 34.8 |
| 12 | 56.2 | 59.65 | 0.94 | 42.6 | 44.06 | 0.97 | N | 36.2 |
| 13 | 46.8 | 49.00 | 0.96 | 56.8 | 59.32 | 0.96 | N | 37.6 |
| 14 | 22.8 | 26.03 | 0.88 | 59.8 | 61.08 | 0.98 | N | 36.8 |
| 15 | 56.6 | 61.15 | 0.93 | 56.4 | 57.55 | 0.98 | N | 38.2 |
| 16 | 17.2 | 20.42 | 0.84 | 62.4 | 64.99 | 0.96 | N | 35.8 |
| 17 | 65.2 | | | 28.6 | | | | 32.4 |
| 18 | 6.6 | | | 2.2 | | | | 28.4 |
| 19 | 56.8 | | | 42.8 | | | | 31.2 |
| 20 | 45.4 | | | 58.4 | | | | 31.6 |
| 21 | 20.8 | | | 60.2 | | | | 31.0 |
| 22 | 58.4 | | | 56.6 | | | | 32.8 |
| 23 | 14.8 | | | 64.2 | | | | 30.4 |
| 24 | 0.0 | | | 0.0 | | | | 25.8 |

All innovative ready mix slow release granules (treatment number 1 to 5) shows synergistic efficacy against paddy stem borer control and brown plant hopper control compared to all prior art treatments (treatment number 6 to 16). All innovative ready mix slow release granules (treatment number 1 to 5) also produces higher number of productive tillers per hills, which will be directly contributing to the grain yield.

### Example 12

Experiment 3: Control of Sugarcane Early Shoot Borer (ESB). Chilo infuscatellus
Crop & Variety: Sugarcane, Co-0118
Location: Dhanaula, Dist. Amroha, Uttar Pradesh
Treatments: 32
Plot size: 9 sq.m
Spacing: 90 cm row to row
Planting material: 3 budded setts, 4 setts per meter
Time of Application: At the time of planting

Method of Application:

In furrow application, over the setts and cover up with soil. The required dose was mixed in water and sprayed (using knapsack sprayer by removing nozzle) over the planted setts in the furrows for the insecticide to spread thoroughly around the planting zone.
Agronomic Practices: Fertilizer, irrigation, inter culturing, earthing up and weeding done as per the crop requirement.
Observation Methods:
Early shoot borer (Chilo infuscatellus) incidence (%):
Fifty shoots per plot were selected randomly and presence of characteristic “dead heart” (damaged shoots) were recorded to calculate percent shoot damage by early shoot borer at 90 (DAP) days after planting.

$$Shoot damage ( \% ) by ESB = \frac{Damaged shoots}{Total number of shoots obsesrved ( 50 )} \times 100$$

Early shoot borer (ESB) control calculated by below formula,

$$\% Early Shoot Borer ( ESB ) control = 100 - \frac{\% shoot damage by ESB in treated plot}{\% shoot damage by ESB in untreated plot} \times 100$$

% Early shoot borer data used to check the synergism by applying Colby's formula given above.
Shoot count: Count the number of shoots/tillers from 1 mrl (meter row length) from randomly selected 5 spot per plot at 90 DAP.

The percent increase in shoot over untreated control were calculated by below formula.

$$Percent increase over untreated control = 100 \times \frac{Number of shoots in treatment}{Number of shoots in untreated control} - 100$$

TABLE 6
Treatment details for field bioefficacy against sugarcane
early shoot borer (ESB), Chilo infuscatellus

| | | Compound B | Compound C |
|---|---|---|---|
| Treat- | | Gibberellic | Methoxyfenozide |
| ment | | acid | 24% SC |
| number | Compound A | 0.001% L | (21.8% w/v) |
| 1 | Chlorantraniliprole 20% SC | 750 | 416 |
| 2 | Cyantraniliprole 10.26% OD | 750 | 416 |
| 3 | Cyclaniliprole 5% SL | 750 | 416 |
| 4 | Tetraniliprole 20% SC | 750 | 416 |
| 5 | Flubendiamide 48% SC | 750 | 416 |
| 6 | Broflanilide 30% SC | 750 | 416 |
| 7 | Cyhalodiamide 20% SC | 750 | 416 |
| 8 | Chlorantraniliprole 20% SC | 750 | — |
| 9 | Cyantraniliprole 10.26% OD | 750 | — |
| 10 | Cyclaniliprole 5% SL | 750 | — |
| 11 | Tetraniliprole 20% SC | 750 | — |
| 12 | Flubendiamide 48% SC | 750 | — |
| 13 | Broflanilide 30% SC | 750 | — |
| 14 | Cyhalodiamide 20% SC | 750 | — |
| 15 | Chlorantraniliprole 20% SC | — | 416 |
| 16 | Cyantraniliprole 10.26% OD | — | 416 |
| 17 | Cyclaniliprole 5% SL | — | 416 |
| 18 | Tetraniliprole 20% SC | — | 416 |
| 19 | Flubendiamide 48% SC | — | 416 |
| 20 | Broflanilide 30% SC | — | 416 |
| 21 | Cyhalodiamide 20% SC | — | 416 |
| 22 | | 750 | 416 |
| 23 | Chlorantraniliprole 20% SC | — | — |
| 24 | Cyantraniliprole 10.26% OD | — | — |
| 25 | Cyclaniliprole 5% SL | — | — |
| 26 | Tetraniliprole 20% SC | — | — |
| 27 | Flubendiamide 48% SC | — | — |
| 28 | Broflanilide 30% SC | — | — |
| 29 | Cyhalodiamide 20% SC | — | — |
| 30 | | 750 | — |
| 31 | | — | 416 |
| 32 | UTC (Untreated Check) | — | — |

Chlorantraniliprole 20% SC (18.5% w/w), Cyantraniliprole 10% OD (10.26% w/w), Cyclaniliprole 5% SL (4.55% w/w), Flubendiamide 48% SC (39.35% w/w).
Treatment number from composition from 8 to 22 are prior arts.

TABLE 7
Synergistic bio efficacy against sugarcane early shoot borer (ESB), Chilo infuscatellus

| | % Early shoot borer (ESB) control | | | | Number of | % Increase in |
|---|---|---|---|---|---|---|
| Treatment | Observed | Calculated | Ratio | Synergism | shoot per mrl | shoots over |
| number | Value | Value | O/E | (Y/N) | at 90 DAP | Untreated check |
| 1 | 98.6 | 86.95 | 1.13 | Y | 45.6 | 171.4 |
| 2 | 97.2 | 86.54 | 1.12 | Y | 47.8 | 184.5 |
| 3 | 99.2 | 87.03 | 1.14 | Y | 46.2 | 175.0 |
| 4 | 98.4 | 86.38 | 1.14 | Y | 45.6 | 171.4 |
| 5 | 97.4 | 86.95 | 1.12 | Y | 46.8 | 178.6 |
| 6 | 96.4 | 86.21 | 1.12 | Y | 47.6 | 183.3 |
| 7 | 97.6 | 87.03 | 1.12 | N | 46.6 | 177.4 |
| 8 | 69.4 | 71.51 | 0.97 | N | 34.8 | 107.1 |
| 9 | 68.8 | 70.61 | 0.97 | N | 35.6 | 111.9 |
| 10 | 69.4 | 71.69 | 0.97 | N | 36.2 | 115.5 |
| 11 | 69.2 | 70.25 | 0.99 | N | 35.4 | 110.7 |
| 12 | 69.4 | 71.51 | 0.97 | N | 34.6 | 106.0 |
| 13 | 68.8 | 69.89 | 0.98 | N | 35 | 108.3 |
| 14 | 70.4 | 71.69 | 0.98 | N | 36.4 | 116.7 |
| 15 | 84.8 | 85.44 | 0.99 | N | 38.4 | 128.6 |
| 16 | 83.6 | 84.98 | 0.98 | N | 39.2 | 133.3 |
| 17 | 84.6 | 85.53 | 0.99 | N | 37.6 | 123.8 |
| 18 | 83.4 | 84.79 | 0.98 | N | 38.8 | 131.0 |
| 19 | 84.2 | 85.44 | 0.99 | N | 39.2 | 133.3 |
| 20 | 83.6 | 84.61 | 0.99 | N | 38.6 | 129.8 |
| 21 | 83.8 | 85.53 | 0.98 | N | 37 | 120.2 |
| 22 | 57.6 | 58.96 | 0.98 | N | 28.6 | 70.2 |
| 23 | 68.2 | | | | 32.6 | |
| 24 | 67.2 | | | | 31.6 | |
| 25 | 68.4 | | | | 32.4 | |
| 26 | 66.8 | | | | 31.2 | |
| 27 | 68.2 | | | | 30.8 | |
| 28 | 66.4 | | | | 31 | |
| 29 | 68.4 | | | | 30 | |
| 30 | 10.4 | | | | 20.4 | |
| 31 | 54.2 | | | | 23.4 | |
| 32 | 0 | | | | 16.8 | |

All innovative synergistic mixtures (treatment number 1 to 7) shows synergism in efficacy against early shoot borer control and provides excellent residual control (duration of control) i.e. 96.4 to 99.2% control at 90 DAP (days after planting), whereas all prior art treatments (treatment number 8 to 22) provides 57.6 to 84.8% control.

The number of productive shoots are much higher in in innovative synergistic mixtures treatment (treatment number 1 to 7) i.e. 45.6 to 47.8 per mrl (meter row length) compared to all prior art treatments (treatment number 8 to 22) i.e. 28.6 to 39.2 per mrl in. The number of productive tillers were higher in innovative synergistic mixtures treatments (treatment number 1 to 7) compared to all prior art treatments (treatment number 8 to 22).

Conclusion:
1. Synergism was observed in innovative mixtures/combinations
2. The innovative synergistic combinations provides better control of ESB (early shoot borer), higher % control and longer duration which ultimately helps the farmers in reducing the number of sprays and thereby reducing the loading of active ingredients in the crop ecosystem.
3. The innovative synergistic combinations produces higher number of productive shoots, which directly contributes to the higher cane yields.

### Example 13

Experiment 4: Bioefficacy Against Spodoptera litura Infesting Cabbage Crop
Crop & Variety: Cabbage, Indu
Location: Padra, Dist. Baroda, Gujarat
Treatments: 28
Plot size: 15 sq.m
Spacing: 45 cm×15 cm
Time of Application: As soon as Spodoptera larval infestation observed
Method of Application: Foliar spray with knapsack sprayer
Water volume: 500 liter per hectare
Agronomic Practices: Fertilizer, irrigation, inter culturing, earthing up and weeding done as per the crop requirement.
Observation Methods:
Larval control (%) of Spodoptera litura: Count the number of live larvae per plant on 7^{th} days after application. Observed such 10 plants per plot and calculate % larval control by given formula.

$$\% Larval control = 100 - \frac{Number of live larva in treate plot}{Number of live larvae in untreated control} \times 100$$

% Larval control data used to check the synergism by applying Colby's formula.

TABLE 8
Synergistic bioefficacy against Spodoptera litura infesting cabbage crop.

| | Treatment details with application Rate (ml or g per Hectare) | | | | | | |
|---|---|---|---|---|---|---|---|
| | | Compound B- | Compound C- | % Spodoptera larval control | | | |
| Treatment | | Gibberellic | Emamectin | Observed | Calculated | Ratio | Synergism |
| number | Compound A | acid 0.001% L | benzoate 5% SG | Value | Value | O/E | (Y/N) |
| 1 | Chlorantraniliprole | 500 ml | 100 g | 100 | 88.65 | 1.13 | Y |
| | 20% SC, 100 ml | | | | | | |
| 2 | Cyantraniliprole | 500 ml | 100 g | 99.8 | 88.16 | 1.13 | Y |
| | 10.26% OD, 100 ml | | | | | | |
| 3 | Cyclaniliprole | 500 ml | 100 g | 100 | 88.99 | 1.12 | Y |
| | 4.55% SL, 400 ml | | | | | | |
| 4 | Tetraniliprole | 500 ml | 100 g | 100 | 88.72 | 1.13 | Y |
| | 20% SC, 100 ml | | | | | | |
| 5 | Flubendiamide | 500 ml | 100 g | 100 | 88.51 | 1.13 | Y |
| | 39.35% SC, 50 ml | | | | | | |
| 6 | Broflanilide | 500 ml | 100 g | 100 | 88.58 | 1.13 | Y |
| | 30% SC, 50 ml | | | | | | |
| 7 | Chlorantraniliprole | 500 ml | | 69.4 | 72.58 | 0.96 | N |
| | 20% SC, 100 ml | | | | | | |
| 8 | Cyantraniliprole | 500 ml | | 68.8 | 71.41 | 0.96 | N |
| | 10.26% OD, 100 ml | | | | | | |
| 9 | Cyclaniliprole | 500 ml | | 69.4 | 73.42 | 0.95 | N |
| | 4.55% SL, 400 ml | | | | | | |
| 10 | Tetraniliprole | 500 ml | | 69.2 | 72.75 | 0.95 | N |
| | 20% SC, 100 ml | | | | | | |
| 11 | Flubendiamide | 500 ml | | 69.4 | 72.24 | 0.96 | N |
| | 39.35% SC, 50 ml | | | | | | |
| 12 | Broflanilide | 500 ml | | 68.8 | 72.41 | 0.95 | N |
| | 30% SC, 50 ml | | | | | | |
| 13 | Chlorantraniliprole | | 100 g | 84.8 | 86.42 | 0.98 | N |
| | 20% SC, 100 ml | | | | | | |
| 14 | Cyantraniliprole | | 100 g | 83.4 | 85.84 | 0.97 | N |
| | 10.26% OD, 100 ml | | | | | | |
| 15 | Cyclaniliprole | | 100 g | 85.2 | 86.83 | 0.98 | N |
| | 4.55% SL, 400 ml | | | | | | |
| 16 | Tetraniliprole | | 100 g | 84.4 | 86.50 | 0.98 | N |
| | 20% SC, 100 ml | | | | | | |
| 17 | Flubendiamide | | 100 g | 85.4 | 86.26 | 0.99 | N |
| | 39.35% SC, 50 ml | | | | | | |
| 18 | Broflanilide | | 100 g | 85.2 | 86.34 | 0.99 | N |
| | 30% SC, 50 ml | | | | | | |
| 19 | | 500 ml | 100 g | 60.4 | 65.39 | 0.92 | N |
| 20 | Chlorantraniliprole | | | 67.2 | | | |
| | 20% SC, 100 ml | | | | | | |
| 21 | Cyantraniliprole | | | 65.8 | | | |
| | 10.26% OD, 100 ml | | | | | | |
| 22 | Cyclaniliprole | | | 68.2 | | | |
| | 4.55% SL, 400 ml | | | | | | |
| 23 | Tetraniliprole | | | 67.4 | | | |
| | 20% SC, 100 ml | | | | | | |
| 24 | Flubendiamide | | | 66.8 | | | |
| | 39.35% SC, 50 ml | | | | | | |
| 25 | Broflanilide | | | 67.0 | | | |
| | 30% SC, 50 ml | | | | | | |
| 26 | | 500 ml | | 16.4 | | | |
| 27 | | | 100 g | 58.6 | | | |
| 28 | UTC (Untreated | | | 0.0 | | | |
| | Check) | | | | | | |

Treatment number from Sr. No. 7 to 19 are prior art.

Results:

All innovative synergistic mixtures (treatment number sr. no. 1 to 6) shows synergism in terms of efficacy against Spodoptera litura and provides excellent i.e. 98.2 to 100% control on 7 day after application compared to all prior art treatments (treatment number 7 to 19) i.e. 60.4 to 85.4% on 7^{th} day.

### Example 14

Experiment 5: Control of Sugarcane Early Shoot Borer (ESB). Chilo Infuscatellus
Crop & Variety: Sugarcane, Co-0118
Location: Yamunagar, Haryana
Treatments: 40
Plot size: 9 sq.m
Spacing: 90 cm row to row
Planting material: 3 budded setts, 4 setts per meter
Time of Application: At the time of planting
Method of Application:

In furrow application, over the setts and cover up with soil. The required dose was mixed in water and sprayed (using knapsack sprayer by removing nozzle) over the planted setts in the furrows for the insecticide to spread thoroughly around the planting zone.

Agronomic Practices: Fertilizer, irrigation, inter culturing, earthing up and weeding done as per the crop requirement.

Observation Methods:

Early Shoot Borer (Chilo infuscatellus) Incidence (%):

Fifty shoots per plot were selected randomly and presence of characteristic “dead heart” (damaged shoots) were recorded to calculate percent shoot damage by early shoot borer at 90 (DAP) days after planting.

$$Shoot damage ( \% ) by ESB = \frac{Damaged shoots}{Total number of shoots observed ( 50 )} \times 100$$

Early shoot borer (ESB) control calculated by below formula,

$$\% Early Shoot Borer ( ESB ) control = 100 - \frac{\% shoot damage by ESB in treated plot}{\% shoot damage by ESB in untreated plot} \times 100$$

% Early shoot borer data used to check the synergism by applying Colby's formula given above.

Shoot Count:

Count the number of shoots/tillers from 1 mrl (meter row length) from randomly selected 5 spot per plot at 90 DAP.

The percent increase in shoot over untreated control were calculated by below formula.

$$Percent increase over untreated control = 100 \times \frac{Number of shoots in treatment}{Number of shoots in untreated control} - 1 \; 00$$

TABLE 9
Treatment details for field bioefficacy against sugarcane
early shoot borer (ESB), Chilo Infuscatellus

| | Treatment Composition with Use rate (ml or g per hectare) | | |
|---|---|---|---|
| | | Compound B- | |
| Sr. | | Gibberellic | |
| No. | Compound A | acid 0.001% L | Compound C |
| 1 | Tetraniliprole 20% SC, 250 ml | 180 ml | Novaluron 10% EC, 500 ml |
| 2 | Tetraniliprole 20% SC, 250 ml | 180 ml | Dichloromezotiaz 35% WG, 25 g |
| 3 | Tetraniliprole 20% SC, 250 ml | 180 ml | Indoxacarb 14.5% SC, 375 ml |
| 4 | Tetraniliprole 20% SC, 250 ml | 180 ml | Spinetoram 11.7% SC, 180 ml |
| 5 | Broflanilide 30% SC, 80 ml | 180 ml | Novaluron 10% EC, 500 ml |
| 6 | Broflanilide 30% SC, 80 ml | 180 ml | Dichloromezotiaz 35% WG, 25 g |
| 7 | Broflanilide 30% SC, 80 ml | 180 ml | Indoxacarb 14.5% SC, 375 ml |
| 8 | Broflanilide 30% SC, 80 ml | 180 ml | Spinetoram 11.7% SC, 180 ml |
| 9 | Chlorantraniliprole 20% SC, 375 ml | 180 ml | Novaluron 10% EC, 500 ml |
| 10 | Chlorantraniliprole 20% SC, 375 ml | 180 ml | Dichloromezotiaz 35% WG, 25 g |
| 11 | Chlorantraniliprole 20% SC, 375 ml | 180 ml | Indoxacarb 14.5% SC, 375 ml |
| 12 | Chlorantraniliprole 20% SC, 375 ml | 180 ml | Spinetoram 11.7% SC, 180 ml |
| 13 | Tetraniliprole 20% SC, 250 ml | 180 ml | |
| 14 | Broflanilide 30% SC, 80 ml | 180 ml | |
| 15 | Chlorantraniliprole 20% SC, 375 ml | 180 ml | |
| 16 | Tetraniliprole 20% SC, 250 ml | | Novaluron 10% EC, 500 ml |
| 17 | Tetraniliprole 20% SC, 250 ml | | Dichloromezotiaz 35% WG, 25 g |
| 18 | Tetraniliprole 20% SC, 250 ml | | Indoxacarb 14.5% SC, 375 ml |
| 19 | Tetraniliprole 20% SC, 250 ml | | Spinetoram 11.7% SC, 180 ml |
| 20 | Broflanilide 30% SC, 80 ml | | Novaluron 10% EC, 500 ml |
| 21 | Broflanilide 30% SC, 80 ml | | Dichloromezotiaz 35% WG, 25 g |
| 22 | Broflanilide 30% SC, 80 ml | | Indoxacarb 14.5% SC, 375 ml |
| 23 | Broflanilide 30% SC, 80 ml | | Spinetoram 11.7% SC, 180 ml |
| 24 | Chlorantraniliprole 20% SC, 375 ml | | Novaluron 10% EC, 500 ml |
| 25 | Chlorantraniliprole 20% SC, 375 ml | | Dichloromezotiaz 35% WG, 25 g |
| 26 | Chlorantraniliprole 20% SC, 375 ml | | Indoxacarb 14.5% SC, 375 ml |
| 27 | Chlorantraniliprole 20% SC, 375 ml | | Spinetoram 11.7% SC, 180 ml |
| 28 | | 180 ml | Novaluron 10% EC, 500 ml |
| 29 | | 180 ml | Dichloromezotiaz 35% WG, 25 g |
| 30 | | 180 ml | Indoxacarb 14.5% SC, 375 ml |
| 31 | | 180 ml | Spinetoram 11.7% SC, 180 ml |
| 32 | Tetraniliprole 20% SC, 250 ml | | |
| 33 | Broflanilide 30% SC, 80 ml | | |
| 34 | Chlorantraniliprole 20% SC, 375 ml | | |
| 35 | | 180 ml | |
| 36 | | | Novaluron 10% EC |
| 37 | | | Dichloromezotiaz 35% WG |
| 38 | | | Indoxacarb 14.5% SC |
| 39 | | | Spinetoram 11.7% SC, 180 ml |
| 40 | UTC (Untreated Check) | | |

Treatment composition from Sr. No. 13 to 31 are prior art.

TABLE 10
Synergistic bio efficacy against sugarcane early
shoot borer (ESB), Chilo Infuscatellus

| | % Early shoot borer (ESB) control | | | | Number of | % Increase in |
|---|---|---|---|---|---|---|
| Sr. | Observed | Calculated | Ratio | Synergism | shoot per mrl | shoots over |
| No. | Value | Value | O/E | (Y/N) | at 90 DAP | Untreated check |
| 1 | 100 | 84.29 | 1.19 | Y | 46.8 | 220.5 |
| 2 | 100 | 83.75 | 1.19 | Y | 44.2 | 202.7 |
| 3 | 99.2 | 81.35 | 1.22 | Y | 47.8 | 227.4 |
| 4 | 98.6 | 81.89 | 1.20 | Y | 45.6 | 212.3 |
| 5 | 100 | 84.04 | 1.19 | Y | 44.0 | 201.4 |
| 6 | 100 | 83.49 | 1.20 | Y | 44.6 | 205.5 |
| 7 | 98.4 | 81.05 | 1.21 | Y | 48.2 | 230.1 |
| 8 | 98.2 | 81.61 | 1.20 | Y | 46.8 | 220.5 |
| 9 | 100 | 83.54 | 1.20 | Y | 44.2 | 202.7 |
| 10 | 100 | 82.97 | 1.21 | Y | 47.8 | 227.4 |
| 11 | 97.8 | 80.45 | 1.22 | Y | 43.8 | 200.0 |
| 12 | 98.4 | 81.03 | 1.21 | Y | 44.8 | 206.8 |
| 13 | 64.8 | 65.71 | 0.99 | N | 30.4 | 108.2 |
| 14 | 64.2 | 65.16 | 0.99 | N | 28.6 | 95.9 |
| 15 | 63.4 | 64.07 | 0.99 | N | 29.8 | 104.1 |
| 16 | 81.8 | 82.78 | 0.99 | N | 37.4 | 156.2 |
| 17 | 81.2 | 82.18 | 0.99 | N | 36.8 | 152.1 |
| 18 | 78.8 | 79.55 | 0.99 | N | 35.4 | 142.5 |
| 19 | 79.4 | 80.15 | 0.99 | N | 37.2 | 154.8 |
| 20 | 81.6 | 82.50 | 0.99 | N | 36.4 | 149.3 |
| 21 | 80.2 | 81.89 | 0.98 | N | 34.8 | 138.4 |
| 22 | 78.8 | 79.22 | 0.99 | N | 35.4 | 142.5 |
| 23 | 77.6 | 79.83 | 0.97 | N | 36.2 | 147.9 |
| 24 | 79.4 | 81.95 | 0.97 | N | 35.6 | 143.8 |
| 25 | 79.2 | 81.32 | 0.97 | N | 34.8 | 138.4 |
| 26 | 76.4 | 78.57 | 0.97 | N | 37.2 | 154.8 |
| 27 | 78.8 | 79.20 | 0.99 | N | 36.6 | 150.7 |
| 28 | 57.2 | 58.23 | 0.98 | N | 22.6 | 54.8 |
| 29 | 55.8 | 56.77 | 0.98 | N | 21.8 | 49.3 |
| 30 | 49.2 | 50.39 | 0.98 | N | 23.2 | 58.9 |
| 31 | 50.4 | 51.85 | 0.97 | N | 22.6 | 54.8 |
| 32 | 62.4 | | | | 26.8 | 83.6 |
| 33 | 61.8 | | | | 25.8 | 76.7 |
| 34 | 60.6 | | | | 27.2 | 86.3 |
| 35 | 8.8 | | | | 24.6 | 68.5 |
| 36 | 54.2 | | | | 19.8 | 35.6 |
| 37 | 52.6 | | | | 20.6 | 41.1 |
| 38 | 45.6 | | | | 18.8 | 28.8 |
| 39 | 47.2 | | | | 17.8 | 21.9 |
| 40 | 0 | | | | 14.6 | 0.0 |

All innovative synergistic mixtures (sr. no. 1 to 12) shows synergism in efficacy against early shoot borer control and provides excellent residual control (duration of control) i.e. 97.8 to 100% control at 90 DAP (days after planting), whereas all prior art treatments (sr. no. 13 to 31) provides 49.2 to 81.8% control.

The number of productive shoots are much higher in in innovative synergistic mixtures treatment (sr. no. 1 to 12) i.e. 44 to 47.8 per mrl (meter row length) compared to all prior art treatments (sr. no. 13 to 31) i.e. 21.8 to 37.2 per mrl in. The number of productive tillers were at least 200% higher (over untreated check) in innovative synergistic mixtures treatments (sr. no. 1 to 12).

Conclusion:
1. Synergism was observed in innovative mixtures/combinations (sr. no. 1 to 12)
2. The innovative synergistic combinations (sr. no. 1 to 12) provides better control of ESB (early shoot borer), higher % control and longer duration which ultimately helps the farmers in reducing the number of sprays and thereby reducing the loading of active ingredients in the crop ecosystem.
3. The innovative synergistic combinations (sr. no. 1 to 12) produces higher number of productive shoots, which directly contributes to the higher cane yields.

### Example 15

Experiment 6: Control of Okra Jassid, Amrasca biguttula biguttula
Crop & Variety: Okra, JK-115
Location: Anand, Gujarat
Treatments: 40
Plot size: 20 sq.m
Spacing: 100 cm×25 cm
Time of Application: At moderate infestation of jassid i.e. 10 to 20 insects per leaf
Method of Application: Foliar spray with knapsack sprayer
Water volume: 500 liter/hectare
Agronomic Practices: Fertilizer, irrigation, inter culturing, earthing up and weeding done as per the crop requirement.

Observation Methods:
% Jassid control:

Count the number of insects per leaf and observe 3 leaves per plant. Record the observations from 10 plants per plot at 3, 7, 10 and 14 days after application.

$$\% Insect Control = 100 - \frac{Number of live insects in treated plot}{Number of live insects in untreated plot} \times 100$$

% Jassid control data used to check the synergism by applying Colby's formula.

Fruit Count:

Count the number of fruits per plants in 1 meter row length. Calculate the % increase in fruit count over untreated control by formula given below.

$$\% increase over untreated control = 100 \times \frac{average number of fruits in treatment}{average number of fruits in untreated control} - 100$$

TABLE 11
Treatment details for field bio efficacy against
okra jassid, Amrasca biguttula biguttula

| | Treatment details with use rate (ml or g per Hectare) | | |
|---|---|---|---|
| | | Compound B | |
| | | Gibberellic | |
| Sr. | | acid 0.001% L, | |
| No. | Compound A | 500 ml | Compound C |
| 1 | Cyclaniliprole 5% SL, 200 ml | Compound B | Tolfenpyrad 15% EC, 500 ml |
| 2 | Cyclaniliprole 5% SL, 200 ml | Compound B | Flonicamid 50% WG, 100 g |
| 3 | Cyclaniliprole 5% SL, 200 ml | Compound B | Afidopyropen 5% DC, 500 ml |
| 4 | Cyclaniliprole 5% SL, 200 ml | Compound B | Diafenthiuron 50% WP, 400 g |
| 5 | Broflanilide 30% SC, 40 ml | Compound B | Tolfenpyrad 15% EC, 500 ml |
| 6 | Broflanilide 30% SC, 40 ml | Compound B | Flonicamid 50% WG, 100 g |
| 7 | Broflanilide 30% SC, 40 ml | Compound B | Afidopyropen 5% DC, 500 ml |
| 8 | Broflanilide 30% SC, 40 ml | Compound B | Diafenthiuron 50% WP, 400 g |
| 9 | Tetraniliprole 20% SC, 100 ml | Compound B | Tolfenpyrad 15% EC, 500 ml |
| 10 | Tetraniliprole 20% SC, 100 ml | Compound B | Flonicamid 50% WG, 100 g |
| 11 | Tetraniliprole 20% SC, 100 ml | Compound B | Afidopyropen 5% DC, 500 ml |
| 12 | Tetraniliprole 20% SC, 100 ml | Compound B | Diafenthiuron 50% WP, 400 g |
| 13 | Cyclaniliprole 5% SL, 200 ml | Compound B | |
| 14 | Broflanilide 30% SC, 40 ml | Compound B | |
| 15 | Tetraniliprole 20% SC, 100 ml | Compound B | |
| 16 | Cyclaniliprole 5% SL, 200 ml | | Tolfenpyrad 15% EC, 500 ml |
| 17 | Cyclaniliprole 5% SL, 200 ml | | Flonicamid 50% WG, 100 g |
| 18 | Cyclaniliprole 5% SL, 200 ml | | Afidopyropen 5% DC, 500 ml |
| 19 | Cyclaniliprole 5% SL, 200 ml | | Diafenthiuron 50% WP, 400 g |
| 20 | Broflanilide 30% SC, 40 ml | | Tolfenpyrad 15% EC, 500 ml |
| 21 | Broflanilide 30% SC, 40 ml | | Flonicamid 50% WG, 100 g |
| 22 | Broflanilide 30% SC, 40 ml | | Afidopyropen 5% DC, 500 ml |
| 23 | Broflanilide 30% SC, 40 ml | | Diafenthiuron 50% WP, 400 g |
| 24 | Tetraniliprole 20% SC, 100 ml | | Tolfenpyrad 15% EC, 500 ml |
| 25 | Tetraniliprole 20% SC, 100 ml | | Flonicamid 50% WG, 100 g |
| 26 | Tetraniliprole 20% SC, 100 ml | | Afidopyropen 5% DC, 500 ml |
| 27 | Tetraniliprole 20% SC, 100 ml | | Diafenthiuron 50% WP, 400 g |
| 28 | | Compound B | Tolfenpyrad 15% EC, 500 ml |
| 29 | | Compound B | Flonicamid 50% WG, 100 g |
| 30 | | Compound B | Afidopyropen 5% DC, 500 ml |
| 31 | | Compound B | Diafenthiuron 50% WP, 400 |
| 32 | Cyclaniliprole 5% SL, 200 ml | | |
| 33 | Broflanilide 30% SC, 40 ml | | |
| 34 | Tetraniliprole 20% SC, 100 ml | | |
| 35 | | Compound B | |
| 36 | | | Tolfenpyrad 15% EC, 500 ml |
| 37 | | | Flonicamid 50% WG, 100 g |
| 38 | | | Afidopyropen 5% DC, 500 ml |
| 39 | | | Diafenthiuron 50% WP, 400 g |
| 40 | UTC (Untreated Check) | | |

Treatment composition from Sr. No. 13 to 31 are prior art.
SL—Soluble liquid, L—Liquid, SC—Suspension concentrate, OD—Oil dispersion, EC—Emulsifiable concentrate, WG—Wettable granule, DC—Dispersion concentrate, WP—Wettable powder.

TABLE 12
Synergistic bio efficacy against okra jassid, Amrasca biguttula biguttula

| | % Jassid control | | | | Number of | % Increase in |
|---|---|---|---|---|---|---|
| Sr. | Observed | Calculated | Ratio | Synergism | fruits per | fruits over |
| No. | Value | Value | O/E | (Y/N) | plants in mrl | Untreated check |
| 1 | 96.8 | 87.27 | 1.11 | Y | 38.4 | 204.8 |
| 2 | 97.8 | 87.91 | 1.11 | Y | 35.6 | 182.5 |
| 3 | 99.2 | 88.62 | 1.12 | Y | 37.2 | 195.2 |
| 4 | 98.4 | 86.11 | 1.14 | Y | 35.6 | 182.5 |
| 5 | 99.2 | 87.77 | 1.13 | Y | 37.4 | 196.8 |
| 6 | 98.6 | 88.38 | 1.12 | Y | 38.2 | 203.2 |
| 7 | 99.4 | 89.06 | 1.12 | Y | 33.6 | 166.7 |
| 8 | 97.2 | 86.66 | 1.12 | Y | 35.2 | 179.4 |
| 9 | 96.4 | 85.85 | 1.12 | Y | 36.4 | 188.9 |
| 10 | 97.6 | 86.56 | 1.13 | Y | 37.8 | 200.0 |
| 11 | 97.4 | 87.35 | 1.12 | Y | 36.6 | 190.5 |
| 12 | 98.2 | 84.56 | 1.16 | Y | 36.2 | 187.3 |
| 13 | 65.8 | 67.85 | 0.97 | N | 23.8 | 88.9 |
| 14 | 67.2 | 69.11 | 0.97 | N | 22.6 | 79.4 |
| 15 | 60.2 | 64.26 | 0.94 | N | 24.2 | 92.1 |
| 16 | 80.2 | 85.82 | 0.93 | N | 28.2 | 123.8 |
| 17 | 78.8 | 86.54 | 0.91 | N | 27.4 | 117.5 |
| 18 | 79.2 | 87.33 | 0.91 | N | 26.7 | 111.9 |
| 19 | 80.2 | 84.53 | 0.95 | N | 28.2 | 123.8 |
| 20 | 77.8 | 86.38 | 0.90 | N | 28.0 | 122.2 |
| 21 | 76.8 | 87.07 | 0.88 | N | 27.4 | 117.5 |
| 22 | 77.2 | 87.82 | 0.88 | N | 26.6 | 111.1 |
| 23 | 79.2 | 85.14 | 0.93 | N | 27.8 | 120.6 |
| 24 | 74.2 | 84.24 | 0.88 | N | 27.2 | 115.9 |
| 25 | 79.4 | 85.04 | 0.93 | N | 26.6 | 111.1 |
| 26 | 78.8 | 85.91 | 0.92 | N | 26.4 | 109.5 |
| 27 | 77.6 | 82.81 | 0.94 | N | 25.8 | 104.8 |
| 28 | 60.2 | 64.44 | 0.93 | N | 18.2 | 44.4 |
| 29 | 59.8 | 66.24 | 0.90 | N | 17.6 | 39.7 |
| 30 | 58.8 | 68.21 | 0.86 | N | 18.4 | 46.0 |
| 31 | 52.4 | 61.21 | 0.86 | N | 17.4 | 38.1 |
| 32 | 64.2 | | | | 14.8 | 17.5 |
| 33 | 65.6 | | | | 15.0 | 19.0 |
| 34 | 60.2 | | | | 14.6 | 15.9 |
| 35 | 10.2 | | | | 15.2 | 20.6 |
| 36 | 60.4 | | | | 13.8 | 9.5 |
| 37 | 62.4 | | | | 13.6 | 7.9 |
| 38 | 64.6 | | | | 14.2 | 12.7 |
| 39 | 56.8 | | | | 13.8 | 9.5 |
| 40 | 0 | | | | 12.6 | 0.0 |

All innovative synergistic mixtures (sr. no. 1 to 12) shows synergism in efficacy against jassid control and provides excellent residual control (duration of control) i.e. 96.4 to 99.2% control at 7 days after application, where as all prior art treatments (sr. no. 13 to 31) provides 52.4 to 80.2% control on 7^{th} day.

The number of fruits are much higher in innovative synergistic mixtures treatment (sr. no. 1 to 12) i.e. 33.6 to 38.4 fruits per mrl (meter row length) compared to all prior art treatments (sr. no. 13 to 31) i.e. 17.4 to 28.3 fruits per mrl in. The number of fruits were at least 42.9% higher than prior art treatments and 166.7% higher than untreated control.

Conclusion:
1. Synergism was observed in innovative mixtures/combinations (sr. no. 1 to 12)
2. The innovative synergistic combinations (sr. no. 1 to 12) provides excellent control of Jassid, i.e. % control is higher and provides longer duration which ultimately helps the farmers in reducing the number of sprays and thereby reducing the loading of active ingredients in the crop ecosystem.
3. The innovative synergistic combinations (sr. no. 1 to 12) produces higher number of okra fruits which helps the farmer to earn more profit.

### Example 16

Experiment 7: Control of Cotton Sucking Pests
Crop & Variety: Cotton, Local Bt II
Location: Karjan, Vadodara, Gujarat
Treatments: 40
Time of Application: At moderate infestation (Sucking pests above ETL level)
Method of Application: Foliar spray with knapsack sprayer
Water volume: 500 liter/hectare
Agronomic Practices: Fertilizer, irrigation, inter culturing, earthing up and weeding done as per the crop requirement.

Observation Methods:

% Whitefly control:

Count the number of insects per leaf and observe 3 leaves per plant. Record the observations from 10 plants per plot at 5^{th} days after application.

$$\% Insect Control = 100 - \frac{Number of live insects in treated plot}{Number of live insects in untreated plot} \times 100$$

% whitefly control data used to check the synergism by applying Colby's formula given above.
% Thrips control-calculated as same way as whitefly.

TABLE 13
Treatment details for field bio efficacy against cotton sucking pests

| | Treatment details with application Rate (ml or g per Hectare) | | | | | |
|---|---|---|---|---|---|---|
| | Compound A- | Compound B- | | | | |
| Sr. | Cyantraniliprole | Gibberellic | | Application (ml/h) | | |
| No. | 10.26% OD, 350 ml | acid 0.001% L | Compound C | Compound A | Compound B | Compound C |
| 1 | Compound A | Compound B | Diafenthiuron | 350 | 500 | 300 |
| | | | 50% WP | | | |
| 2 | Compound A | Compound B | Pyriproxyfen | 350 | 500 | 500 |
| | | | 10% EC | | | |
| 3 | Compound A | Compound B | Flonicamid | 350 | 500 | 75 |
| | | | 50% WG | | | |
| 4 | Compound A | Compound B | Tolfenpyrad | 350 | 500 | 750 |
| | | | 10% EC | | | |
| 5 | Compound A | Compound B | Flupyradifuron | 350 | 500 | 625 |
| | | | 17.09% SL | | | |
| 6 | Compound A | Compound B | Spiromesifen | 350 | 500 | 300 |
| | | | 22.90% SC | | | |
| 7 | Compound A | Compound B | Spiropidion | 350 | 500 | 100 |
| | | | 20% SC | | | |
| 8 | Compound A | Compound B | Pyrifluquinazon | 350 | 500 | 50 |
| | | | 10% SC | | | |
| 9 | Compound A | Compound B | Dimpropyridaz | 350 | 500 | 100 |
| | | | 12% SC | | | |
| 10 | | Compound B | Diafenthiuron | | 500 | 300 |
| | | | 50% WP | | | |
| 11 | | Compound B | Pyriproxyfen | | 500 | 500 |
| | | | 10% EC | | | |
| 12 | | Compound B | Flonicamid | | 500 | 75 |
| | | | 50% WG | | | |
| 13 | | Compound B | Tolfenpyrad | | 500 | 750 |
| | | | 10% EC | | | |
| 14 | | Compound B | Flupyradifuron | | 500 | 625 |
| | | | 17.09% SL | | | |
| 15 | | Compound B | Spiromesifen | | 500 | 300 |
| | | | 22.90% SC | | | |
| 16 | | Compound B | Spiropidion | | 500 | 100 |
| | | | 20% SC | | | |
| 17 | | Compound B | Pyrifluquinazon | | 500 | 50 |
| | | | 10% SC | | | |
| 18 | | Compound B | Dimpropyridaz | | 500 | 100 |
| | | | 12% SC | | | |
| 19 | Compound A | | Diafenthiuron | 350 | | 300 |
| | | | 50% WP | | | |
| 20 | Compound A | | Pyriproxyfen | 350 | | 500 |
| | | | 10% EC | | | |
| 21 | Compound A | | Flonicamid | 350 | | 75 |
| | | | 50% WG | | | |
| 22 | Compound A | | Tolfenpyrad | 350 | | 750 |
| | | | 10% EC | | | |
| 23 | Compound A | | Flupyradifuron | 350 | | 625 |
| | | | 17.09% SL | | | |
| 24 | Compound A | | Spiromesifen | 350 | | 300 |
| | | | 22.90% SC | | | |
| 25 | Compound A | | Spiropidion | 350 | | 100 |
| | | | 20% SC | | | |
| 26 | Compound A | | Pyrifluquinazon | 350 | | 50 |
| | | | 10% SC | | | |
| 27 | Compound A | | Dimpropyridaz | 350 | | 100 |
| | | | 12% SC | | | |
| 28 | Compound A | Compound B | | 350 | 500 | |
| 29 | | | Diafenthiuron | | | 300 |
| | | | 50% WP | | | |
| 30 | | | Pyriproxyfen | | | 500 |
| | | | 10% EC | | | |
| 31 | | | Flonicamid | | | 75 |
| | | | 50% WG | | | |
| 32 | | | Tolfenpyrad | | | 750 |
| | | | 10% EC | | | |
| 33 | | | Flupyradifuron | | | 625 |
| | | | 17.09% SL | | | |
| 34 | | | Spiromesifen | | | 300 |
| | | | 22.90% SC | | | |
| 35 | | | Spiropidion | | | 100 |
| | | | 20% SC | | | |
| 36 | | | Pyrifluquinazon | | | 50 |
| | | | 10% SC | | | |
| 37 | | | Dimpropyridaz | | | 100 |
| | | | 12% SC | | | |
| 38 | | Compound B | | | 500 | |
| 39 | Compound A | | | 350 | | |
| 40 | UTC (Untreated | | | | | |
| | Check) | | | | | |

Treatment composition from Sr. No. 10 to 28 are prior art.

TABLE 14
Synergistic bio efficacy against cotton sucking pests
(whitefly, Bemisia tabaci & Thirps, Thrips tabaci)

| | % Whitefly control at 5 DAA | | | % Thrips control at 5 DAA | | | |
|---|---|---|---|---|---|---|---|
| | | | Colby/s | | | Colby/s | |
| Sr. | Obs. | Cal. | Ratio | Obs. | Cal. | Ratio | Synergism |
| No. | Value | Value | O/E | Value | Value | O/E | (Y/N) |
| 1 | 98.6 | 87.92 | 1.12 | 98.2 | 87.62 | 1.12 | Y |
| 2 | 97.4 | 87.06 | 1.12 | 97.6 | 87.09 | 1.12 | Y |
| 3 | 99.2 | 87.56 | 1.13 | 96.4 | 87.99 | 1.10 | Y |
| 4 | 97.4 | 87.63 | 1.11 | 96.4 | 87.69 | 1.10 | Y |
| 5 | 98.6 | 86.56 | 1.14 | 97.4 | 86.94 | 1.12 | Y |
| 6 | 97.2 | 87.06 | 1.12 | 98.4 | 87.46 | 1.13 | Y |
| 7 | 96.4 | 86.49 | 1.11 | 97.6 | 87.24 | 1.12 | Y |
| 8 | 97.2 | 86.78 | 1.12 | 96.6 | 87.54 | 1.10 | Y |
| 9 | 98.2 | 86.92 | 1.13 | 97.8 | 87.69 | 1.12 | Y |
| 10 | 67.8 | 69.65 | 0.97 | 69.4 | 70.09 | 0.99 | N |
| 11 | 66.6 | 67.49 | 0.99 | 66.8 | 68.81 | 0.97 | N |
| 12 | 68.4 | 68.75 | 0.99 | 69.4 | 71.00 | 0.98 | N |
| 13 | 67.6 | 68.93 | 0.98 | 69.2 | 70.27 | 0.98 | N |
| 14 | 65.2 | 66.24 | 0.98 | 67.4 | 68.44 | 0.98 | N |
| 15 | 66.8 | 67.49 | 0.99 | 68.2 | 69.72 | 0.98 | N |
| 16 | 65.4 | 66.06 | 0.99 | 68.8 | 69.17 | 0.99 | N |
| 17 | 66.4 | 66.77 | 0.99 | 68.8 | 69.90 | 0.98 | N |
| 18 | 66.4 | 67.13 | 0.99 | 69.2 | 70.27 | 0.98 | N |
| 19 | 84.8 | 86.55 | 0.98 | 84.8 | 86.42 | 0.98 | N |
| 20 | 83.4 | 85.59 | 0.97 | 83.4 | 85.84 | 0.97 | N |
| 21 | 85.2 | 86.15 | 0.99 | 85.2 | 86.83 | 0.98 | N |
| 22 | 84.4 | 86.23 | 0.98 | 84.4 | 86.50 | 0.98 | N |
| 23 | 83.8 | 85.04 | 0.99 | 83.8 | 85.68 | 0.98 | N |
| 24 | 84.6 | 85.59 | 0.99 | 85.4 | 86.26 | 0.99 | N |
| 25 | 83.2 | 84.96 | 0.98 | 84.8 | 86.01 | 0.99 | N |
| 26 | 84.4 | 85.27 | 0.99 | 85.2 | 86.34 | 0.99 | N |
| 27 | 82.6 | 85.43 | 0.97 | 83.2 | 86.50 | 0.96 | N |
| 28 | 60.4 | 64.26 | 0.94 | 60.4 | 62.24 | 0.97 | N |
| 29 | 66.2 | | | 67.2 | | | |
| 30 | 63.8 | | | 65.8 | | | |
| 31 | 65.2 | | | 68.2 | | | |
| 32 | 65.4 | | | 67.4 | | | |
| 33 | 62.4 | | | 65.4 | | | |
| 34 | 63.8 | | | 66.8 | | | |
| 35 | 62.2 | | | 66.2 | | | |
| 36 | 63.0 | | | 67.0 | | | |
| 37 | 63.4 | | | 67.4 | | | |
| 38 | 10.2 | | | 8.8 | | | |
| 39 | 60.2 | | | 58.6 | | | |
| 40 | 0.0 | | | 0.0 | | | |

All innovative synergistic mixtures (sr. no. 1 to 9) shows synergism in efficacy against whitefly and thrips control and also provides excellent residual control

Conclusion:
1. Synergism was observed in innovative mixtures/combinations (sr. no. 1 to 9)
2. The innovative synergistic combinations (sr. no. 1 to 9) provides excellent control of whitefly and thrips, also provides longer duration which ultimately helps the farmers in reducing the number of sprays and thereby reducing the loading of active ingredients in the crop ecosystem.
3. Other visual observations are excellent plant vigor, greening effect, leaves are green and tender, more number of flowers, square and boll formation observed after 3 weeks of application.

### Example 17

Experiment 8: Control of Tomato Fruit Borer, Tomato Whitefly and Healthy Fruits

Crop-Tomato, Pest-Fruit borer, Helicoverpa armigera & whitefly, Bemisia tabaci.

Application method-500 liter/ha with knapsack sprayer, applied when fruit borer larva and whitefly infestation observed. Observations recorded on 5^{th} days after application.

TABLE 15
Treatment details for bio efficacy against tomato fruit borer and whitefly

| Treatment | |
|---|---|
| number | Treatment details with application Rate (ml or g per hectare) |
| 1 | Isocyclaseram 10% DC-250 ml + Triacontanol 0.1% EW-250 |
| | ml/h + Methoxyfenozide 24% SC-500 ml/h |
| 2 | Isocyclaseram 10% DC-250 ml + Triacontanol 0.1% EW-250 ml/h + Emamectin |
| | benzoate 5% SG-200 g/h |
| 3 | Isocyclaseram 10% DC-250 ml + Triacontanol 0.1% EW-250 ml/h + Spinosad |
| | 45% SC-111.1 ml/h |
| 4 | Isocyclaseram 10% DC-250 ml + Triacontanol 0.1% EW-250 ml/h + Novaluron |
| | 10% EC-500 ml/h |
| 5 | Isocyclaseram 10% DC-250 ml + Triacontanol 0.1% EW-250 ml/h + |
| | Dichloromezotiaz 20% SC-125 ml/h |
| 6 | Isocyclaseram 10% DC-250 ml + Triacontanol 0.1% EW-250 ml/h |
| 7 | Isocyclaseram 10% DC-250 ml + Methoxyfenozide 24% SC-500 ml/h |
| 8 | Isocyclaseram 10% DC-250 ml + Emamectin benzoate 5% SG-200 g/h |
| 9 | Isocyclaseram 10% DC-250 ml + Spinosad 45% SC-111.1 ml/h |
| 10 | Isocyclaseram 10% DC-250 ml + Novaluron 10% EC-500 ml/h |
| 11 | Isocyclaseram 10% DC-250 ml + Dichloromezotiaz 20% SC-125 ml/h |
| 12 | Triacontanol 0.1% EW-250 ml/h + Methoxyfenozide 24% SC-500 ml/h |
| 13 | Triacontanol 0.1% EW-250 ml/h + Emamectin benzoate 5% SG-200 g/h |
| 14 | Triacontanol 0.1% EW-250 ml/h + Spinosad 45% SC-111.1 ml/h |
| 15 | Triacontanol 0.1% EW-250 ml/h + Novaluron 10% EC-500 ml/h |
| 16 | Triacontanol 0.1% EW-250 ml/h + Dichloromezotiaz 20% SC-125 ml/h |
| 17 | Isocyclaseram 10% DC-250 ml |
| 18 | Triacontanol 0.1% EW-250 ml/h |
| 19 | Methoxyfenozide 24% SC-500 ml/h |
| 20 | Emamectin benzoate 5% SG-200 g/h |
| 21 | Spinosad 45% SC-111.1 ml/h |
| 22 | Novaluron 10% EC-500 ml/h |
| 23 | Dichloromezotiaz 20% SC-125 ml/h |
| 24 | UTC (Untreated Check) |

Treatment number 1 to 5 are innovative tank mix combinations. Treatment number 6 to 16 are prior arts.

TABLE 16
Synergistic bioefficacy against tomato fruit borer and whitefly.

| | % Fruit borer larval control | | | % Whitefly control | | | | Average |
|---|---|---|---|---|---|---|---|---|
| | | | Colby/s | | | Colby/s | | number of |
| Treatment | Obs. | Cal. | Ratio | Obs. | Cal. | Ratio | Synergism | healthy fruits |
| number | Value | Value | O/E | Value | Value | O/E | (Y/N) | per plants |
| 1 | 100 | 86.28 | 1.16 | 86.4 | 72.38 | 1.19 | Y | 54.2 |
| 2 | 100 | 85.37 | 1.17 | 88.2 | 80.94 | 1.09 | Y | 50.6 |
| 3 | 100 | 90.34 | 1.11 | 85.2 | 77.49 | 1.10 | Y | 52.8 |
| 4 | 100 | 84.74 | 1.18 | 84.6 | 75.70 | 1.12 | Y | 51.4 |
| 5 | 100 | 86.28 | 1.16 | 82.6 | 78.82 | 1.05 | Y | 53.6 |
| 6 | 64.4 | 64.99 | 0.99 | 65.8 | 66.80 | 0.99 | N | 48.6 |
| 7 | 84.8 | 85.34 | 0.99 | 70.2 | 71.05 | 0.99 | N | 46.2 |
| 8 | 83.6 | 84.37 | 0.99 | 78.4 | 80.02 | 0.98 | N | 45.8 |
| 9 | 89 | 89.68 | 0.99 | 74.2 | 76.41 | 0.97 | N | 47.2 |
| 10 | 82.4 | 83.69 | 0.98 | 72.2 | 74.53 | 0.97 | N | 48.2 |
| 11 | 84.6 | 85.34 | 0.99 | 76.6 | 77.80 | 0.98 | N | 46.8 |
| 12 | 62.4 | 63.31 | 0.99 | 16.8 | 20.63 | 0.81 | N | 45.8 |
| 13 | 57.8 | 60.88 | 0.95 | 43.2 | 45.24 | 0.95 | N | 43.2 |
| 14 | 72.4 | 74.17 | 0.98 | 34.8 | 35.32 | 0.99 | N | 44.8 |
| 15 | 56.8 | 59.19 | 0.96 | 28.8 | 30.17 | 0.95 | N | 46.2 |
| 16 | 62.2 | 63.31 | 0.98 | 38.4 | 39.13 | 0.98 | N | 45.4 |
| 17 | 62.6 | | | 65.2 | | | | 39.8 |
| 18 | 6.4 | | | 4.6 | | | | 32.4 |
| 19 | 60.8 | | | 16.8 | | | | 35.8 |
| 20 | 58.2 | | | 42.6 | | | | 36.2 |
| 21 | 72.4 | | | 32.2 | | | | 37.4 |
| 22 | 56.4 | | | 26.8 | | | | 35.4 |
| 23 | 60.8 | | | 36.2 | | | | 36.6 |
| 24 | 0.0 | | | 0.0 | | | | 27.8 |

All innovative synergistic mixtures (sr. no. 1 to 5) shows synergism in efficacy against tomato fruit borer and whitefly and also produces higher number of healthy/marketable fruits in comparison with all prior art treatments. The visual observations shows excellent plant growth, phytotonic effect, dark green leaves, more number of flowers, branches and fruits per plant compared to prior art treatments.

### Example 18

Experiment 9: Control of Pigeonpea Pod Borer and Healthy Nods

Crop-Pigeonpea/Redgram, Pest-Pod borer, Helicoverpa armigera.

Application method-500 liter/ha with knapsack sprayer, applied when pod fruit borer larval infestation observed. Observations recorded on 5^{th} days after application.

TABLE 17
Treatment details for bioefficacy against pigeonpea pod borer

| Sr. | | | | Application Rate (ml or g per Hectare) | | |
|---|---|---|---|---|---|---|
| No. | Treatment Details | Compound B | Compound C | Compound A | Compound B | Compound C |
| 1 | Chlorantraniliprole | Compound B | Compound C | 100 | 500 | 500 |
| | 20% SC | | | | | |
| 2 | Cyantraniliprole | Compound B | Compound C | 200 | 500 | 500 |
| | 10% OD | | | | | |
| 3 | Tetraniliprole | Compound B | Compound C | 100 | 500 | 500 |
| | 20% SC | | | | | |
| 4 | Cyclaniliprole | Compound B | Compound C | 400 | 500 | 500 |
| | 5% SL | | | | | |
| 5 | Broflanilide | Compound B | Compound C | 75 | 500 | 500 |
| | 30% SC | | | | | |
| 6 | Chlorantraniliprole | Compound B | | 100 | 500 | |
| | 20% SC | | | | | |
| 7 | Cyantraniliprole | Compound B | | 200 | 500 | |
| | 10% OD | | | | | |
| 8 | Tetraniliprole | Compound B | | 100 | 500 | |
| | 20% SC | | | | | |
| 9 | Cyclaniliprole | Compound B | | 400 | 500 | |
| | 5% SL | | | | | |
| 10 | Broflanilide | Compound B | | 75 | 500 | |
| | 30% SC | | | | | |
| 11 | Chlorantraniliprole | | Compound C | 100 | | 500 |
| | 20% SC | | | | | |
| 12 | Cyantraniliprole | | Compound C | 200 | | 500 |
| | 10% OD | | | | | |
| 13 | Tetraniliprole | | Compound C | 100 | | 500 |
| | 20% SC | | | | | |
| 14 | Cyclaniliprole | | Compound C | 400 | | 500 |
| | 5% SL | | | | | |
| 15 | Broflanilide | | Compound C | 75 | | 500 |
| | 30% SC | | | | | |
| 16 | | Compound B | Compound C | | 500 | 500 |
| 17 | Chlorantraniliprole | | | 100 | | |
| | 20% SC | | | | | |
| 18 | Cyantraniliprole | | | 200 | | |
| | 10% OD | | | | | |
| 19 | Tetraniliprole | | | 100 | | |
| | 20% SC | | | | | |
| 20 | Cyclaniliprole | | | 400 | | |
| | 5% SL | | | | | |
| 21 | Broflanilide | | | 75 | | |
| | 30% SC | | | | | |
| 22 | | Compound B | | | 500 | |
| 23 | | | Compound C | | | 500 |
| 24 | UTC (Untreated | | | | | |
| | Check) | | | | | |

Compound B-Gibberellic acid 0.001% L-500 ml/h, Compound C-Lambda cyhalothrin 5% EC-500 ml/h
Treatment composition from Sr. No. 6 to 16 are prior art. Chlorantraniliprole 20% SC (18.5% w/w) Cyantraniliprole 10% OD (10.26% w/w), Cyclaniliprole 5% SL (4.55% w/w).

TABLE 18
Synergistic bioefficacy against pigeonpea pod borer

| | % Pod borer control control | | | | Number of |
|---|---|---|---|---|---|
| Sr. | Observed | Calculated | Ratio | Synergism | Healthy |
| No. | Value | Value | O/E | (Y/N) | Pods/plant |
| 1 | 98.2 | 87.01 | 1.13 | Y | 136.8 |
| 2 | 97.6 | 85.31 | 1.14 | Y | 132.4 |
| 3 | 99.4 | 85.97 | 1.16 | Y | 138.2 |
| 4 | 97.4 | 85.50 | 1.14 | Y | 137.4 |
| 5 | 95.6 | 86.53 | 1.10 | Y | 135.8 |
| 6 | 73.2 | 74.72 | 0.98 | N | 98.2 |
| 7 | 70.4 | 71.42 | 0.99 | N | 93.6 |
| 8 | 71.6 | 72.70 | 0.98 | N | 90.2 |
| 9 | 70.2 | 71.79 | 0.98 | N | 96.2 |
| 10 | 72.4 | 73.80 | 0.98 | N | 94.6 |
| 11 | 84.6 | 85.81 | 0.99 | N | 96.2 |
| 12 | 82.4 | 83.96 | 0.98 | N | 96.2 |
| 13 | 82.4 | 84.68 | 0.97 | N | 94.2 |
| 14 | 81.6 | 84.17 | 0.97 | N | 96.8 |
| 15 | 83.8 | 85.30 | 0.98 | N | 97.6 |
| 16 | 50.4 | 52.92 | 0.95 | N | 70.00 |
| 17 | 72.4 | | | | 98.8 |
| 18 | 68.8 | | | | 92.6 |
| 19 | 70.2 | | | | 89.6 |
| 20 | 69.2 | | | | 96.4 |
| 21 | 71.4 | | | | 97.4 |
| 22 | 8.4 | | | | 20.8 |
| 23 | 48.6 | | | | 64.8 |
| 24 | 0.0 | | | | |

All innovative synergistic mixtures (sr. no. 1 to 5) shows synergism in efficacy against pigeonpea pod borer and produces higher number of healthy/marketable pods in comparison with all prior art treatments (sr. no. 6 to 16).

### VISUAL OBSERVATIONS ON ALL BIO-EFFICACY TRIALS

All innovative synergistic ready mixtures and tank mixtures shows/produces many unrecordable visual effects like, excellent plant growth and vigour, bigger leaf blade and size, more number of leaves, tillers, shoots, branches, more number of flowers and fruits, more number of secondary and tertiary roots and rootlets, excellent fruit color and quality observed during field trials in the crops like paddy/rice, sugarcane, cabbage, okra, brinjal, tomato and pigeon pea/red gram.

We claim:

1) A synergistic insecticidal composition comprising:
a. at least one insecticide selected from class of diamide, metadiamides, isoxazolines in an amount of 0.1 to 40% by weight or mixture thereof;
b. at least one plant growth regulator in an amount of 0.001 to 20% by weight or mixture thereof;
c. at least one more insecticide from various groups in an amount of 0.01 to 40% by weight or mixture thereof;
d. inactive formulation excipients.

2) The synergistic insecticidal composition as claimed in claim 1 wherein, the synergistic insecticidal composition comprising:
a. at least one insecticide from class of diamide selected from chlorantraniliprole, cyantraniliprole, cyclaniliprole, cyhalodiamide, cyproflanilide, flubendiamide, tetrachlorantraniliprole, tyclopyrazoflor, tetraniliprole; from class of metadiamides is broflanilide; or from class of Isoxazoline selected from Fluxametamide, Isocycloseram; or mixture thereof;
b. at least one plant growth regulator selected from the class of Anti-auxins, Auxin, Cytokinins, Defoliants, Ethylene modulators, Ethylene releasers, Gibberellins, Growth Inhibitors, Morphactins, Growth retardants, Growth stimulants, Unclassified plant growth regulators;
c. at least one insecticidal compound selected from the group of an Acetylcholine esterase inhibitors from the class of carbamates, Acetylcholine esterase inhibitors from the class of organophosphates, GABA-gated chloride channel antagonists from cyclodiene organochlorine compounds and Phenylpyrazole (fiproles), Sodium channel modulators from the class of pyrethroids, Nicotinic acteylcholine receptor agonists from the class of neonicotinoids, Sulfoximines, Butenolides, Mesoionics, allosteric nicotinic acteylcholine receptor activators from the class of spinosyns, chloride channel activators from the class of mectins, Juvenile hormone mimics, Non-specific multi-site inhibitors, Chordotonal organs TRPV channel modulators, Mite growth inhibitors affecting CHS1, Microbial disruptors of insect midgut membrane, Inhibitors of mitochondrial ATP synthase, Uncouplers of oxidative phosphorylation, Inhibitors of the chitin biosynthesis affecting CHS1, Inhibitors of the chitin biosynthesis type 1, Moulting disruptors, Ecdyson receptor agonists, Octopamin receptor agonists, Mitochondrial complex III electron transport inhibitors, Mitochondrial complex I electron transport inhibitors, Voltage-dependent sodium channel blockers from class of oxadiazines and semicarbazones, Inhibitors of the lipid synthesis, Inhibitors of acetyl CoA carboxylase, Mitochondrial complex II electron transport inhibitors, Baculoviruses, Compounds of unknown or uncertain mode of action; and one or more customary formulation adjuvants; shows synergistic activity.

3) The synergistic insecticidal composition as claimed in claim 1 wherein the insecticide
from acetylcholine esterase inhibitors from the class of carbamates is selected from aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, xylylcarb, and triazamate;
from acetylcholine esterase inhibitors from the class of organophosphate is selected from acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion;
from GABA-gated chloride channel antagonists from cyclodiene organochlorine class of compound is endosulfan;
from GABA-gated chloride channel antagonists from Phenylpyrazole (fiproles) class of compound selected from ethiprole, fipronil, nicofluprole, flufiprole, pyrafluprole, or pyriprole;
from sodium channel modulators from the class of pyrethroids is selected from acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, meperfluthrin, metofluthrin, momfluorothrin, permethrin, phenothrin, prallethrin, profluthrin, pyrethrin (pyrethrum), resmethrin, silafluofen, tefluthrin, tetramethylfluthrin, tetramethrin, tralomethrin, transfluthrin;
from nicotinic acteylcholine receptor agonists from the class of neonicotinoids is selected from acetamiprid, dichloromezotiaz, chlothianidin, dinotefuran, imidacloprid, nitenpyram, thiacloprid, thiamethoxam, sulfoxaflor, flupyradifurone, flupyrimin or triflumezopyrim;
from allosteric nicotinic acteylcholine receptor activators from the class of spinosyns is selected from spinosad, spinetoram;
from chloride channel activators from the class of mectins is selected from abamectin, emamectin benzoate, ivermectin, lepimectin or milbemectin;
from juvenile hormone mimics is selected from hydroprene, kinoprene, methoprene, fenoxycarb, pyriproxyfen;
from non-specific multi-site inhibitors is selected from methyl bromide and other alkyl halides, chloropicrin, sulfuryl fluoride, borax or tartar emetic, dazomet, metam;
from chordotonal organ TRPV channel modulators with selective homopteran feeding blockers is selected from the pymetrozine, pyrifluquinazon, afidopyropen, flonicamid;
from selective homopteran feeding blockers from the class of pyropenes is afidopyropen;
from mite growth inhibitors is selected from clofentezine, hexythiazox, diflovidazin or etoxazole;
from microbial disruptors of insect midgut membrane may be selected from Bacillus thuringiensis and insecticidal proteins they produce;
from class of inhibitors of mitochondrial ATP synthase may be selected from diafenthiuron, azocyclotin, cyhexatin, fenbutatin oxide, propargite, or tetradifon;
from class of uncouplers of oxidative phosphorylation is selected from chlorfenapyr, DNOC, or sulfluramid;
from class of inhibitors of the chitin biosynthesis affecting CHS1 is selected from Benzoylureas-bistrifluron, chlorfluazuron, diflubenzuron, flucycloxuron, flufenoxuron, hexaflumuron, lufenuron, novaluron, noviflumuron, teflubenzuron, triflumuron;
from class of inhibitors of the chitin biosynthesis type 1 is buprofezin;
from class of moulting disruptors is cyromazine;
from class of Ecdyson receptor agonists is selected from diacylhydrazines-methoxyfenozide, tebufenozide, halofenozide, fufenozide or chromafenozide;
from class of Octopamin receptor agonists is amitraz;
from class of Mitochondrial complex III electron transport inhibitors is selected from hydramethylnon, acequinocyl, flometoquin, fluacrypyrim, pyriminostrobin or bifenazate;
from class of Mitochondrial complex I electron transport inhibitors is selected from fenazaquin, fenpyroximate, pyrimidifen, pyridaben, tebufenpyrad, tolfenpyrad, flufenerim, or rotenone;
from class of voltage-dependent sodium channel blockers is selected from indoxacarb, metaflumizone;
insecticide from class of inhibitors of the lipid synthesis, inhibitors of acetyl CoA carboxylase selected from spirodiclofen, spiromesifen, spirotetramat or spiropidion;
from class of mitochondrial complex II electron transport inhibitors is selected from cyenopyrafen, cyflumetofen or pyflubumide;
insecticede from class of chlorodontal organ modulators is flonicamid;
insecticidal compounds of unknown or uncertain mode of action is selected from azadirechtin, benzoximate, benzpyrimoxan, pyridalyl, oxazosulfyl, dimpropyridaz, tyclopyrazoflor, fluhexafon, Cyetpyrafen, flupentiofenox, acynonapyr, Cyclobutrifluram, fluazaindolizine or tioxazafen.

4) The synergistic insecticidal composition as claimed in claim 1 wherein, the plant growth regulator
from the class of anti-auxins is selected from clofibric acid, 2,3,5-tri-iodobenzoic acid;
from the class of auxin is selected from 4-CPA, 2,4-D, 2,4-DB, 2,4-DEP, dichlorprop, fenoprop, IAA, IBA, naphthalene acetamide, a-naphthalene acetic acid, 1-naphthol, naphthoxy acetic acid, potassium naphthenate, sodium naphthenate, 2,4,5-T;
from the class of cytokinin is selected from adenine, adenine hemisulfate di-hydrate, 2iP, 6-benzylaminopurine, N-Oxide-2,6-lutidine, 2,6-dimethylpyridine, kinetin, zeatin;
from the class of defoliants is selected from calcium cyanamide, dimethipin, endothal, merphos, metoxuron, pentachlorophenol, thidiazuron, tribufos, tributyl phosphorotrithioate;
from the class of ethylene modulators is selected from aviglycine, 1-MCP, prohexadione, prohexadione calcium, trinexapac, trinexapac-ethyl, aminoethoxyvinylglycine (AVG);
from the class of ethylene releasers is selected from ACC, etacelasil, ethephon, glyoxime;
from the class of gibberellins is selected from gibberellin, gibberellic acid, GA3;
from the class of Growth Inhibitors is selected from abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, mepiquat chloride, mepiquat pentaborate, piproctanyl, prohydrojasmon, propham, 2,3,5-tri-iodobenzoic acid;
from the class of Morphactins is selected from chlorfluren, chlorflurenol, dichlorflurenol, flurenol;
from the class of Growth retardants is selected from chlormequat, chlormequat chloride, daminozide, flurprimidol, mefluidide, paclobutrazol, tetcyclacis, uniconazole, metconazole;
from the class of Growth stimulants is selected from forchlorfenuron, hymexazol;
from the class of Unclassified plant growth regulators is selected from amidochlor, benzofluor, buminafos, carvone, choline chloride, ciobutide, clofencet, cloxyfonac, cyanamide, cyclanilide, cycloheximide, cyprosulfamide, epocholeone, ethychlozate, ethylene, fenridazon, fluprimidol, fluthiacet, heptopargil, holosulf, inabenfide, karetazan, lead arsenate, methasulfocarb, pydanon, sintofen, triapenthenol, Nitrophenolate (sodium para-nitrophenolate, ortho-nitrophenoate, sodium-5-nitroguaiacolate), triacontanol, alpha naphthyl acetic acid, 6-benzyladenine.

5) The synergistic insecticidal composition as claimed in claim 1 wherein,
inactive excipients comprises:
a. wetting agent in an amount of 2 to 4% by weight;
b. dispersing agent in an amount of 1 to 5% by weight;
c. suspending agent in an amount of 0.2 to 1.0% by weight;
d. antifoaming agent in an amount of 0.1 to 1.5% by weight;
e. preservative in an amount of 0.1 to 0.5% by weight;
f. anti-freezing agent in an amount of 2 to 6% by weight;
g. thickening agent in an amount of 0.1 to 1.0% by weight;
h. disintegrating agent in an amount of 0.1 to 1.0% by weight;
i. colorant in an amount of 0.1 to 1.0% by weight;
j. solvents in an amount of 2 to 5% by weight;
k. carrier in an amount of 30 to 95% by weight.

6) The synergistic insecticidal composition as claimed in claim 1 wherein, the formulation for the said composition is selected from Capsule suspension (CS), Dispersible concentrate (DC), Powder for dry seed treatment (DS), Emulsifiable concentrate (EC), Emulsion, water in oil (EO), Emulsion for seed treatment (ES), Emulsion, oil in water (EW), Flowable suspension/concentrate for seed treatment (FS), Granule/soil applied (GR), Controlled (Slow or Fast) release granules (CR), Solution for seed treatment (LS), Micro-emulsion (ME), Oil dispersion (OD), Oil miscible flowable concentrate (oil miscible suspension (OF), Oil miscible liquid (OL), Suspension concentrate (flowable concentrate) (SC), Suspo-emulsion (SE), Water soluble granule (SG), Soluble concentrate (SL), Water soluble powder (SP), Water dispersible granule (WG or WDG), Wettable powder (WP), Water dispersible powder for slurry treatment (WS), A mixed formulation of CS and SC (ZC), A mixed formulation of CS and SE (ZE), A mixed formulation of CS and EW (ZW).

7) The synergistic insecticidal composition as claimed in claim 6 wherein, the preferred composition and formulation thereof comprises:
a) Granule (GR) formulation or slow release granule (CR) formulation of Chlorantraniliprole 0.3%+Triacontanol 0.125%+Clothianidin 1.0%;
b) Granule (GR) formulation or slow release granule (CR) formulation of Cyantraniliprole 0.6%+Triacontanol 0.125%+Clothianidin 1.0%;
c) Granule (GR) formulation or slow release granule (CR) formulation of Cyantraniliprole 0.6%+Triacontanol 0.125%+Thiamethoxam 1.0%;
d) Granule (GR) formulation or slow release granule (CR) formulation of Tetraniliprole 0.3%+Triacontanol 0.125%+Thiamethoxam 1.0%;
e) Granule (GR) formulation or slow release granule (CR) formulation of Chlorantraniliprole 0.3%+Paclobutrazol 0.3%+Thiamethoxam 1.0%;
f) Granule (GR) formulation or slow release granule (CR) formulation of Chlorantraniliprole 0.3%+Triacontanol 0.125%+Thiamethoxam 1%;
g) Granule (GR) formulation of Chlorantraniliprole 0.3%+Triacontanol 0.125%+Triflumezopyrim 0.25%;
h) Granule (GR) formulation or slow release granule (CR) formulation of Chlorantraniliprole 0.3%+Triacontanol 0.125%+Flupyrimin 0.25%;
i) Granule (GR) formulation or slow release granule (CR) formulation of Cyclaniliprole 0.25%+Triacontanol 0.125%+Fipronil 0.5%;
j) Granule (GR) formulation or slow release granule (CR) formulation of Cyclaniliprole 0.25%+Triacontanol 0.125%+Clothianidin 0.5%;
k) Granule (GR) formulation or slow release granule (CR) formulation of Cyclaniliprole 0.25%+Triacontanol 0.125%+Triflumezopyrim 0.25%;
l) Water dispersible granule (WG) formulation of Chlorantraniliprole 7.5%+Gibberellic acid 0.005%+Pymetrozine 37.5%;
m) Water dispersible granule (WG) formulation of Chlorantraniliprole 7.5%+Gibberellic acid 0.005%+Pymetrozine 37.5%;
n) Water dispersible granule (WG) formulation of Cyantraniliprole 7.5%+Gibberellic acid 0.005%+Pymetrozine 37.5%;
o) Water dispersible granule (WG) formulation of Cyclaniliprole 7.5%+Gibberellic acid 0.005%+Pymetrozine 37.5%;
p) Water dispersible granule (WG) formulation of Tetraniliprole 7.5%+Gibberellic acid 0.005%+Pymetrozine 37.5%;
q) Water dispersible granule (WG) formulation of Flubendiamide 7.5%+Gibberellic acid 0.005%+Pymetrozine 37.5%;
r) Water dispersible granule (WG) formulation of Cyhalodiamide 7.5%+Gibberellic acid 0.005%+Pymetrozine 37.5%;
s) Suspension concentrate (SC) formulation of Chlorantraniliprole 5%+Gibberellic acid 0.004%+Methoxyfenozide 20%;
t) Suspension concentrate (SC) formulation of Broflanilide 5%+Gibberellic acid 0.004%+Methoxyfenozide 20%;
u) Suspension concentrate (SC) formulation of Cyantraniliprole 10%+Gibberellic acid 0.008%+Emamectin Benzoate 3%.

8) The synergistic insecticidal composition as claimed in claim 6 wherein, the preferred combination for the composition comprises:
i. Chlorantraniliprole+Gibberellic acid+Methoxyfenozide;
ii. Cyantraniliprole+Gibberellic acid+Methoxyfenozide;
iii. Cyclaniliprole+Gibberellic acid+Methoxyfenozide;
iv. Tetraniliprole+Gibberellic acid+Methoxyfenozide;
v. Flubendiamide+Gibberellic acid+Methoxyfenozide;
vi. Broflanilide+Gibberellic acid+Methoxyfenozide;
vii. Chlorantraniliprole+Gibberellic acid+Emamectin benzoate;
viii. Cyantraniliprole+Gibberellic acid+Emamectin benzoate;
ix. Cyclaniliprole+Gibberellic acid+Emamectin benzoate;
x. Tetraniliprole+Gibberellic acid+Emamectin benzoate;
xi. Flubendiamide+Gibberellic acid+Emamectin benzoate;
xii. Broflanilide+Gibberellic acid+Emamectin benzoate;
xiii. Chlorantraniliprole+Gibberellic acid+Novaluron;
xiv. Chlorantraniliprole+Gibberellic acid+Dichloromezotiaz;
xv. Chlorantraniliprole+Gibberellic acid+Indoxacarb;
xvi. Chlorantraniliprole+Gibberellic acid+Spinetoram;
xvii. Tetraniliprole+Gibberellic acid+Novaluron;
xviii. Tetraniliprole+Gibberellic acid+Dichloromezotiaz;
xix. Tetraniliprole+Gibberellic acid+Indoxacarb;
xx. Tetraniliprole+Gibberellic acid+Spinetoram;
xxi. Broflanilide+Gibberellic acid+Novaluron;
xxii. Broflanilide+Gibberellic acid+Dichloromezotiaz;
xxiii. Broflanilide+Gibberellic acid+Indoxacarb;
xxiv. Broflanilide+Gibberellic acid+Spinetoram;
xxv. Broflanilide+Gibberellic acid+Tolfenpyrad;
xxvi. Broflanilide+Gibberellic acid+Flonicamid;
xxvii. Broflanilide+Gibberellic acid+Afidopyropen;
xxviii. Broflanilide+Gibberellic acid+Diafenthiuron;
xxix. Cyantraniliprole+Gibberellic acid+Diafenthiuron;
xxx. Cyantraniliprole+Gibberellic acid+Pyriproxyfen;
xxxi. Cyantraniliprole+Gibberellic acid+Flonicamid;
xxxii. Cyantraniliprole+Gibberellic acid+Tolfenpyrad;
xxxiii. Cyantraniliprole+Gibberellic acid+Spiromesifen;
xxxiv. Cyantraniliprole+Gibberellic acid+Spiropidion;
xxxv. Cyantraniliprole+Gibberellic acid+Pyrifluquinazon;
xxxvi. Cyantraniliprole+Gibberellic acid+Dimpropyridaz.

9) The synergistic insecticidal composition as claimed in claim 7 wherein, the granule (GR) formulation comprises:
a) Chlorantraniliprole;
b) Triacontanol;
c) Clothianidin;
d) Wetting agent;
e) Dispersing agent I;
f) Dispersing agent II;
g) Colorants;
h) Solvent;
i) Carrier.

10) The synergistic insecticidal composition as claimed in claim 1 wherein, the Suspension Concentrate (SC) formulation comprises:
a) Chlorantraniliprole;
b) Gibberellic acid;
c) Methoxyfenozide;
d) Wetting agent;
e) Dispersing agent I;
f) Dispersing agent II;
g) Suspending agent;
h) Antifoaming agent;
i) Preservative;
j) Antifreezing agent;
k) Thickener;
l) Diluent Water.

11) The synergistic insecticidal composition as claimed in claim 1 wherein, the water dispersible granules (WG) formulation comprises:
a) Chlorantraniliprole;
b) Gibberellic acid;
c) Pymetrozine;
d) Wetting agent;
e) Dispersing agent I;
f) Dispersing agent II;
g) Disintegrating agent;
h) Antifoaming agent;
i) Carrier.

12) The synergistic insecticidal composition as claimed in claim 5 wherein, wetting agent
for granule (GR) formulation is selected from Mono C2-6alkyl ether of a polyC2-4alkylene oxide block copolymer, condensation product of castor oil and polyC2-4alkylene oxide, alkoxylated castor oil is available under the trade name Agnique CSO-36, a mono- or di-ester of a C12-24fatty acid and polyC2-4alkylene oxide, carboxylates, sulphates, sulphonates, alcohol ethoxylates, alkyl phenol ethoxylates, fatty acid ethoxylates, sorbitan esters, ethoxylated fats or oils, amine ethoxylates, phosphate esters, ethylene oxide-propylene oxide copolymers, fluorocarbons, alkyd-polyethylene glycol resin, polyalkylene glycol ether, apolyalkoxylated nonyl phenyl, alkoxylated primary alcohol, ethoxylated distyrylphenol, ethoxylated distyrylphenol sulphate, ethoxylated tristyrylphenol phosphate, tristyrylphenol phosphate ester, hydroxylated stearic acid polyalkylene glycol polymer, and their corresponding salts, alkyd-polyethylene glycol resin, polyalkylene glycol ether, ethoxylated distyrylphenol, ethoxylated distyrylphenol sulphate, ethoxylated tristyrylphenol phosphate, tristyrylphenol phosphate ester, tristyrylphenol phosphate potassium salt, dodecysulfate sodium salt;
for suspension concentrate (SC) formulation is selected from Ethylene oxide/propylene oxide block copolymer, Polyarylphenyl ether phosphate, Ethoxylated Fatty Alcohol, Sodium dioctyl sulfosuccinate, sodium lauryl sulfate and sodium dodecyl benzene sulfonate, alkyldiphenylsulfonates, sodium isopropyl naphthalene sulfonate, Alkylnaphthalene sulfonate;
for Wettable Dispersible Granule (WDG) formulation is selected from sodium N-methyl-N-oleoyl taurate, Alkylated naphtalene sulfonate, sodium salt, mixture of isomers of dibutylnaphthalene sulphonic acid sodium salt, sodium diisopropylnaphthalenesulphonate, Sodium Lauryl sulfate, Dioctyl sulfate, alkyl naphthalene sulfonates, phosphate esters, sulphosuccinates and nonionics such as tridexyl alcohol ethoxylate, alkyl or alkaryl sulfonates such as alkylbenzene sulfonates, alpha olefin sulfonate and alkyl naphthalene sulfonates, ethoxylated or non-ethoxylated alkyl or alkyaryl carboxylates, alkyl or alkyaryl phosphate esters, alkylpolysaccharide;
di or mono alkyl sulfosuccinate derivatives, alpha olefin sulfonates, alkyl naphthalene sulfonates, dialkyl sulphosuccinates, butyl, dibutyl, isopropyl and diisopropyl naphthalene sulfonate salts, C12 alkyl benzene sulfonate or C10-C16 alkyl benzene sulfonate.

13) The synergistic insecticidal composition as claimed in claim 5 wherein, dispersing agent
for Wettable Dispersible Granule (WDG) is selected from Naphthalenesulfonic acid, sodium salt condensated with formaldehyde, polyalcoxylated alkylphenol, naphthalenesulfonic acid formaldehyde condensate, methylnaphtaline-formaldehyde-condensate sodium salt, napthalene condensates, lignosulfonates, polyacrylates and phosphate esters, calcium lignosulfonate, lignin sulfonate sodium salt;
for suspension concentrate (SC) formulation is selected from Alkylated naphthalene sulfonate, sodium salt, Sodium salt of naphthalene sulfonate condensate, Sodium Ligno sulfonate, Sodium ploycarboxylate, EO/PO based copolymer, Phenol sulfonate, Sodium Methyl Oleoyl Taurate, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide;
for granule (GR) formulation is selected from Copolymer of propylene oxide (PO) and ethylene oxide (EO) and/or an ethoxylated tristyrene phenol, copolymer of PO and EO is alpha-butyl-omega-hydroxypoly(oxypropylene) block polymer with poly(oxyethylene), ethoxylated tristyrene phenol is alpha-[2,4,6-tris[1-(phenyl)ethyl]phenyl]-omega-hydroxy poly(oxyethylene, poly(oxy-1,2-ethanediyl)-alpha-C10-15alkyl-omega-hydroxy phosphate or sulphate and/or a C10-13alkylbenzenesulfonic acid, tristyrylphenols, nonylphenols, dinonylphenol and octylphenols, styrylphenol polyethoxyester phosphate, alkoxylated C14-20fatty amines.

14) The synergistic insecticidal composition as claimed in claim 5 wherein, disintegrating agent is selected from citric acid, succinic acid or the sodium bicarbonate.

15) The synergistic insecticidal composition as claimed in claim 5 wherein, antifoaming agent is selected from silicone oil, silicone compound, C10˜C20 saturated fat acid compounds or C8˜C10 aliphatic alcohols compound, Silicone antifoam emulsion, Dimethylsiloxane, Polydimethyl siloxane, Vegetable oil based antifoam, tallow based fatty acids, polyalkyleneoxide modified polydimethylsiloxane;

16) The synergistic insecticidal composition as claimed in claim 5 wherein, suspending agent for suspension concentrate (SC) formulation is selected from Aluminium Magnesium Silicate, Bentonite clay, Silica, Attapulgite clay.

17) The synergistic insecticidal composition as claimed in claim 5 wherein, thickening agent or thickener is selected from Xanthan gum, PVK, carboxymethylcelluloses, polyvinyl alcohols, gelatin, sodium carboxymethylcellulose, hydroxyethylcellulose, Sodium Polyacrylate, modified starch.

18) The synergistic insecticidal composition as claimed in claim 5 wherein, preservative is selected from 1,2-benzisothiazolin-3(2H)-one, sodium salt, Sodium benzoate, 2-bromo-2-nitropropane-1,3-diol, Formaldehyde, Sodium o-phenylphenate, 5-chloro-2-methyl-4-isothiazolin-3-one & 2-methyl-4-isothiazolin-3-one

19) The synergistic insecticidal composition as claimed in claim 5 wherein, colorant is selected from Crystal violet, Thalocyano dye chlorinated, Aerosol green FFB dye, Rodamine, Azo compound.

20) The synergistic insecticidal composition as claimed in claim 5 wherein, solvent is selected from fatty acid methyl ester, cyclohexane, xylene, mineral oil or kerosene, mixtures or substituted naphthalenes, mixtures of mono- and polyalkylated aromatics, dibutyl phthalate or dioctyl phthalate, ethylene glycol monomethyl or monoethyl ether, butyrolactone, octanol, castor oil, soybean oil, cottonseed oil, epoxidised coconut oil or soybean oil, aromatic hydrocarbons, dipropyleneglycol monomethylether, polypropylene glycol [M.W. 2000-4000], polyoxyethylene polyoxypropylene glycols, polyoxypropylene polyoxyethylene glycols, diethyleneglycol, polyethylene glycol [M.W. 200-4000 amu], methoxy polyethylene glycols 350, 550, 750, 2000, 5000; glycerol, methyl oleate, n-octanol, alkyl phosphates such as tri-n-butyl phosphate, propylene carbonate and isoparaffinic, tetrahydrofurfuryl alcohol, gamma-butyrolactone, N-methyl-2-pyrrolidone, tetramethylurea, dimethylsulfoxide, N,N-dimethylacetamide, Diacetone alcohol, Polybutene, Propylene carbonate, Dipropylene glycol isomer mixture.

21) The synergistic insecticidal composition as claimed in claim 5 wherein, anti-freezing agent is selected from ethylene glycol, propane diols, glycerine or the urea, Glycol (Monoethylene glycol, Diethylene glycol, Polypropylene glycol, Polyethylene glycol), Glycerine, Urea, Magnesium sulfate Heptahydrate, Sodium Chloride.

22) The synergistic insecticidal composition as claimed in claim 6 wherein, slow release (control release) agent for controlled release granule (CR) formulation is selected from Xanthan gum, PVK, carboxymethyl celluloses, polyvinyl alcohols, gelatin, sodium carboxymethylcellulose, hydroxyethylcellulose, Sodium Polyacrylate, modified starch, Parafin wax, Polyvinyl acetate, Montan wax and vinyl acetate, Polyethylene Glycol 6000, Cationic hydrosoluble polymer, C4 alkylated Polyvinyl pyrrolidone

23) The synergistic insecticidal composition as claimed in claim 5 wherein, carrier is selected from diatomaceous earth, attapulgite or zeolites, dolomite, limestone, silica, fly ash, hydrated lime, wheat flour, wood flour, ground wheat straw, cellulose and soy flour, bentonite, kaolin, attapulgite, diatomaceous earth, calcium carbonate, talc, muscovite mica, fused sodium potassium, aluminum silicate, perlite, talc and muscovite mica, urea, sulfur-coated urea, isobutylidene diurea, ammonium nitrate, ammonium sulfate, ammonium phosphate, triple super phosphate, phosphoric acid, potassium sulfate, potassium nitrate, potassium metaphosphate, potassium chloride, dipotassium carbonate, potassium oxide and a combination of these. calcium, magnesium, sulfur, iron, manganese, copper, zinc; oxides, humic acid, Wood floor, Calcium silicate, Cellulose granules, Magnesium stearate.
